(19) United States
(12) Patent Application Publication
(10) Pub. No.: US 2007/0078909 A1
(43) Pub. Date: Apr. 5, 2007

(54) Database System

(76) Inventor: Masaharu Tamatsu, Tokyo (JP)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(21) Appl. No.: 11/530,342

(22) Filed: Sep. 8, 2006

(30) Foreign Application Priority Data
Mar. 8, 2004 (JP) JP2004-063772
Mar. 7, 2005 (WO) PCT/JP05/03914

(51) Int. Cl. G06F 17/30

(52) U.S. Cl. 707/203

(57) ABSTRACT

Purpose: The purpose is to enable the non-disruptive insertion of columns, and like operations, into databases that remain in operation, guarantee that programs using old database definition sets are able to run, and automate the creation and modification of database definition sets. Constitution: A database system comprising a logical structure conversion component that, in a database system that stores and retrieves data, converts records defined by some given version of a database definition set to records defined by a different version of the database definition set and a data storage component that stores multiple versions of the database definition paired to the records of one given table and multiple versions of the records defined by those database definition sets.

### FIELD OF THE INVENTION

The invention relates to computerized database storage and retrieval systems.

### DESCRIPTION OF RELATED ART

Conventional computerized database storage and retrieval systems are described in many publications, such as Jeffrey D. Ullman, Deetabeesu Shisutemu no Genri [Principles of Database Systems], 1st ed. (trans. Kunii et al., Nihon Konpyuuta Kyoukai, 25 May 1985) and Samuel Leffler et al., UNIX 4.3 BSD no Sekkel to Jissou [The Design and Implementation of UNIX® BSD 4.3] (trans. Akira Nakamura et al., Maruzen K. K., 30 Jun. 1991),

Such conventional database storage and retrieval systems have suffered from such shortcomings as (1) Load deriving from the creation and maintenance of indices, (2) The need for advance generation of blocks of the maximum size whose utilization is ultimately foreseen, and (3) Susceptibility, due to the hierarchical structure of the indices, to the expansion of exclusion ranges and deadlock resulting from modifications to a higher-order index when the insertion or deletion of data results in the updating of an index.

In order to resolve these shortcomings of conventional database storage and retrieval systems, the present inventor has proposed an information storage and retrieval system (Japanese Patent 3345628 and U.S. Pat. No. 6,654,868) providing acceleration and ease of maintenance through the utilization of such means as the introduction of the concepts of location tables and alternate-key tables instead of conventional hierarchical indices, the simplification of the complex processing that accompanies indexing and the application of binary searches on the tables themselves.

This database system has evidenced the following problems. The modification of data fields and insertions, deletions and modifications occur in actual operation of a database system. Inserting a data field into a database consists of interrupting operation of the database system, modifying the database definitions, modifying the data and then restarting the database system. These operations require long times of several hours, during which shutting down the database has constituted a major constraint in systems requiring uninterrupted operation.

The trouble of surveying applications programs that use the database and revising them so as to avoid inconsistency has required vast extents of additional time. This need to modify application programs has necessitated significant grounds for decisions to insert, modify and delete columns even when it is not necessary to do so.

Existing inventions that are related to the present invention include “Database re-organizing system and database” (PCT/JP03/11592, hereinafter “Database reorganization system”), Database accelerator' (PCT/JP03/13443, hereinafter “Accelerator function”) and “Database storage and retrieval system” (Japanese Patent 2004-020006).

### Problems Solved by the Invention

The only way to insert, delete or modify columns in a database in a conventional database system has been to interrupt the operation of the database for a long period of time. Further, the insertion, deletion and modification of columns in a database constitutes modification of database definitions, and since application programs that had been running with the old definitions cannot be run with the new database definitions when the definitions are modified, it has been necessary to revise and recompile the required application programs. This has made it impossible to easily execute the insertion, deletion or modification of columns.

Embodiments of the present invention provide solutions to the following problems:
1. They improve the performance of database systems.
2. They allow ease of insertion, deletion and modification of columns in database systems.
3. They allow the insertion, deletion and modification of columns white a database is in operation, without interrupting operation of the database.
4. They allow application programs to run without modification even when columns have been inserted, deleted or modified.
5. The insertion, deletion and modification of columns in the records of a single table entails a new record format, but conventional databases have been capable of handling only the most recent record format. Embodiments of the present invention allow storage of multiple formats and the performance on those records of searches, insertions, updates and deletions, and therefore enable historical data storage management that has not previously been available.

### Means for Solving the Problem

The present invention is a database system comprising a structure conversion component that, in a database system that stores and retrieves data, converts records defined by some given version of a database definition set to records defined by a different version of the database definition set and a data storage component that stores multiple versions of the database definition set paired to the records of one given table and multiple versions of the records defined by those database definition sets.

The present invention is likewise a database system comprising a structure conversion component that, in a database system that stores and retrieves data, converts records defined by some given version of a database definition set to records defined by a different version of the database definition set and a data storage component that stores a single version of a database definition set paired to the records of one given table and a single version of the records defined by that database definition set.

### BRIEF DESCRIPTION OF THE DRAWINGS

FIG. 1 illustrates the database described herein.

FIG. 2 illustrates reorganization of primary blocks and overflow blocks.

FIG. 3 illustrates a database into which a column is inserted. Alternate keys are omitted in this drawing.

FIG. 4 gives the database definition set for the database of FIG. 3.

FIG. 5 illustrates the partial completion of the insertion of a column by means of retroactive column insertion with a child database. The drawing illustrates column insertion completed through record 2.

FIG. 6 provides database definition sets and a definition-set cross-reference table for the insertion of a column b by means of retroactive column insertion with a child database. The database definition sets are V1 and V2. V1 is the database definition set prior to the insertion, and V2 is the database definition set subsequent to the insertion.

FIG. 7 illustrates a database in which the insertion of a column b has been completed by means of retroactive column insertion with a child database.

FIG. 8 illustrates the status of a record inserted after the completion of insertion of a column b by means of retroactive column insertion with a child database.

FIG. 9 illustrates the partial completion of the insertion of a column b by means of direct retroactive column insertion. The drawing illustrates reorganization completed through record 3.

FIG. 10 provides database definition sets and a definition-set cross-reference table for the insertion of a column by means of direct retroactive column insertion. Here, the database of FIG. 3 and the database denoted by the database definition set are V1, and the database definition set after the insertion of the column is V2.

FIG. 11 illustrates completed insertion of a column by means of direct retroactive column insertion.

FIG. 12 provides database definition sets on completion of the insertion of a column by means of direct retroactive column insertion.

FIG. 13 illustrates a database into which a column is inserted by means of non-retroactive column insertion with a child database.

FIG. 14 illustrates the point at which preparatory operations have been completed for the insertion of a column by means of non-retroactive column insertion with a child database.

FIG. 15 illustrates the point at which records into which a column is inserted by means of non-retroactive column insertion with a child database are now stored in the database.

FIG. 16 provides database definition sets and a definition-set cross-reference table for the insertion of a column by means of non-retroactive column insertion with a child database.

FIG. 17 illustrates maintenance in a record of the version of the database definition set with which that record was created.

FIG. 18 illustrates maintenance in a block of the versions of the database definition sets with which records in that block were created.

FIG. 19 provides database definition sets and a definition-set cross-reference table for direct non-retroactive column insertion.

FIG. 20 illustrates storage in a database of records into which a column has been inserted by means of direct non-retroactive column insertion.

FIG. 21 provides database definition sets and a definition-set cross-reference table for consolidation with its parent database of a child database created by means of column insertion with a child database.

FIG. 22 illustrates completion through record 3 of the consolidation with its parent database of a child database created by means of column insertion with a child database.

FIG. 23 illustrates the completion of consolidation with its parent database of a child database created by means of column insertion with a child database.

FIG. 24 provides database definition sets and a logical structure conversion table at the point consolidation with its parent database has completed of a child database created by means of column insertion with a child database.

FIG. 25 illustrates column deletion by means of definitional deletion.

FIG. 26 provides database definition sets and a logical structure conversion table for column deletion by means of definitional deletion.

FIG. 27 illustrates a database to which column deletion by means of backward retention with a child database is applied.

FIG. 28 illustrates a database at the point of completion of preparatory operations in the application of column deletion by means of backward retention with a child database.

FIG. 29 provides database definition sets and a logical structure conversion table for the point at which preparatory operations have completed in the application of column deletion by means of backward retention with a child database.

FIG. 30 illustrates a database at the point where processing has completed through record 3 in the application of column deletion by means of backwards retention with a child database.

FIG. 31 illustrates a database at the point where processing has completed in the application of column deletion by means of backward retention with a child database.

FIG. 32 illustrates the point at which processing has completed through record 3 in the application of column deletion by means of backward non-retention and direct column deletion.

FIG. 33 provides database definition sets and a logical structure conversion table for the application of column deletion by means of backward non-retentive direct column deletion.

FIG. 34 provides a post-deletion database definition set and logical structure conversion table for the application of column deletion by means of backward non-retentive direct column deletion.

FIG. 35 illustrates a database at the point column deletion has completed in the application of column deletion by means of backward non-retentive direct column deletion.

FIG. 36 illustrates an overflow-block management table.

FIG. 37 illustrates the application of a database having an overflow-block management table in column insertion with a child database.

FIG. 38 illustrates the application of a database having an overflow-block management table in direct column insertion.

FIG. 39 illustrates the partial acceleration of reorganization in an application of the technique of decreasing the initial volume of a new location table in reorganization.

FIG. 40 illustrates the principles of an accelerator system.

FIG. 41 illustrates the application to an accelerator system of a database having an overflow-block management table.

FIG. 42 provides an example of XML.

FIG. 43 provides an example of XML.

FIG. 44 illustrates a method of defining multiple columns as one alternate key in an application to XML.

FIG. 45 illustrates alternate-key entries in a method of defining multiple columns as one alternate key.

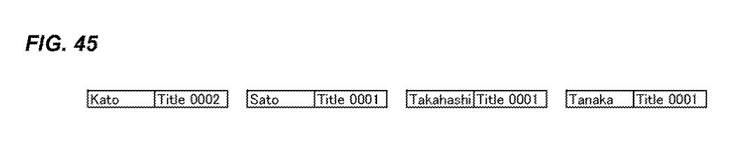

FIG. 46 illustrates the processing of a record-read request in a non-retroactive operation.

FIG. 47 illustrates the processing of a record-update request in a non-retroactive operation.

FIG. 48 illustrates the processing of a record-delete request in a non-retroactive operation.

FIG. 49 illustrates the processing of a record-insert request in a non-retroactive operation.

FIG. 50 illustrates the processing of a record-read request in a retroactive operation.

FIG. 51 illustrates the processing of a record-update request in a retroactive operation.

FIG. 52 illustrates the processing of a record-delete request in a retroactive operation.

FIG. 53 illustrates the processing of a record-insert request in a retroactive operation.

FIG. 54 provides an example of a logical structure conversion table.

FIG. 55 provides an example of the use of logic to perform logical structure conversion.

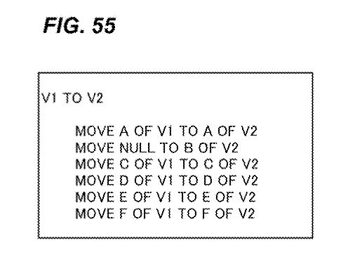

FIG. 56 illustrates the creation of a new database definition set from some given database definition set.

FIG. 57 illustrates a parent database and child database.

### PREFERRED EMBODIMENTS OF THE INVENTION

while this specification involves extensive description of methodology, utilization of the methods set forth herein enables the construction of such a system.

Records

A record always has a single unique primary key and zero or one or more non-unique keys (alternate keys, which may also non-problematically be unique). Records may also have fields (columns) that are not keys. In an employee database, for example, the primary key would be an employee code or other code identifying employees, and the alternate keys would be their names, dates of birth and so on and, depending on the database, may be absent or may be a plurality. Records lacking a field that would serve as a primary key having significance may be assigned serial numbers in the order of their storage that may serve as the primary key. Fields (columns) are units of information; some serve as keys and others do not serve as keys. One or more exist within a record. Columns may be of fixed length and may also be of variable length. Where columns are of variable length, each column may be of a variable length, and columns lacking data may also be recognized as columns. Records may logically be handled as aggregates. Aggregations of fields subordinate to a primary key may be broadly defined as logical records. However, all fields subordinate to a primary key are not always reckoned as a single logical record. For example, fields subordinate to employee codes may include such information as name, date of birth, internal assignment, date of employment, email address and in-house extension number. They may also include such information as street address, school of graduation and family membership, They may also include salary and bonus information. They may further include evaluation results.

This different information may be aggregated in units of the frequency of its utilization or partially segregated into separate records for security reasons. Following on from the above example, the employee master database would contain employee names, dates of birth, dates of employment, internal assignments, email addresses and in-house extension numbers. Individual employee files would contain their street addresses schools of graduation and family memberships. The employee remuneration file would contain salary and bonus information. The employee evaluation file would contain evaluation results. Four logical records would thus be created that are subordinate to the employee code, Those logical records may be comprised of multiple physical records. An example is the employee evaluation file. Extant evaluation fields may refer to a method of scoring by superiors. Evaluations by subordinates may then be added to these later on. Superior evaluations and subordinate evaluations may then be aggregated into a single physical record, i.e., a logical record. It is likewise possible to maintain unchanged those records storing past evaluations by superiors, create new records containing evaluations by subordinates and handle them together as new logical records. In the latter case, the superior evaluations file and the subordinate evaluations file may also each be treated as independent logical records. Further segmentation would allow also for combinations of individual fields with the primary key as separate physical records. Unless stated otherwise, the text of this specification addresses logical records.

A first method of engendering these broad-definition records is to dispose all fields subordinate to a primary key in a single concatenation. This is the common concept of a record, A second method of engendering such records is to store records consisting of a primary key and a field subordinate to that primary key, i.e, narrow-definition records. This method consists of creating narrow-definition records for each field subordinate to the primary key. Aggregates of these narrow-definition records would constitute broad-definition records. A third method of engendering such records combines the first and the second method in creating multiple narrow-definition records made up of one or more fields subordinate to the primary key and treating aggregates of those narrow-definition records as broad-definition records, Unless otherwise stated, broad-definition records are employed in this specification, but child database procedures employ the third of these methods.

Database definition sets are employed in prevailing database systems to define databases. While database definition sets may contain a broad range of information concerning a database, such as its physical structure, its logical structure, its storage structure, the composition of its indices and its attributes, at the very least it holds information describing the composition of its records. Record composition information is information that includes physical structure, logical structure and attribute information. Where this specification employs the term database definition set, it refers to record composition information. That is, the term “database definition set” refers to record composition information in database definition sets. The insertion, deletion or modification of a column in some given table results in the modification of the logical structure and the physical structure of records, and new database definition sets created with those record modifications are new versions of database definition sets. Tables refers to files (e.g. employee master databases, client master databases, product master databases, accounts receivable files) made up of rows and columns that are commonly used in databases, but the location tables, alternate-key location tables, logical structure conversion tables and the like discussed below are distinct from these. Such classes of tables employed within this specification are referred to by such nomenclature as location table, alternate-key table and logical structure conversion table, and these are not referred to simply as “table”.

The discussion addresses first the non-requirement for modification of application programs when inserting, modifying or deleting a column. Conventional procedures have entailed shutting down the database, then performing the insertion, deletion or modification of the column, and once again starting up the database. The format of records stored in the database has therefore been restricted to the most recent generation thereof. This information is stored in the database definition set. Application programs utilized have also been those that are revised to conform with the most recent generation of the database.

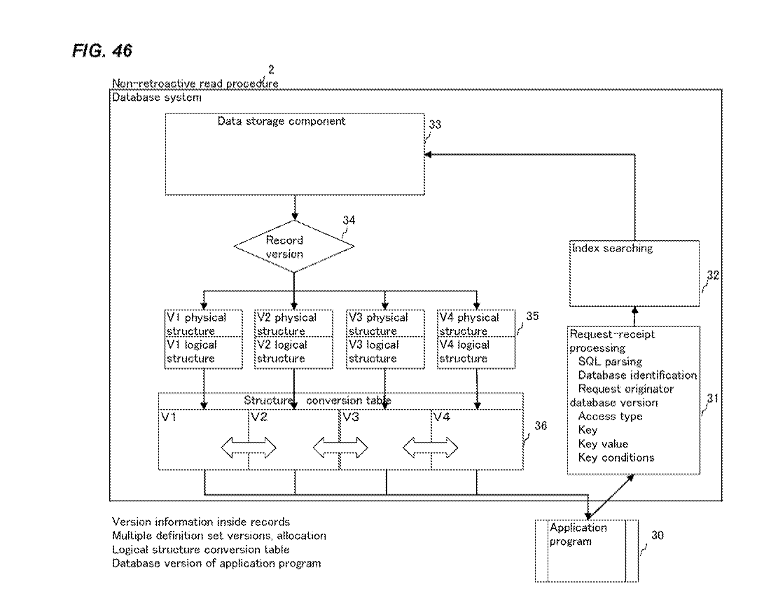

The present invention is implemented by maintaining for records in tables that are stored in a database the version information of the database definition set with which those records were created, retaining multiple generations of database definition sets, converting the logical structures of those individual versions, retaining information specifying which version of a database definition set is employed by application programs (application program version information) and tracking these multiple versions. FIG. 46 illustrates database access by multiple versions of an application program. This drawing illustrates the processing of a read operation (read processing being in many cases a select operation in SQL). The database receives a read instruction from an application program or other request originator 30. The database system performs request receipt processing 31 and then performs index searching 32. Up to this point, procedures are likewise to conventional database systems. The target record is retrieved from the data storage component 33 where data are stored. The version information for the database definition set at the time that record was created (record version information) shall have been stored in advance in a specific location either inside that record or outside that record. This record version information is stored when the record is created and each time it is modified.

The record is sent to the database definition set of the version matching the record version information read. Here the record is read from the block (nomenclature for which varies with the database system) storing the record on the basis of its physical structure. The record read is then converted to the logical structure of that version. The logical structure conversion component is then employed to convert it to the version of the database definition set of the application program. The logical structure conversion component performs conversions of records defined by some given version of a database definition set to records defined by other versions of the database definition set, using a logical structure conversion table or logical structure conversion program logic, for example. The converted record is passed to the application program. Records may thus be read, regardless of the version of the database definition set with which the stored record was created and the version information of the database definition set used by the reading application program. Records may also be updated, inserted and deleted in the same fashion as they are read.

There are two approaches, roughly speaking, of inserting columns: retroactive and non-retroactive. Since each of these may be performed either with a child database or directly, in all there are four methods of implementation. The retroactive methods of inserting a column consist of preparing in advance the values of the column that will be inserted for records previously created and inserting those values into existing records. The result of this approach is that existing records will also hold the values of the inserted column. The non-retroactive methods of inserting a column result in newly created records holding the values of the inserted column and records created prior to the insertion of the column not having a value in the inserted column, without preparing the values of the column inserted into records previously created. The value of an inserted column in a record lacking a value in the inserted column is passed to application programs as the default value, a null value or a column lacking data. It is also possible to pass a specific return code. This applies likewise below.

Use of a child database is a method in which the database that will store the inserted column is defined as a separate, new database (child database) apart from an existing database into which the column is inserted, records (child records) are given a format combining the primary key of the existing database and the inserted column (field), the primary key of the existing database is defined as the primary key of the new database, and child records are stored in the new database.

The direct column insertion methods consist of inserting a column directly into an existing database, The methods set out in “Database reorganization system” are applied to implement these methods. Column insertions are performed record by record, but the unit of processing is the block. A new location table is provided to an existing location table, and blocks into which columns are inserted are managed by the new location table. Records are read sequentially from the existing database, and after column insertion is performed, those records are again stored in blocks. The block addresses are written to the new location table. Because blocks storing records with new columns inserted into them are commingled in the existing database with blocks storing records without inserted columns, column operation pointers are employed with this method in order to segregate them. A column operation completion pointer is also employed to specify the completion point of a column insertion. The column operation pointers point to the next address after the entry pointing to the final block at which column insertion has completed in each location table. One column operation pointer each is maintained for the existing and new location tables.

Where a child database is employed as in the method described above and the database reorganization system is used to perform reorganization, a database split in two may be consolidated into one. Splitting a database in two has the advantage of alleviating the load at the time of its creation, but because the database is split in two, the added database must also have a location table and primary key, which makes the database that much larger. It also becomes necessary to access two databases in order to retrieve a single record, which makes the load on the system that much larger. However, in some cases it is efficient, as when the records overall are rarely accessed, much of the access specifies the fields and few applications use the inserted fields, and so the circumstances of usage must govern the choice.

As with the insertion of columns, there are two approaches, roughly speaking, to deleting columns: backward retention and backward non-retention. Backward-retentive deletion is further divided into a method of definitional deletion and a method using a child database, Direct deletion is the sole method of backward non-retention. The method of definitional deletion consists of definitionally deleting the column to be deleted without performing an actual deletion. Employing this method allows operations to be completed in an extremely short time because the deletion requires only the modification of database definitions. Records are read at the length in which they are actually written in the database, but the column deleted is deleted from records when passing them to application programs. When a record is passed to an application program using an old database definition set, however, the record passed may be that including deleted columns.

Columns may be modified, as well as inserted and deleted. Like column insertion, column modification may be either retroactive or non-retroactive. Methods using a child database are implemented using methods like those for performing reorganization with the database reorganization system, but columns are deleted from records and the records written back after these column deletions. New records are created combining deleted fields and the primary key of the source database, and those records written to a child database, Because this method entails the creation of a new database when a column is deleted, it suffers from the drawback of requiring excessive time for column deletion, but it permits evasion of circumstances in which application programs using the deleted fields are unable to run. Like the method of definitional deletion, the use of a child database allows records including deleted columns to be passed to application programs that use old database definition sets.

Backward non-retentive deletion is a method in which the column to be deleted is deleted from pre-deletion records and the shorter post-deletion records are written back to the database. This method may be implemented by employing methods like those employed to perform reorganization using the database reorganization system. A new location table is used with the current location table, and the addresses of blocks storing post-deletion records are maintained by the new location table. In order to distinguish through which block column deletion has been performed, one column operation pointer each is used in the current and new location tables. Care is required with the use of this method because application programs using the fields deleted may experience problems.

The recitation turns next to the modification of columns. The modification of columns pertains to their attributes and length. These fall into three groups: modification of a column attribute and no modification of its length, no modification of a column attribute and modification of its length, and modification of both a column attribute and its length. The attribute of a column refers to the form of the data stored therein; examples of column attributes are numeric, text and date.

The recitation first addresses modification of a column's attribute. The methods employed are like that of direct column insertion. Which is used depends on whether the modification of the column attribute extends through existing records. When modifying column attributes in existing records, the column attributes in the existing records are modified in the same manner as for retroactive column insertion. This is termed retroactive column modification. Where the attributes of columns modified in existing records are to be left unmodified, the method of modifying the attributes of modified columns in records created using a new database definition set is termed non-retroactive column modification.

In retroactive column modification, a new location table is provided to an existing location table, and modifications are performed on the modified columns in existing records while executing reorganization. Like retroactive column insertion, retroactive column modification should use only the record format of the most recent database definition set version. A logical structure conversion table may be used, however, to pass records to application programs using old database definition sets.

Because modifications are not performed on existing records in non-retroactive column modification, operations on existing records are unnecessary. Newly created records need not be inserted with the most recent version of the database definition set, but may also be inserted with an existing old database definition set version. And because existing records remain in the format of their creation, each version of the database definition set is retained. In this case also, a logical structure conversion table is used.

Next, the recitation addresses the modification of column lengths. Modification of column length also allows a choice between a retroactive and a non-retroactive method. Retroactive modification is a method of modification that brings the length of modified columns in existing records into conformance with the length of a new database definition set. In this case, modifications performed on existing records are likewise to the method described for retroactive column insertion. In non-retroactive modification, no modification is performed on existing records, and the length of modified columns in records created with the most recent database definition set is modified.

In this case as well, records may be transferred by using a logical structure conversion table, even if record versions are different from application program versions, but because modification of column length may result in data overflow or truncation, application of this method requires confirmation that operational problems will not arise.

Database definition sets are as follows. The initial database definition set is created manually by a system administrator. This is referred to as version 1 (V1). When a column is later inserted, for example, the database definition set subsequent to the insertion is referred to as V2. In this V2 the system administrator specifies to the database system at what position in which column the insertion was made and also whether the insertion was performed directly or with a child database. The database system creates V2 on the basis of these instructions by synthesizing it with the V1 information. Each version of the database definition set is a combination of that versions physical information and logical information.

If necessary, new V1 definitions are then created based on the V2 definitions. Instances where it would be necessary include consolidation into a single database with V2 of data in a child database format with V1 and where physical structure, but not logical structure, is altered.

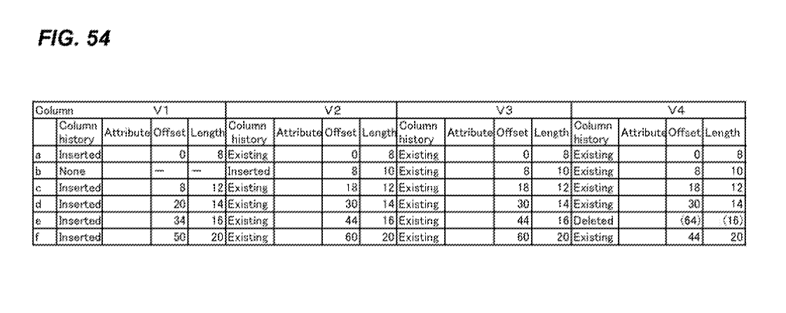

Next, a logical structure conversion table for V1 and V2 is created. This table indicates how the V1 columns and the V2 columns correspond to each other. The logical structure conversion table contains extracts of the logical structure from each database definition set version paired with each other. Conversions of logical structure between the two versions may be performed by means of this logical structure conversion table. FIG. 54 provides an example of a logical structure conversion table.

Embodiments

The discussion now addresses enabling the use, unmodified, of application programs running with previous database definition set versions when the insertion, deletion or modification of a column has resulted in the modification of the physical structure or logical structure of records in some given table in a database. The discussion here employs an example of four versions of a database definition set that are termed V1, V2, V3 and V4, but implementation may be performed with any number of versions. Although this specification entails considerable description of methodology, a database system may be constructed by using these methods to build the system. Description of column attributes is omitted in many locations in this specifications and the drawings. This is because they have little significance beyond the modification of column attributes.

Access by Multiple Versions of Application Programs

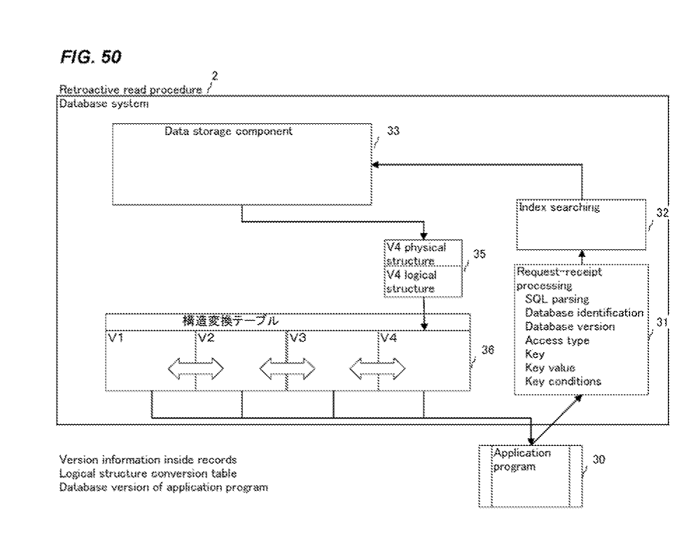

FIG. 46 is concerned with read processing in a non-retroactive operation. FIG. 50 is concerned with read processing in a retroactive operation. The example employed here is one of column insertion, and the recitation describes a retroactive approach and a non-retroactive approach. The non-retroactive approach is one that does not reflect (does not make retroactive) newly inserted columns in previously created records. In other words, past records remain in the format in which they were created. Newly created records in a format that includes an inserted column are inserted by application programs that use a database definition set with the column inserted, and newly created records in a format that does not include the inserted column are inserted by application programs of prior versions. In other words, records of different formats are commingled.

In the retroactive approach, on the other hand, the values of newly inserted columns are prepared for records that have previously been created, these are applied to the existing records, and all records in the database are made into records of a format including the inserted columns. Further, newly created records are only records of the format that includes the inserted columns. In the retroactive approach, since those application programs using previous versions of a database definition set that insert records lack information pertaining to inserted columns, they should define column values that are default values or null values, or define the columns as lacking data. Alternatively, those application programs using a database definition set other than the most recent that insert records may also not be allowed to run.

The present invention may be implemented by maintaining in records stored in a database version information for the database definition set with which the records were created, retaining multiple database definition set versions, performing conversions between the logical structures of those different versions, retaining in application programs information stating which version of the database definition set it uses (application program version information) and allocating among the multiple versions.

Although the terms subschema and schema are commonly used with respect to database systems, this specification employs the term “database” without making particular use of such terminology. Such phrases as “inserting a column in a database” and “accessing a database” in this specification describe an operation performed on a specific database file (for example, an employee file) and are not references to the totality of database files stored in a database system. Additionally, where specific database files are comprised of multiple database files—for example, where a newly inserted hometown column in an employee master database is stored in a separate database file, but as a record is treated as a single set—the term “database” is used to refer to the individual database files.

Non-Retroactive Methods

Non-Retroactive Read Operations

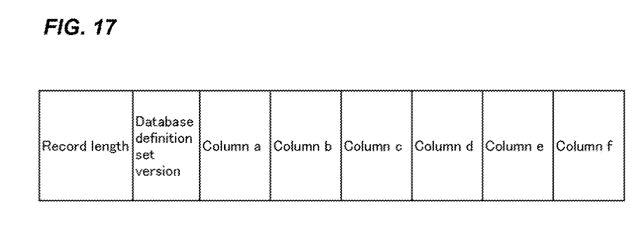

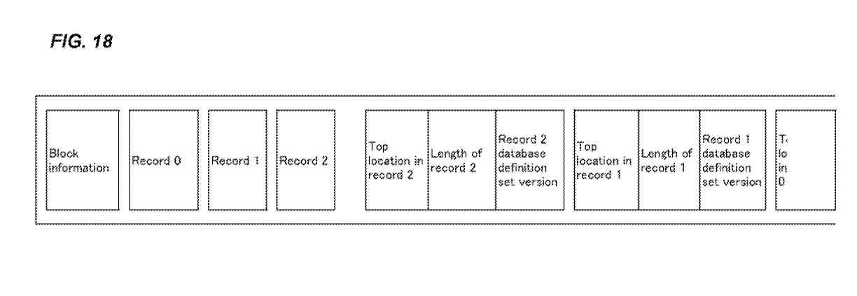

FIG. 46 illustrates non-retroactive read processing (in SQL read processing is often a select operation). A database system receives a read instruction from an application program 30. The database system performs request-receipt processing 31. This consists of SQL parsing, database identification (access to which database files), the application program's database definition set and the version thereof, kind of access (in this case, a read operation), type of key (primary key or alternate key; if an alternate key, which alternate key), the key value (the value of the target key) and the key conditions (e.g. equal to, greater than or less than the target key). It then performs index searching 32 and detects the location where the target record is stored. Up to this point, procedures are likewise to conventional database systems. The target record is retrieved from the area where data are stored (data storage component) 33. The version information for the database definition set at the time that record was created (record version information) shall have been stored in advance in a specific location either inside the record or outside the record. This record version information is performed at the time the database is created and later stored whenever a record is inserted or modified by an application program. FIG. 17 provides an example of a record format. Here, the record format includes column values as well as record length and information on the database definition version. FIG. 18 provides an example of holding information on database definition versions in specific locations outside records.

The record is read from the block (nomenclature for which varies with the database system) storing the record on the basis of the physical structure of the version of the database definition set matching the version information for the database definition set of the record read. Depending on physical structure, a single logical record may be dispersed across multiple databases, and in such cases those requisite multiple databases are read. The record read is then converted to the logical structure of that version. A logical structure conversion table is then employed to convert it to the version of the database definition set of the application program. The converted record is passed to the application program. Records may thus be read, regardless of the version of the database definition set with which the stored record was created and the version information of the database definition set used by the reading application program. FIG. 46 depicts database definition sets decoupled from a logical structure conversion table, but the system may be implemented in like fashion where a logical structure conversion table is assigned to each database definition set. This applies likewise below. The database definition sets of FIG. 46 are depicted as including logic that performs conversions of the physical structure and logical structure of records. Thus, configurations are possible in which database definition sets internally include logic for logical structure conversion, and configurations are also possible in which database definition sets are pure definitional statements and the logic that performs logical structure conversion is distinct from the database definition sets. This applies likewise to discussion of FIGS. 46 through 53.

Non-Retroactive Rewrite Operations

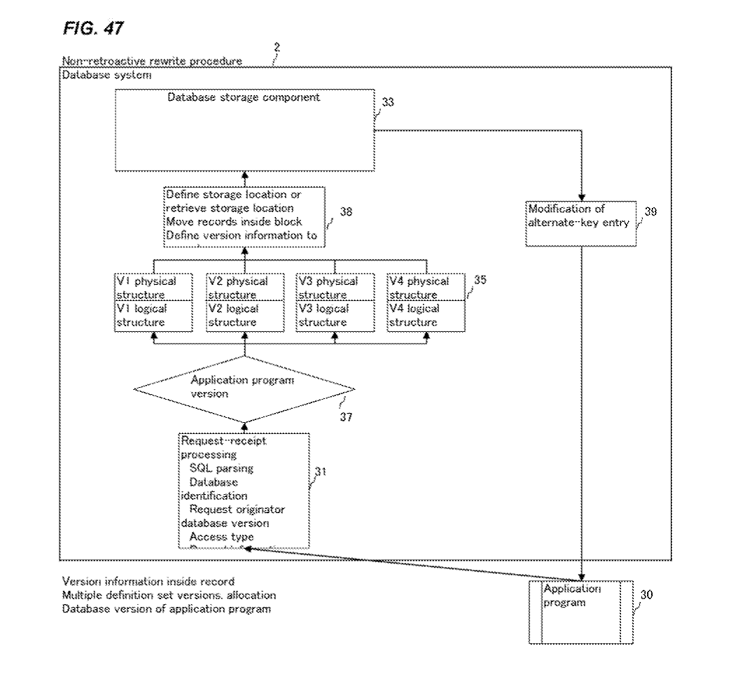

The discussion next addresses FIG. 47. This drawing illustrates a non-retroactive rewrite operation (updating, which is often an update operation in SQL). A rewrite operation consists of updating a record that has been read and then writing it back. In this drawing, the reading and updating of the record have already completed. An application program 30 makes a rewrite request to database system 2. The database system executes request-receipt processing 31. Here, checking is performed for SQL parsing, database identification, the version of the application program's database definition set, kind of access (here, a rewrite operation), and the record information. Next, allocation 37 is performed according to the application program's database definition set version. If the application program's database definition set is V1, the record data is allocated to the V1 database definition set. With the database definition set, the record is converted into a physical structure. Next, the storage location is defined. This record was read by a read operation, and since there will have been no change in its storage location if exclusion was imposed at that point, the storage location at the time of the read operation is defined. If the read operation was not exclusive, the storage location may have changed during the period until the rewrite operation is performed and so the storage location is retrieved. Next, if the space in the block storing the record that was previously occupied by the record to be stored and the new space required in that block are different, successive records inside the block are moved. Also, version information is defined to the record stored (38). The record is then stored. Next, if modification involving an alternate key has occurred, modification is performed for that alternate key.

Non-Retroactive Delete Operations

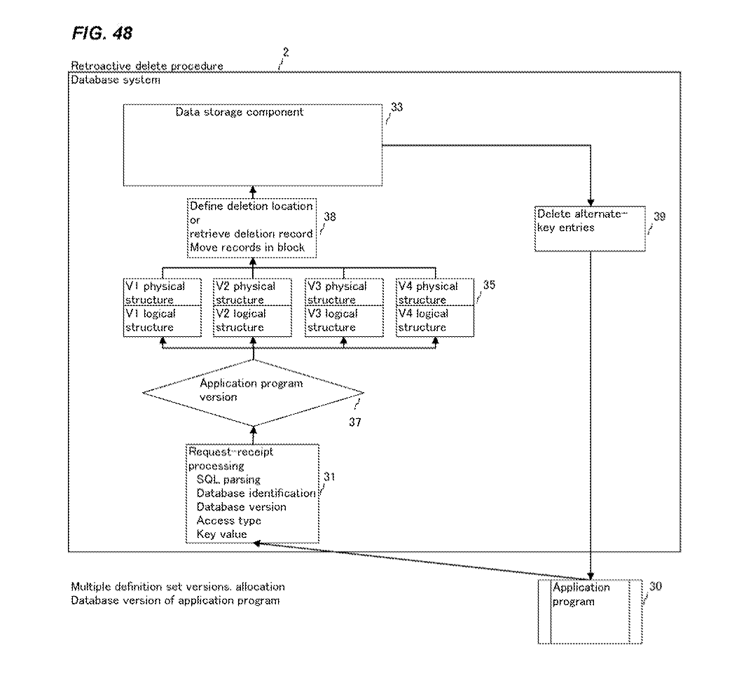

FIG. 48 depicts a non-retroactive delete operation. It resembles a rewrite operation. A delete operation generally consists of once reading a record and then deleting it, but a deletion may also be performed abruptly by assigning a key value. Request-receipt processing 31, database identification, allocation 37 according to the application program's database definition set version, and physical structure conversion according to that version's database definition set are likewise to a rewrite operation. Next, the storage location is defined or the storage location retrieved. This is also likewise to a rewrite operation. Since the space occupied by a record is left empty if that record is deleted, any records successive to that record must be moved. Deletion of the record is then performed. Next, if it has alternate keys, the alternate-key entries relating to that record are deleted.

Non-Retroactive Insert Operations

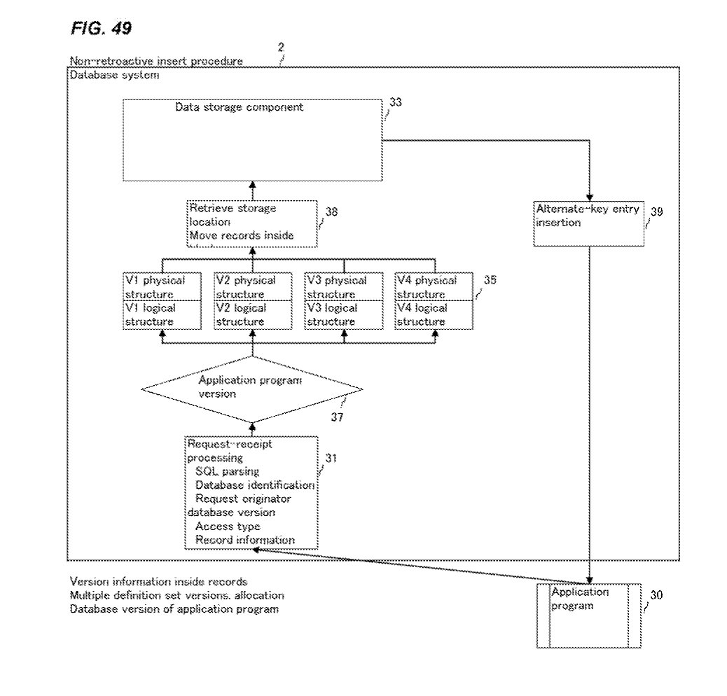

FIG. 49 depicts a retroactive insert operation (record insertion). As in the above examples, request-receipt processing is performed. Performing an insertion requires record information. Information concerning keys is not required because it is included in the record. Allocation is performed according to the database definition set version. Conversion of logical structure and physical structure is then performed according to the database definition set. Once the storage location is retrieved, records successive to that record in the block in which that record is stored are moved, and the record stored. Alternate-key entries are also inserted.

Logical Structure Conversion Component

Next, the discussion addresses the conversion of logical structure. The discussion employs a logical structure conversion table as an example of a logical structure conversion component. FIG. 54 provides an example of a logical structure conversion table. This logical structure conversion table is defined to perform the conversion of logical structure among database definitions V1 through V4. At leftmost are the column names, To their right is a description of the logical structure of database definition V1. Column a is 8 bytes from an offset of byte 0 in the record, column b is not present, column c is 12 bytes from an offset of byte 8 in the record, column d is 14 bytes from an offset of byte 20 in the record, column e is 16 bytes from an offset of byte 34 in the record, and column f is 18 bytes from an offset of byte 50 in the record. The logical structures of V2, V3 and V4 are described likewise. The column history of column e in V4 is given as “deleted,” which indicates that a column deletion was performed in this version. Also, its offset and length are expressed in parentheses, which means that, although it is not present in V4 logical records, the column e values are retained as historical data. This is used to pass column e values to an application when a record is created with V4 and the application program is other than V4. When the source of the request is a V4 application program, of course, the record not including column e is passed. The column history provides historical information on whether that column was created or deleted in that database definition set version. The columns at leftmost in this logical structure conversion table are the columns retained individually in the multiple database definition sets for that database that have been extracted with an OR condition.

An example follows of using this logical structure conversion table to convert logical structure. The recitation first describes a read operation. Take V1 as the database definition set version of the record read. Also, take V3 as the database definition set version of the application program (the request originator). In this case, the columns are passed from V1 to V3 in the logical structure conversion table. Column a is 8 bytes from an offset of byte 0 in the record read, and this is set to 8 bytes from an offset of byte 0 in the V3 record. As it is found that column b is not present in the record read, column b in the V3 record is set to its default value or a null value, or the column is set not to hold data. Column C is 12 bytes from an offset of byte 8 in the record read, and this is set to 12 bytes from an offset of byte 18 in the V3 record. Column d is 14 bytes from an offset of byte 20 in the record read, and this is set to 14 bytes from an offset of byte 30 in the V3 record. Columns e and f are then set. The V3 record being thus complete, that record is passed to the application program.

Next, take V4 as the database definition set version of the record read. Also, take V2 as the database definition set version of the application program. In this case, the columns are passed from V4 to V2 in the logical structure conversion table. Column a is 8 bytes from an offset of byte 0 in the record read, and this is set to 8 bytes from an offset of byte 0 in the V2 record. Column b is 10 bytes from an offset of byte 8 in the record read, this is set to 10 bytes from an offset of byte 8 in the V2 record. Column c is 12 bytes from an offset of byte 18 in the record read, and this is set to 12 bytes from an offset of byte 18 in the V2 record. Column d is 14 bytes from an offset of byte 30 in the record read, and this is set to 14 bytes from an offset of byte 30 in the V2 record. Column e is 16 bytes from an offset of byte 64 in a V4 logical record and is set to 16 bytes from an offset of byte 44 in the V2 record. Column f is 20 bytes from an offset of byte 44 in the record read and is set to 20 bytes from an offset of byte 60 in the V2 record. The V2 record thus being complete, that record is passed to the application program.

Because the logical structure conversion table is not used in rewrite, delete or insert operations, logical conversions between database definition sets are not performed. Within a single version, only conversions between logical structure and physical structure are performed. The logical structure conversion table is updated when a new version of the database definition set is created. Updating may be performed automatically by the database system.

Here we define record, physical structure and logical structure, A record is the unit in which data is stored in a database and consists of a concatenation of one or more fields (columns). As used herein, a record additionally includes information on the version of the database definition set in use at the time that record was created or modified. Logical structure is the structure of a record comprising a concatenation of one or more columns. It may include such information as column sequence, begin offset, length, attribute and history, but must include at least the column's begin offset and length. Physical structure refers to how a record is stored. Of the information stored in records, the information on database definition set version need not be passed to application programs and is managed by the database system.

Logical Structure Conversion Component: Another Implementation

The discussion foregoing addresses the conversion of logical structure with a logical structure conversion table. However, the conversion of logical structure may also be performed without using such a logical structure conversion table. A first method is to maintain logic conversion between versions as program logic. If logical structure conversions between versions are here all stated one-on-one, problems will arise when the number of versions grows large because the number of conversion algorithms would grow geometrically. An implementation of initial conversion to an intermediate format followed by conversion to the target format allows a lower number of logical structure conversion algorithms. A second method is to compare the logical structures in individual versions of database definition sets and transfer identical columns between them. Because column attributes and lengths may have been modified, this would require modifying attributes and lengths rather than simply transferring columns. This discussion applies to all subsequent discussion of logical structure conversion tables.

Retroactive Methods

The discussion next addresses retroactive operations. Retroactive operations consist of preparing the values of columns newly inserted into records previously created and applying them to existing records to give records that include the inserted columns. Newly created records are only those that include the inserted columns.

Retroactive Read Operations

FIG. 50 illustrates a retroactive read operation. An application program 30 issues a read instruction to the database system. The database system performs request-receipt processing 31. It then performs index searching and detects the location storing the target record. Up to this point, procedures are likewise to conventional database systems and non-retroactive read operations. The target record is found in the area storing data (records) 33. Because only records having the most recent database definition set version information (in this case, V4) exist with a retroactive approach, there is no need to store database definition set version information in the records.

As the version information of the record read is V4, the record is sent to the V4 database definition set. Here, the record is read from the block (nomenclature for which varies with the database system) storing the record on the basis of its physical structure. Depending on its physical structure, a single record may be dispersed across multiple databases, and in such cases those requisite multiple databases are read. The record read is then converted to the logical structure of that version. A logical structure conversion table is then employed to convert it to the version of the database definition set of the application program. The converted record is passed to the application program. Records may thus be read, regardless of the version of the database definition set with which the stored record was created and the version information of the database definition set used by the reading application program.

If a newly inserted column is joined to another table, in conventional database systems it will invariably be joined, but in the database described above, if it is accessed by an application program before the column insertion is performed, that column is not passed to the application program and so the application program will suffer no adverse effect even if no value exists corresponding to the column inserted.

Retroactive Rewrite Operations

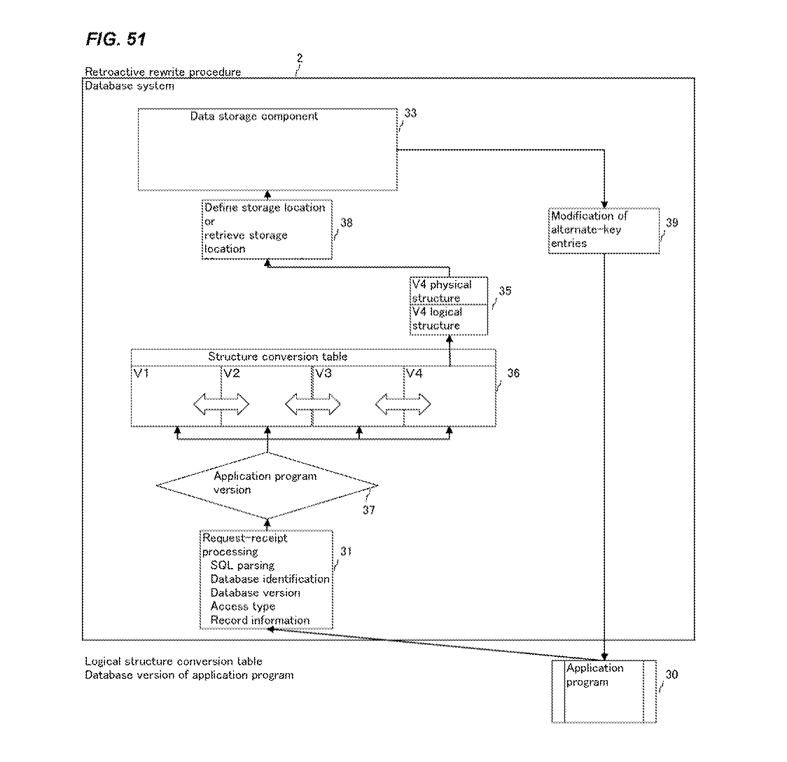

The discussion next concerns FIG. 51. This drawing illustrates a retroactive rewrite operation. An application program 30 makes a rewrite request to a database system 2. The database system executes request-receipt processing 31. Next, a logical structure conversion table 36 is employed to convert the database definition set version of the application program. Here, the only logical structure conversion output is V4, the most recent. Next, the logical structure is converted to a physical structure according to a V4 database definition set 35. Next, the storage location is defined. This record was read by a read operation, and since there will have been no change in its storage location if exclusion was imposed at that point, the storage location at the time of the read operation is defined. If the read operation was not exclusive, the storage location may have changed during the period until the rewrite operation is performed and so the storage location is retrieved. Next, if the space in the block storing the record that was previously occupied by the record to be stored and the new space required in that block are different, successive records inside the block are shifted. Also, version information is defined 38 to the record stored. The record is then stored. Next, if modification involving an alternate key has occurred, modification 39 is performed for that alternate key.

Retroactive Delete Operations

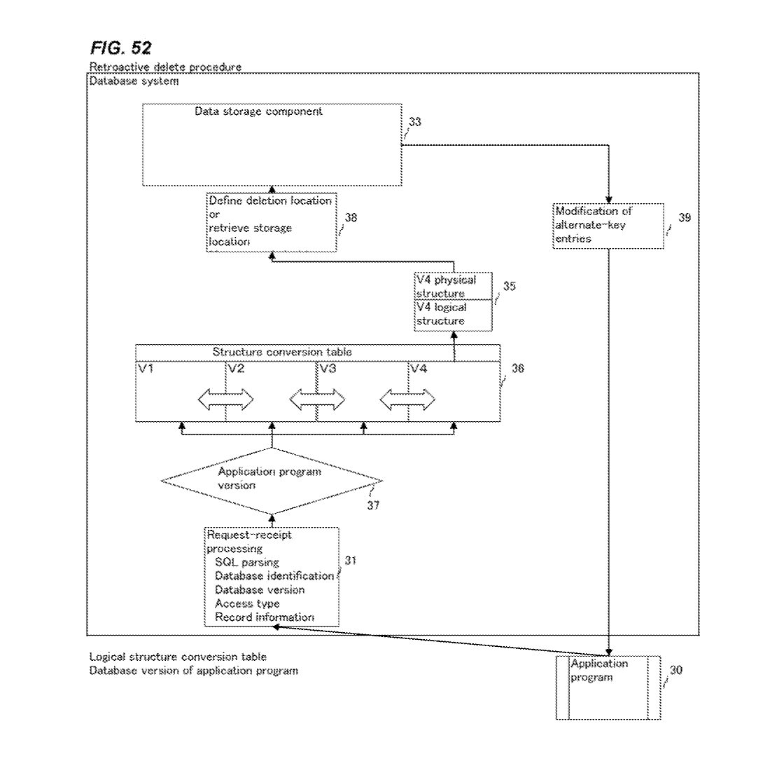

FIG. 52 illustrates a retroactive delete operation. It resembles a rewrite operation. A delete operation generally consists of once reading a record and then deleting it, but a deletion may also be performed abruptly by assigning a key value. Request-receipt processing 31 and conversion of logical structure to V4 by a logical structure conversion table 36 are performed, and physical structure conversion is performed according to the V4 database definition set. These procedures are likewise to a rewrite operation. Next, the storage location is defined or the storage location retrieved. This is also likewise to a rewrite operation. Since the space occupied by a record is left empty if that record is deleted, any records successive to that record must be shifted. Deletion of the record is then performed. Next, if it has alternate keys, the alternate-key entries relating to that record are deleted.

Retroactive Insert Operations

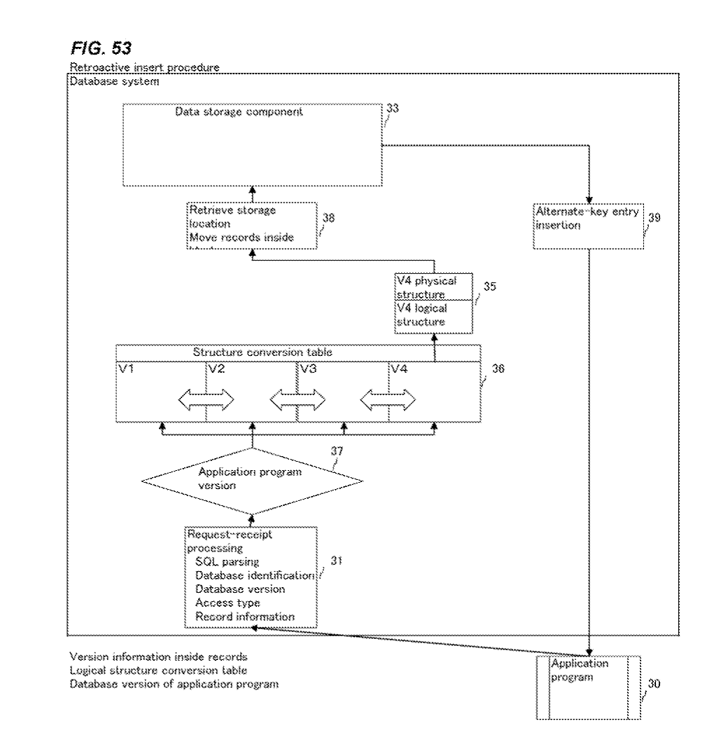

FIG. 53 illustrates a retroactive insert (record insertion) operation. As in the above examples, request-receipt processing is performed. Performing an insertion requires record information. Information concerning keys is not required because it is included in the record. Allocation is performed according to the database definition set version. Conversion of logical structure and physical structure is then performed according to the database definition set. Once the storage location is retrieved, records successive to that record in the block in which that record is stored are moved, and the record stored. Alternate-key entries are also inserted. Structure conversion is likewise to non-retroactive operations.

Special Database Structures

Now, in almost all database systems a database must be interrupted in order to insert a column into an existing record. Use of a database Invention disclosed in “Information storage and retrieval system” (Japanese Patent 3345628, U.S. Pat. No. 6,654,868) invented by the present inventor or in the “Database storage and retrieval system” enables the insertion of columns into existing records with uninterrupted operation of the database.

The present inventor has invented these information storage and retrieval systems providing acceleration and ease of maintenance through the utilization of such means as the introduction of the concepts of location tables and alternate-key tables instead of conventional hierarchical indices, the simplification of the complex processing that accompanies indexing and the application of binary searches on the tables themselves. Further, in “A database reorganization system and a database system” (PCT/JP03/11592, hereinafter “Database reorganization system”), the present inventor has proposed a framework enabling reorganization to be performed on a database of the “Information storage and retrieval system” while the database is in operation. A further invention enables efficient reorganization by means of the addition of alternate-key location tables for alternate-key tables.

In “Database accelerator” (PCT/JP03/13443, hereinafter “Accelerator function”), the present inventor has also invented retention in an accelerator system of copies of location tables and alternate-key location tables, and parallel processing capabilities for access though the use of the accelerator system's location tables and alternate-key location tables when retrieving a record.

In “Information storage and retrieval system” the present inventor has also invented a system of employing overflow-block management tables to link to overflow blocks from primary blocks and to overflow blocks from overflow blocks. The overflow-block management table is likewise a means of using alternate-key overflow-block management tables to link alternate-key blocks and alternate-key overflow blocks and to link alternate-key overflow blocks and alternate-key overflow blocks in the same fashion.

Information Storage and Retrieval System

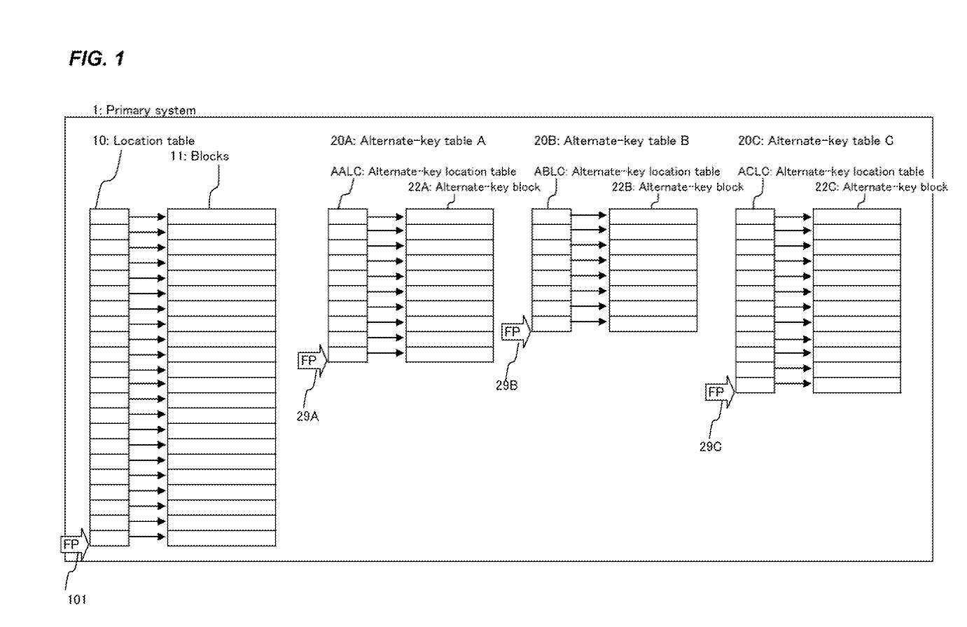

A brief description follows, with reference to FIG. 1, of the information storage and retrieval proposed by the present inventor. Primary system 1 is a principal example of systems that implement the information storage and retrieval system. Data records are stored in blocks 11 in the order of their primary keys. The blocks 11 are made up of primary blocks and overflow blocks, but FIG. 1 depicts primary blocks only. If a primary block is full when a data record is inserted into that primary block, the data record is stored having linked an overflow block linked to that primary block. An overflow block may be linked to a further overflow block. A location table LC is provided that holds in a contiguous region location table records (or location table entries) that contain the addresses of the primary blocks. The location table LC is secured beforehand in a contiguous region. This contiguous region is one of logical order and may span separated physical regions. If so, an address conversion table may be used to treat them as logically contiguous. This applies likewise below. A final pointer 101 is used to indicated the end of a region used by a location table.

When a record cannot be inserted in a final primary block, a primary block is added subsequent to it and the record stored therein. The address of the added primary block is written to the location table LC and the position of the final pointer shifted one place downwards.

Links do not refer to physical linkage; this terminology is used (here and below) because the state in which a primary block maintains the address of a first overflow block and the first overflow block maintains the address of a second overflow block allows the blocks to be treated as though physically connected. Being stored in this fashion, location table entries are in the order of their primary keys. Retrieval by primary key consists of finding a block by performing a binary search between the first address in the location table LC and the location table entry pointed to by the final pointer 101, finding the block and finding the target record within that block. Any overflow blocks linked to that block are also subjected to the search. While this description addresses retrieval, record updating, insertion and deletion may also be implemented with similar logic.

An alternate key is a non-unique key in a database, such as employee name or date of birth in an employee master database. Depending on the database, alternate keys may be absent or may be a plurality. FIG. 1 illustrates an example in which three alternate keys exist. Alternate-key records (or alternate-key entries) made up of the alternate-key value and the primary-key value are stored in alternate-key blocks (22A, 22B and 22C) in the order of their alternate-key values. If an alternate-key block is full when an alternate-key entry is inserted into that alternate-key block, an alternate-key overflow block is linked to the alternate-key block and the alternate-key entry stored therein. An alternate-key overflow block may be linked to a further alternate-key overflow block. Alternate-key overflow blocks are omitted in FIG. 1.

Alternate-key location tables (AALC, ABLC and ACLC) are provided that hold in contiguous regions alternate-key location table records (or alternate-key location table entries) that contain the addresses of the alternate-key primary blocks. The alternate-key location tables are secured beforehand in contiguous regions. Alternate-key final pointers (29A, 29B and 29C) are used to indicate the end of the regions used by the alternate-key location tables. In the insertion of an alternate-key entry, an alternate-key entry having an alternate-key value greater than the alternate-key values of existing alternate-key entries is stored in the last alternate-key block, and if it cannot be stored in that alternate-key block, a new alternate-key block is created and the record stored in that alternate-key block.

A set of alternate-key location tables and alternate-key blocks is termed an alternate-key table (20A, 208 and 20C). A method retrieving a record having a given alternate key is to perform a binary search between the first entry in the alternate-key location table and the alternate-key location table entry pointed to by the alternate-key final pointer, find the target alternate-key block, search within that alternate-key block and find the alternate-key entry having the target alternate key. Any alternate-key overflow blocks linked to that alternate-key block are also subjected to the search. Next, a binary search is performed on the location table LC with the primary key of that alternate-key entry to find the target block and find the target record within that block. Any overflow blocks linked to that block are also subjected to the search.

Since alternate keys are non-unique keys, multiple records that have the same alternate-key value may exist. If so and the next alternate-key record in the alternate-key block has the same alternate-key value, the above operations are repeated. While this description addresses retrieval, record updating, insertion and deletion may also be implemented with similar logic. Where multiple alternate keys exist, alternate-key tables are created and used in the same quantity as that of the alternate keys.

Database Reorganization System

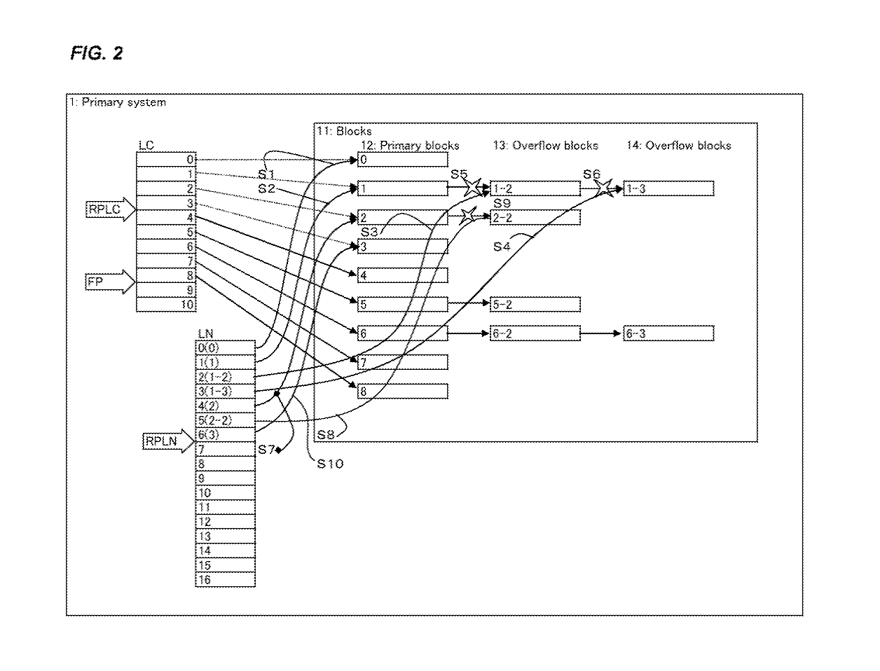

Next, the recitation describes a database reorganization system with reference to FIG. 2. In “Database reorganization system” a framework is proposed that takes advantage of the simple structure proposed in the “Information storage and retrieval system” to perform reorganization without interrupting the database. A brief description of this database reorganization system follows. Reorganization consists of performing three operations: the elimination of overflow blocks, the reservation of suitable initial storage rates and the elimination of fragmentation. The elimination of overflow blocks consists of the following. When many overflow blocks are linked to a primary block and records are to be inserted into those blocks, large numbers of records must be moved because records stored across a primary block and overflow block must be stored in the order of their primary keys. Efficiency is also degraded as the retrieval of records requires retrieval to be performed across multiple blocks. In order to avoid such circumstances, overflow blocks are eliminated and made into primary blocks.

The reservation of suitable initial storage rates consists of the following. If a block is provided with a suitable proportion of empty space, a record may be inserted therein immediately without adding an overflow block. After repeated instances of record insertion, however, the empty space diverges from the suitable initial storage rate. The reservation of suitable initial storage rates consists of returning them to their initial state. While the elimination of fragmentation resembles the reservation of suitable initial storage rates, it consists of imposing a uniform state of utilization on blocks by such means as pruning primary blocks and overflow blocks that are no longer needed and consolidating blocks with low storage rates. Although this recitation has concerned itself with primary blocks and overflow blocks, it applies entirely likewise to alternate-key blocks and alternate-key overflow blocks.

Two location tables, a current location table LC and a new location table LN, are provided for the reorganization of a location table and blocks. Each location table is further provided with a reorganization pointer, one RPLC for the current location table and one RPLN for the new location table, to indicate how far reorganization has completed. FIG. 2 illustrates the elimination of overflow blocks. Blocks 11 pointed to by the current location table LC consist of primary blocks 12 and overflow blocks 13 and 14. As the first block of the current location table LC is made up only of a primary block 0, it is written over to the first location table entry in the new location table. Looking next at primary block 1, it is linked to overflow blocks 1-2 and 1-3. The primary block 1 is written over to location table entry 1 in the new location table LN. Next, the overflow block 1-2 is delinked, the address of the overflow block 1-2 written to entry 2 in the new location table LN and the overflow block made into a primary block. The address of the overflow block 1-3 is likewise written to entry 3 in the new location table LN, and the overflow block 1-3 likewise made into a primary block.

Overflow blocks are successively delinked in like fashion, and FIG. 2 depicts the point at which the elimination of overflow blocks has completed through block 3 managed by entry 3 of the new location table LC. The current location table reorganization pointer RPLC is pointing to the address after entry 3 of the new location table LC. The new location table reorganization pointer RPLN is pointing to the address after entry 6 in the new location table.

Next, the reservation of suitable initial storage rates and the elimination of fragmentation act on multiple blocks at once, moving records between primary blocks and overflow blocks that lack suitable initial storage rates and, depending on the circumstances, deleting and adding blocks. Although this recitation has concerned itself with primary blocks and overflow blocks, it applies entirely likewise to alternate-key blocks and alternate-key overflow blocks.

A database may be accessed during reorganization. The recitation first addresses retrieval. Retrieval entails determining whether the primary key of the record stored in the block pointed to by the entry pointed to by the reorganization pointer RPLC is greater than or less than the value of the target primary key. If less than that value, the new location table LN is used to retrieve the target record by performing a binary search on the range between its beginning and the location pointed to by the reorganization pointer RPLN. If greater than or equal to that value, the current location table LC is used to retrieve the target record by performing a binary search on the range between the locations pointed to by the reorganization pointer RPLC and a final pointer FP. Although this recitation has addressed retrieval, it applies likewise to updating, insertion and deletion.

Reorganization and access of alternate-key tables may be executed with procedures much the same as those applied to location tables and blocks. A new invention teaches the maintenance of alternate-key location tables for alternate-key tables. This completes the recitation herein of database reorganization systems.

Implementations with Overflow-Block Management Tables

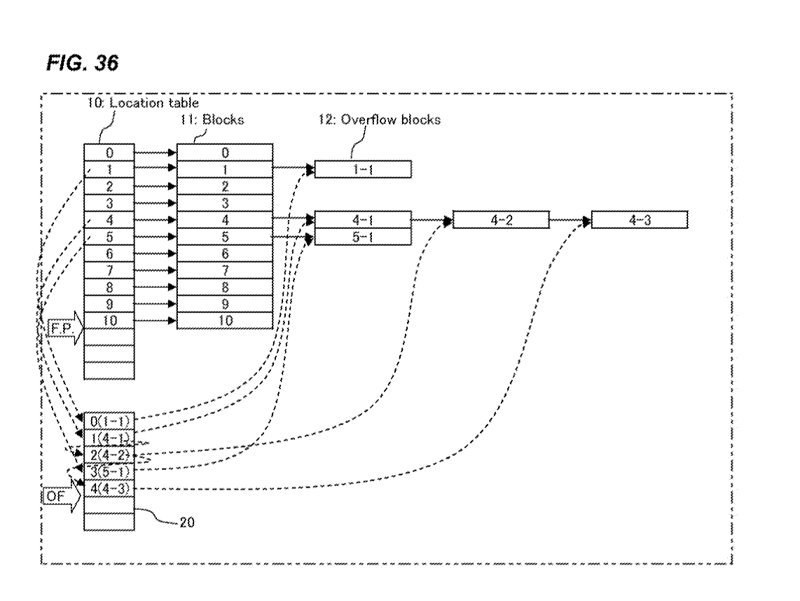

The foregoing recitation is of links between primary blocks and overflow blocks and between overflow blocks and overflow blocks in the form of the block immediately antecedent to the block maintaining the address of that block. “Information storage and retrieval system” teaches a means of implementing links between primary blocks and overflow blocks and between overflow blocks and overflow blocks using an overflow-block management table, as shown in FIG. 36. In FIG. 36, three overflow blocks are linked to a primary block pointed to by location table entry 4. These addresses are maintained in overflow-block management table entries 1, 2 and 4. Because there is no need to read overflow blocks sequentially, such an implementation permits fast access when blocks and overflow blocks are stored in storage devices that are slower than a location table.

The foregoing recitation summarizes the existing inventions of the present inventor that are relevant to the present invention. The recitation addresses a case of performing the addition, deletion and modification of columns in a database employing an invention of the “Information storage and retrieval system” or of the “Database storage and retrieval system” without interrupting the database. In particular, the recitation shows that column insertions and deletions may be performed on existing records in a database in uninterrupted operation by employing retroactive column insertion and non-retroactive column deletion; that where column insertion is performed using a child database, records split across multiple databases may be consolidated into one database in reorganization while the databases continue to run; and that deleted columns may also be assigned to a child database in column deletion.

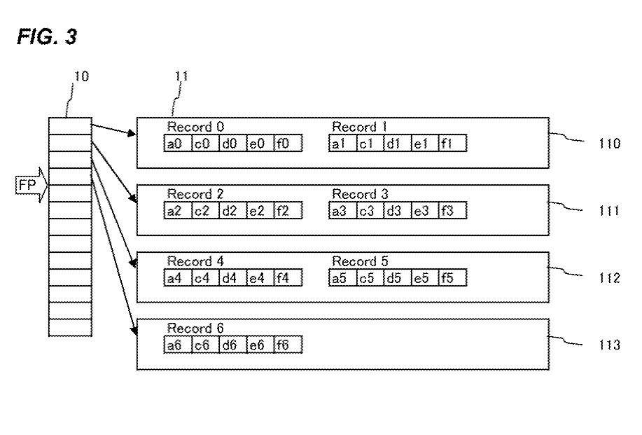

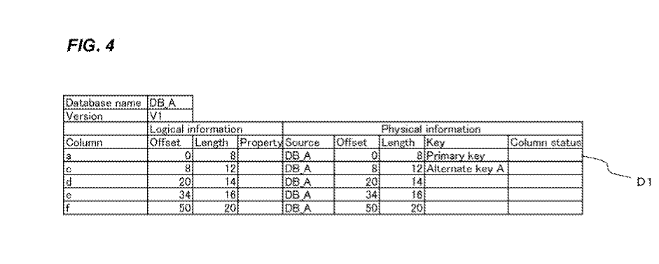

FIG. 3 is an archetype of the database employed in a preferred embodiment of the present invention. The recitation here conforms with the methods disclosed in “Information storage and retrieval system” with respect to links between primary blocks and overflow blocks, between overflow blocks and overflow blocks and links between alternate-key blocks and alternate-key overflow blocks and between alternate-key overflow blocks and alternate-key overflow blocks. Here, these are depicted with a location table 10 and blocks 11. Seven records, record 0 through record 6, are stored in the blocks. Each record contains the five fields (columns) a, c, d, e and f. The methods of storing and retrieving these records are those taught in “Information storage and retrieval system”. Alternate-key tables are here omitted. FIG. 4 provides a database definition set for the archetypal database of FIG. 3. A database definition set will contain such information as describing the physical configuration of the database, the size of blocks, suitable initial storage rates and data formats, but in this drawing is limited to such information as required for the present invention. A database definition set is digitized database definition information.

The recitation next addresses the insertion of columns. There are two approaches, roughly speaking, to inserting columns: retroactive and non-retroactive. Since each of these may be performed either with a child database or directly, in all there are four methods of implementation.

Column Insertion

Retroactive Column Insertion

Retroactive column insertion consists of preparing beforehand the column value to be inserted into a record previously created and inserting that value into an existing record. This approach is one in which both the existing record and the value of the inserted column are retained.

Retroactive Column Insertion with a Child (Subsidiary) Database

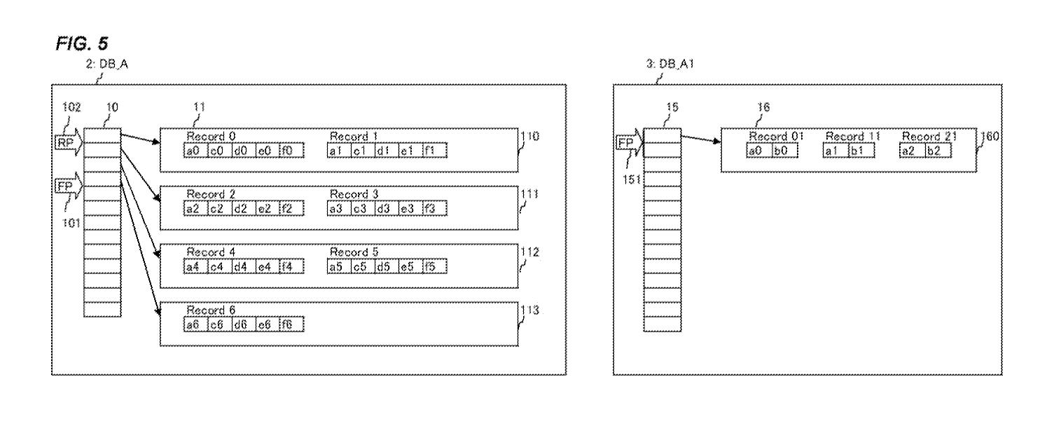

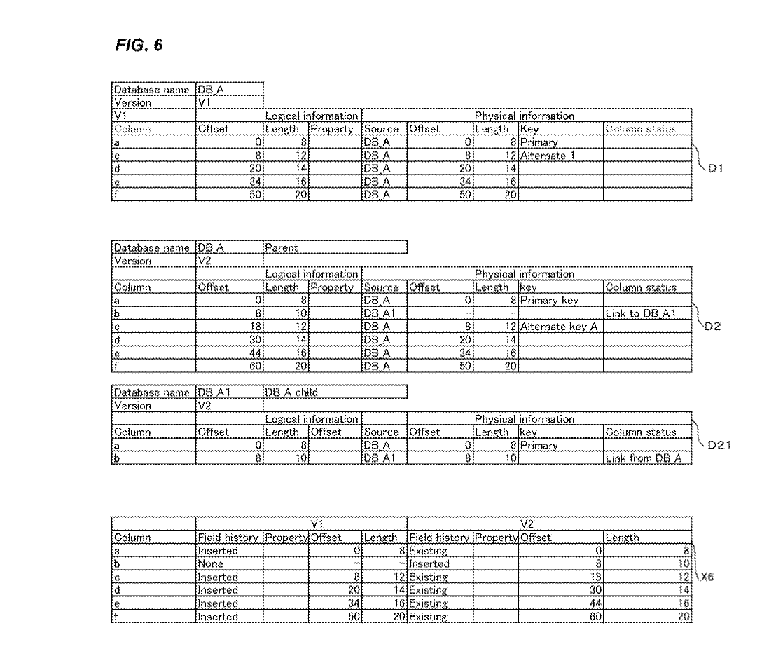

The recitation describes, with reference to FIGS. 5 and 6, the insertion of a new column (field) b in the database of FIG. 3. The method described here consists of creating the inserted column as a child database. This method is referred to as retroactive column insertion with a child database. First, a system administrator instructs the database system to insert a column b directly after a column a by means of retroactive column insertion with a child database. This instruction should be given in an interactive, on-screen interface. After the column b is inserted, the database system creates a database definition set V2 (D2 and D21 in FIG. 6). In FIG. 6, a definition-set cross-reference table X6 is additionally written. The means of creating the database definition set V2 and definition-set cross-reference tables is described below. In D21 of FIG. 6, a separate database DB_A1 is added to DB_A. DB_A is the parent database and DB_A1 the child database. FIG. 6 also includes V1, but essentially if only the most recent database definition set is available, earlier versions of the database definition set are not required in retroactive operations. Next, a child location table 15 is created for DB_A1. A final pointer 151 is deployed and set to point to the beginning of the child location table 15. A child block 16 of DB_A1 may be acquired each time a record is stored, or the required number of blocks may be acquired beforehand. The foregoing consists of the preparatory operations. Although column b has actual meaning in DB_A1, because retrieval and updating cannot be performed with column b alone, it is combined in a record with the column a primary key of DB_A and stored in block 16.

Next, column b is inserted. This being a retroactive operation, the data pertaining to the content of column b is prepared beforehand and taken to exist outside these databases. The recitation first describes the insertion of column b in record 0. Once record 0 is read and the record confirmed to exist, the first entry of the child location table 15 of DB_A1 is placed under exclusion, a child record 01 created with the combination of the primary key of record 0 and the record 0 column b (data that is actually external to the database), and the record 01 written to the child block 0 (160). Next, the recitation describes the insertion of column b in record 1. It will be stored, in this case, in the same block as record 01. Likewise, record 1 is read, a child record 11 created with a combination of the primary key of record 1 and the record 1 column b, and stored in the child block 0 (160) of DB_A1. Record 21 is likewise stored in the child block 0 (160) of DB_A1. As the block 0 has now reached its suitable initial storage rate, exclusion is lifted on the entry 0 of the location table. This description entails reading the records of DB_A; this is done in order to confirm that, at the time of a column insertion, that record has not already been deleted from DB_A.

The arrows labeled FP, one each pointing to the location tables of DB_A and DB_A1, are final pointers (101 and 151) that indicate how much of each location table is in use. Data access efficiencies may be gained by using, in addition to the final pointers, a column operation pointer 102 in order to indicate through which record column b has been inserted by pointing to the block storing the record in which column b has been inserted. Where a column operation pointer is employed, column insertion should be performed in units of a DB_A block. Column insertion has completed through record 2 in FIG. 5, the column operation pointer 102 is pointing immediately subsequent to block 0 because in the block unit it has completed through block 0 (110).

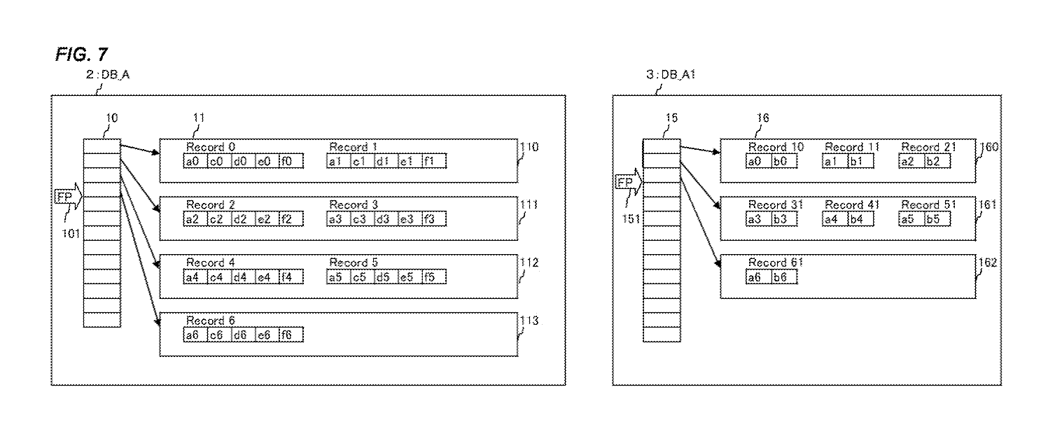

However, if records do not exist in DB_A1, the insertion of column b may be reckoned incomplete even without the use of a column operation pointer. In FIG. 7 column b has thus been inserted through record 6, illustrating the state in which column insertion is completed. It is simplest to define the completion of column insertion as the point at which the end of column-insertion data is detected. When column insertion is complete, the column operation pointer would point to the same location as the final pointer 101 and so be unnecessary, and therefore is not shown in FIG. 7.

The foregoing omits discussion of alternate keys, which are handled as follows. First, alternate keys existing prior to the addition of column b are handled as ancillary to DB_A. As they are not affected by the insertion of column b, no operations on them are necessary. Next, if column b affects an alternate key, DB_A1 is notified at the initial preparatory stage that column b is an alternate key. Next, an empty alternate-key table for column b is created in DB_A1. Next, in parallel with the creation of record 01, record 11 and so on, alternate-key entries made up of column b and column a are created and stored in the alternate-key block. The alternate-key table for column b may also be created in DB_A, or it may be created in DB_A1.

Record Insertion Subsequent to Completed Column Insertion

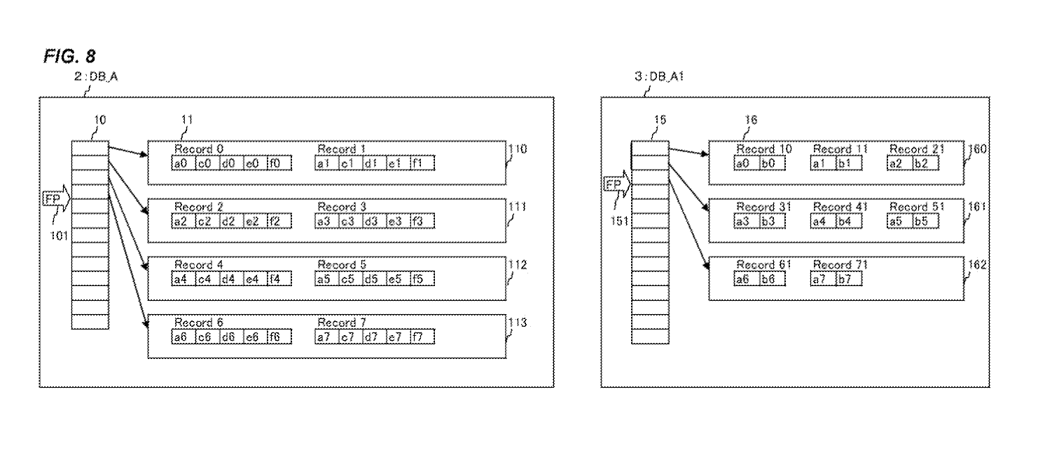

Next, the recitation describes, with reference to FIG. 8, the insertion of a record subsequent to the completion of column insertion. Records newly created in retroactive operations should be exclusively records that include an inserted column. In the retroactive approach, since those application programs using previous versions of a database definition set that insert records lack information pertaining to inserted columns they should define column values that are default values or null values, or define the columns as lacking data. Alternatively, those application programs using a database definition set other than the most recent that insert records may also not be allowed to run.

This description is with reference to FIGS. 8 and 53. The insertion of a record by an application program is as follows. The insertion is of a record 7. FIG. 8 depicts the point at which the insertion of record 7 has completed. The retroactive approach is a method that does not allow an application program not using the most recent version of a database definition set to run; this method is an established one and therefore not novel. The recitation here addresses in particular the case of record insertion by an application program using the latest version of a database definition set.

FIG. 53 depicts database definition sets through a V4, but let the logical structure conversion table 36 consist of the two versions V1 and V2, and let the most recent database definition set be for V2. Where an application program uses the V2 database definition set, the conversion of logical structure is unnecessary and so record insertion is performed as it normally is. The recitation now describes the case of an application program using the V1 database definition set. First, request-receipt processing is performed on the processing request from the application program. Next, the logical structure conversion table 36 is used to convert the V1 logical structure to the V2 logical structure. The specific format of the logical structure conversion table 35 is as depicted in X6 in FIG. 6. Column a in V1 (8 bytes from an offset of byte 0) is set as 8 bytes from an offset of byte 0 in V2. As column b is not maintained in V1, the value of the V2 column b (10 bytes from an offset of byte 8) is defined as the default value or a null value, or defined to lack data. Column c in V1 (12 bytes from an offset of byte 8) is set to 12 bytes from an offset of byte 8 in V2. Columns d, e and f are then set likewise. The V2 database definition set (35 in FIG. 53) is then used to convert logical structure to physical structure. The specifics of the V2 database definition set are illustrated in D2 and D21 of FIG. 6. V2 links DB_A and DB_A1 because the insertion of column b was performed with a child database. The parent database may store records defined by the logical structure conversion table in DB_A, but in DB_A1 they are stored after defining the primary key value to the 8 bytes from an offset of byte 0.

The foregoing recitation addresses the use of two versions of a database definition set, but these procedures may be executed with any number of versions by performing logical structure conversions between individual versions of a database definition set, as illustrated in FIG. 53. As stated above, there are also methods other than the use of a logical structure conversion table of performing the conversion of logical structure.

Database Access During Retroactive Addition of a Column with a Child Database

Next, the recitation discusses the ability to access records while such a column insertion is underway. The basic framework is as described, with reference to FIGS. 50 through 53, for access by separate application programs using multiple versions of a database definition set. As FIG. 5 depicts a state part-way through column insertion, the recitation makes reference to this drawing. Reference is additionally made to FIG. 6. An application program using the most recent database definition set V2 of course may access the database, and the recitation sets forth additionally the ability of both application programs using database definition set V1 and application programs using database definition set V1 to access the same database by maintaining individual versions of the database definition set and a logical structure conversion table.

An application program must itself specify which version of the database definition set it uses. The simplest method of doing this is to code it within the application program. This method requires modifying the application program when changing the version of the database definition set it uses. Another possible method would be to specify the version of the database definition set to the application program as external information (as a parameter, for example) and so diminish modifications of the application program entailed by modification of the database definition set version. This applies likewise to other discussion of column insertion, column deletion and column modification. Another possible method would be for the database system to automatically determine which version of the database definition set is in use by looking at the creation date of the application program. This may easily be determined by comparing the creation date of the individual versions of the database definition set and the creation date of the application program.

Before discussing accessing records, the recitation first discusses, with reference to database definition set V2 (D2 and D21) in FIG. 6 the column-status section in a database definition set. The column-status section states the history of the column and its status at that time. The column-status section of column b states, “Link to DB_A1.” This indicates that while column b is logically a column in DB_A, column b is logically linked and does not physically exist immediately subsequent to column a. A more detailed discussion of the diverse uses of a column-status section follow below in a separate section of this specification.

The recitation now addresses, with reference to FIG. 5, the ability to access a database while insertion of a column is underway. Let the request originator be an application program. Let also access be to a primary key, and let that primary key value be a1. First, request-receipt processing is performed. During that time, it is determined whether the source of the request is using database definition V1 or V2. Next, index retrieval is performed. A binary search is performed on location table 10 of DB_A, and record 1 found in block 0. Database definition set V2 is used to convert the physical structure of record 1 into a logical structure. Next, if the application program is using database definition set V1, the logical structure conversion table is used to convert from the V2 logical structure to the V1 logical structure. Methods of structural conversion are as recited with reference to FIG. 54. The converted record is passed to the request originator. If the request originator is using database definition set V2, the logical structure need not be converted and so the record created with the database definition set is passed to the request originator.

The recitation next addresses access to a primary key where the primary key value is a3. The determination of which database definition set the request originator is using is made in the same fashion as described above. Next, a binary search is performed on the location table of DB_A, and record 3 found in block 111. If column operation pointer 102 is in use, it is known, because the target primary key value is greater than the block to which the column operation pointer is pointing, that the access is to a block in which column insertion has not completed and so there is no need to access DB_A1. If the column operation pointer is not in use, a binary search is performed on the child location table of DB_A1 and, since there is no record 31, the record may be reckoned one in which column b has not been inserted. Thus, use of the column operation pointer allows access to be executed efficiently while a column insertion is underway.

If the request originator uses database definition V1, the logical structure conversion table is used, as with the a1 primary key value, to convert the logical structure from V2 to V1, and the converted record is passed to the request originator. If the request originator uses database definition set V2, the logical structure need not be converted and so the record created with the database definition set is passed to the request originator.

In access by an alternate key, the target record may be retrieved by performing a binary search on the alternate-key location table with the target alternate-key value, finding the alternate-key entry with the target alternate-key value in an alternate-key block or an alternate-key overflow block, and performing a primary-key binary search on the location table with the primary key value of that alternate-key entry. Multiple records may exist that have identical alternate-key values; if so, the above operations are repeated.

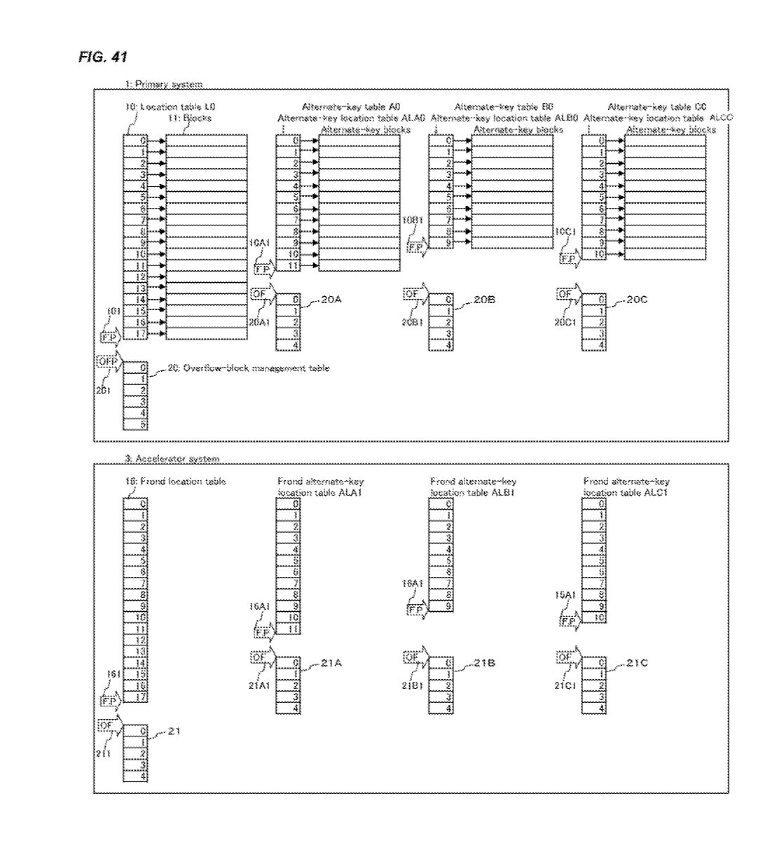

The foregoing recitation concerns the use of a read operation (retrieval), but records may also be updated, deleted and inserted, as discussed with reference to FIGS. 41, 52 and 53. Likewise, in discussion below addresses instances of retrieval where access is possible, but records may also be updated, deleted and inserted entirely likewise to the foregoing example. Records may be updated by updating the record retrieved, and may be deleted by deleting the record retrieved. Insertion may be performed by retrieving the location where the record will be stored and storing the record there. Where necessary, the logical structure conversion table is used to convert the record format.

The insertion of a record by an application program using database definition set V1 should be executed by means of a retroactive operation. The reason is that, after completion of a column insertion, some records will exist that lack a column b. When inserting a record with an application program using database definition set V1, however, an actual database should be created in the database system that defines a default value or a null value to column b or defines the column as lacking data, because records lacking a column b will be written by the application program.

Database Access After Completion of Column Insertion with a Child Database

The foregoing discusses database access while insertion of a column is underway, and those methods may be applied to enable database access without difficulty at the point when column insertion has completed. The difference with access while column insertion is underway is that access following the completion of column insertion will not engender a state in which the insertion of column b has not completed when retrieval is performed with database definition set V2.

The insertion of a column and record retrieval while insertion is underway and following insertion are set forth above with respect to column insertion with a child database. This discussion has addressed the insertion of one column into an existing database, but the methods described above may be employed to insert two or more columns at once or to insert one or more further other columns after the insertion of one column into an existing database. Additionally, while this recitation of the present invention has described the insertion of a column b immediately after a column a, columns may also be inserted at any location in a record, including at the end of a record. Thus, fields of high relatedness may be positioned in close proximity to each other within a record. Another possible method is to add a column to a physical location at the end of a record as inserted at a logical location. This may be stated in the physical structure and logical structure of the database definition set.

Utilization of an Overflow Block Management Table

The foregoing recitation has described application of the methods taught in “Information storage and retrieval system” pertaining to links between primary blocks and overflow blocks and between overflow blocks and overflow blocks and links between alternate-key blocks and alternate-key overflow blocks and between alternate-key overflow blocks and alternate-key overflow blocks. Application to the overflow-block management table taught in “Information storage and retrieval system” is as follows.

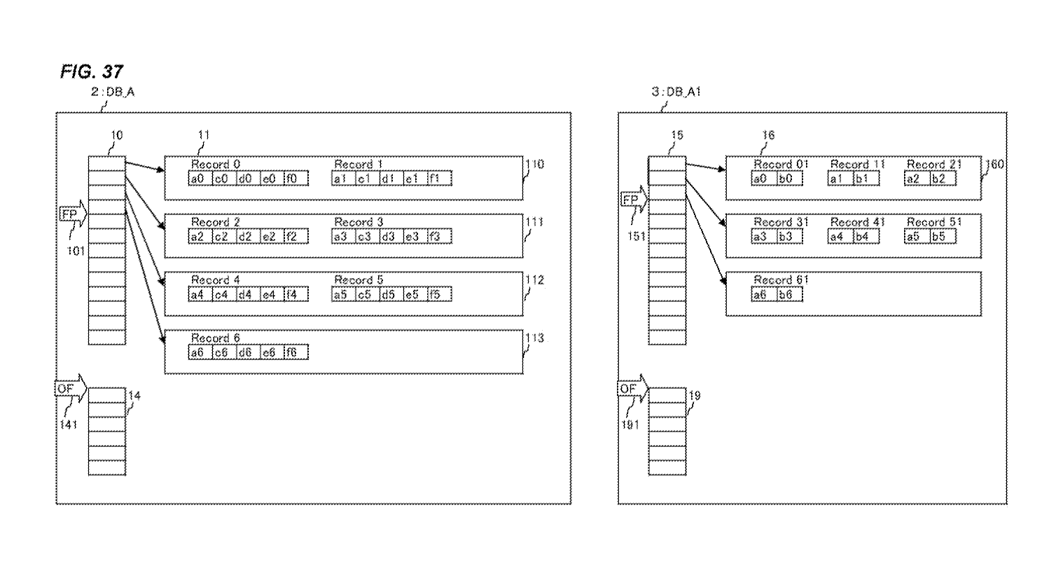

The recitation makes reference to FIG. 37. An overflow-block management table 14 is provided to a parent database (2: DB_A). An overflow-block management table pointer 141 is further provided to the overflow-block management table 14. Likewise, an overflow-block management table 19 is provided to a child database (3: DB_A1). An overflow-block management table pointer 191 is further provided to the overflow-block management table 19. As no overflow blocks have been generated, FIG. 37 does not depict overflow blocks. Both overflow-block management tables are in an unused state. The usage of these overflow-block management tables and methods of access where an overflow-block management table is employed are set forth in the section on overflow-block management tables.

Direct Retroactive Column Insertion

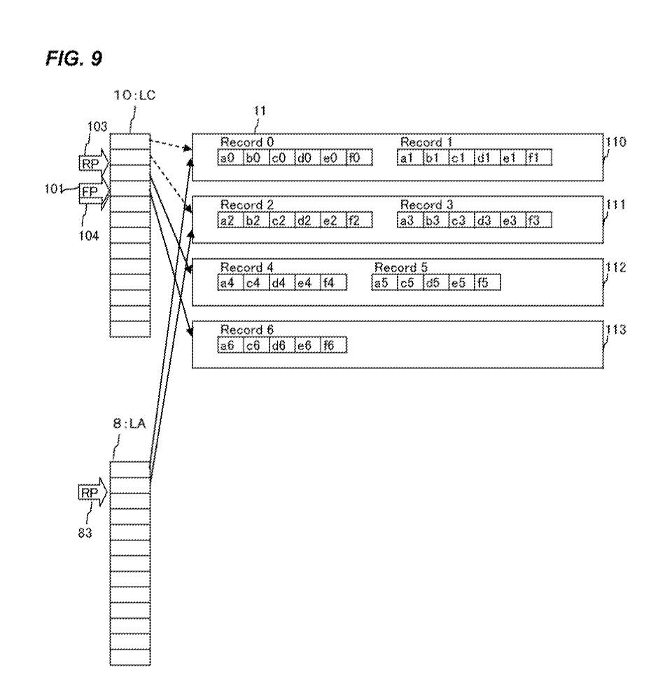

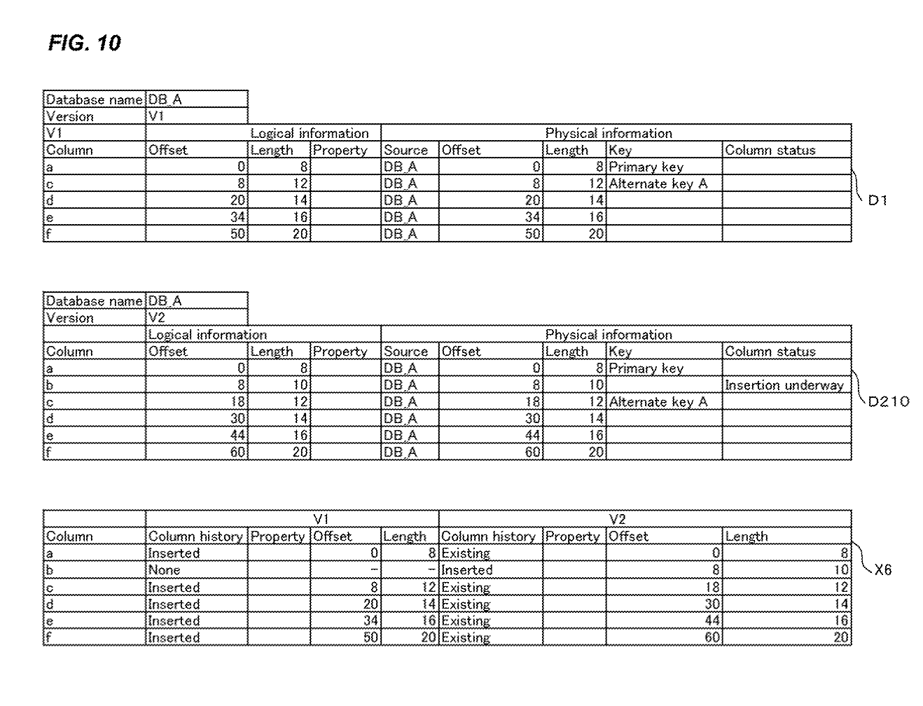

The recitation next sets forth a method of performing column insertion directly on an active database. The description here applies the methods taught in “Information storage and retrieval system” pertaining to links between primary blocks and overflow blocks and between overflow blocks and overflow blocks and links between alternate-key blocks and alternate-key overflow blocks and between alternate-key overflow blocks and alternate-key overflow blocks. This implementation also employs the functionality of “Database reorganization system”. The recitation describes, with reference to FIGS. 9 and 10, the new insertion of a column (field) b into the database of FIG. 3. The method described is that of direct insertion of a column into an active database. This is referred to as direct insertion. As with the child database method, an instruction is first issued to the database system for the insertion of column b by means of direct insertion. The database system creates a new database definition set V2 (D210 in FIG. 10) describing the inserted column b. Database definition set V2 (D210 in FIG. 10) describes the insertion of column b into DB_A and the number of record columns increasing from five to six. The column-history column of V2 (D210 in FIG. 10) states “Insertion underway,” which indicates that insertion of the column is underway, and will instead be blank when the insertion is complete. A logical structure conversion table X6 is created in the same fashion as for retroactive insertion with a child database. Next, a column-insertion location table 8 is created for DB_A. One column operation pointer each (103 and 83) is provided a current location table 10 and the column-insertion location table 8. A column operation completion pointer (104 in FIG. 9) is further provided, having the same value as a final pointer (101 in FIG. 9) immediately prior to initiation of column insertion. The purpose of the column operation completion pointer is to prevent circumstances in which the location pointed to by the final pointer (101 in FIG. 9) progresses when a new record is inserted while column insertion is being performed by means of direct insertion and it thus becomes impossible to determine through which record column insertion must be performed. The location pointed to by the column operation completion pointer remains unchanged until column insertion is completed. When column insertion has been completed, it is no longer required. In direct column insertion, a record inserted after column insertion has initiated should not be stored in a block pointed to by the entry immediately before the location table entry pointed to by the column operation completion pointer, but should be stored beyond the block pointed to by the column operation completion pointer. The foregoing discussion consists of preparatory operations.

Next, the insertion of column b is performed. Let the data to be held in column b be external to these databases. First, exclusion is imposed on the current location table entry 0 the new location table entry 0 and the block 0. Next, record 0 is read and column b inserted in record 0. Record 0 with column b inserted is then written to block 0. Record 1 is read and column b inserted in record 1 in the same fashion. Record 1 with column b inserted is then written to block 1. As block 0 has now reached its suitable initial storage rate, exclusion is released on the current location table entry 0, the new location table entry 0 and the block 0. Both the current column operation pointer (103) and the new location table operation pointer (83) are set to point to the second location table entry.

FIG. 9 depicts the state in which the insertion of column b has thus been performed through record 3. To simplify the explanation, this recitation describes the process as writing records back one by one, but because the record length of record 0 has increased, in fact record 1 must be shifted to the right by that amount when writing back record 0. In order to avoid repeatedly shifting records forward in this way, a method such as calculating the length of records within a block and writing them back collectively should be adopted. This description excludes discussion of overflow blocks, but where overflow blocks exist, the elimination of overflow blocks should be performed simultaneously.

The foregoing recitation describes fitting records that have grown in length into prior and existing blocks; if a record will not fit into a prior and existing block, it is handled as follows. One or more blocks are examined to find the number of records they contain and the length of those records, and the number of blocks N calculated that is required to hold at the suitable initial storage rate the records that have grown in length with the insertion of a column. Let the number of blocks examined be M. How many blocks are examined depends on the circumstances of the records in individual blocks. If M=N, the number of blocks remains unchanged. If M<N, blocks are inserted in a number to make up the difference. Of course, the number of entries in the new location table 8 also increases by that number. If M>N, blocks become unused in a number making up the difference. Records are moved between blocks and the individual blocks adjusted to their suitable initial storage rates. Column insertion and reorganization may thus be performed simultaneously, and the number of reorganization iterations may be reduced by performing them simultaneously. This also applies to direct non-retroactive column insertion and to direct column deletion.

The recitation has here addressed the insertion of one column into an existing database, and it may be seen that the foregoing methods may be employed to insert two or more columns simultaneously and to insert a further one or more other columns in a state in which one column has been inserted into an existing database.

Columns are inserted as described above, and column insertion is completed when column insertion has been performed on the block immediately prior to the current location table entry pointed to by the column operation completion pointer.

The foregoing recitation omits discussion of alternate keys, which are handled as follows. First, the address and block number of a block storing a record pointed to by an alternate-key entry for an alternate key existing prior to the insertion of column b may be modified in reorganization. Therefore, if the block number and block address are maintained in an alternate-key entry, the alternate-key table must be rewritten simultaneously and in parallel, as set forth in “Database reorganization system”. Conversely, if the block number and block address are not maintained in the alternate-key entry, the alternate-key entry will not be modified and no operation need be performed on the alternate-key table.

The foregoing embodiment is described in terms of inserting a column into existing records, and it is self-evident that the insertion of a column at the end of a record may be performed in entirely like fashion.

Access During-Column Insertion by Direct Retroactive Insertion

The recitation next discusses the ability to access records while such column insertion is underway. The discussion will simultaneously address the ability of an application program using an old version of the database definition set to access records by using multiple versions of the database definition set and a logical structure conversion table, as set forth with respect to retroactive insertion with a child database. As FIG. 9 depicts a state part-way through column insertion reference is made to this drawing. The logic described in FIGS. 50 through 53, discussed with respect to retroactive insertion with a child database, applies likewise to this approach.

The discussion addresses a case in which access is by primary key and the primary key value (target key value) is a1. First, request-receipt processing is performed, during which period which version of the database definition set the request originator uses is examined. Next, whether the target key value is less than the primary key value of the record in the block managed by the entry pointed to by a column operation pointer 103 is examined. Here it is found to be lower. If lower, a binary search is performed on a new location table 8. The binary search is performed on location table entries between the beginning of the new location table and the location pointed to by a column operation pointer 83. Block 0 (110) is thus sought and record 1 found within. Database definition set V2 is used to convert the physical structure of record 1 to a V2 logical record. Next, if the application program uses database definition set V1, the logical structure conversion table is used to convert from the V2 logical format to the V1 logical format. The method of structural conversion is as has been recited with reference to FIG. 54. The converted record is passed to the source of the request. If the source of the request uses database definition set V2, there is no need to convert logical structure and so the record created with the database definition set is passed to the source of the request.

Next, the discussion addresses a case in which access is by primary key and the primary key value is a5. This case is one in which the target key value is greater than or equal to the primary key value in the block pointed to by the column operation pointer. In this case, a current location table 10 is used to perform a binary search on the location table entries existing between the location table entry pointed to by the column operation pointer 103 and the location pointed to by a final pointer 101. Record 5 is found in block 2 (112 in FIG. 9). From the column operation pointer information, it is known that column b has not been inserted in record 5. Therefore, the record is of a format created by database definition set V1 (D10 in FIG. 10). Version information for the database definition set with which that record was created may be stored in a specific location inside the record or outside the record, and the format of that record may be definitively ascertained by referencing that information. Database definition set V1 is used to convert physical structure to logical structure. If the request originator uses database definition V1, the record is passed to the request originator as is. If the request originator uses database definition set V2, the logical structure conversion table (X6 in FIG. 10) is used to convert its logical structure from V2 to V1. The created record is then passed to the request originator.

Since application programs using old versions of the database definition set may create new records after the column insertion has completed, such application programs should not be allowed to run, but if such an application program is run, the value in column b is defined as the default value or a null value, or is defined to lack data in the database system.

Access After Completion of Column Insertion by Direct Retroactive Insertion

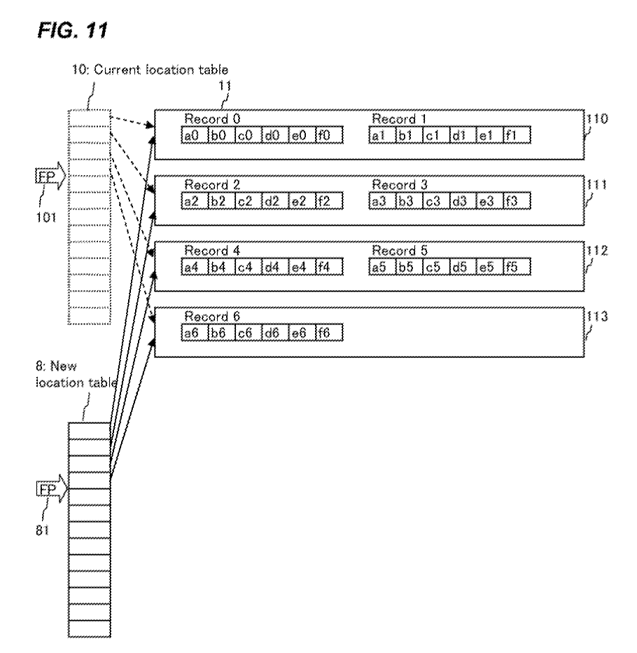

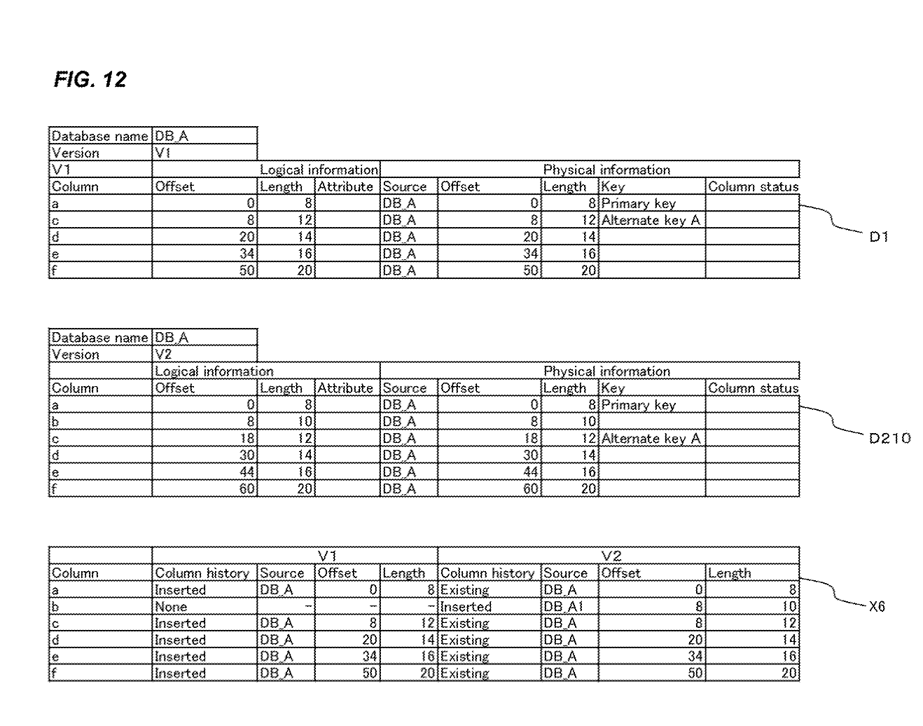

The recitation describes how application programs using different versions of the database definition set may access the database after column insertion has completed. FIG. 11 depicts a state in which column insertion has completed. The database definition set is shown in FIG. 12. The database definition set of FIG. 12 is basically the same as that of FIG. 10, but the column-status column of column b in V2 (D210) is empty because column insertion has completed. Because it is not in fact needed, the previous current location table 10 is represented by dotted lines in FIG. 11. New location table 8 is now the current location table. However, to emphasize that this is a state in which column insertion by means of direct insertion has completed, the recitation employs the term “new location table” here. Given access by primary key and a target key value of a1, first request-receipt processing is performed. Next, a binary search is performed on the new location table 8, and record 1 is found in block 0. Because this record has undergone a column insertion by means of direct retroactive insertion, the format of the record is known to be V2. As stated in discussion of the child database approach, if the version of the database definition set with which the record was created is placed in that record, the version may be ascertained more definitively and easily.

Next, the V2 database definition set is used to convert physical structure and logical structure. Next, it is ascertained whether the request originator uses database definition set V1. If the request originator uses V2, the converted record is passed to the request originator. If the request originator uses V1, the logical structure conversion table is used to convert the logical structure and that record is passed to the request originator.

While this recitation has discussed retrieval, record insertion, deletion and updating may be implemented in entirely like fashion, as set forth in the discussion of FIGS. 51 through 53. These may be implemented with methods likewise to those set forth in relation to child databases.

Access from an alternate key may be achieved by retrieval by primary key from the location table after accessing the alternate-key table and then retrieving the target record.

The foregoing recitation describes the insertion of columns by means of direct column insertion and the retrieval of columns during insertion and after insertion. The recitation has here addressed the insertion of one column into an existing database, but the foregoing methods may be employed to insert two or more columns simultaneously and to insert a further one or more other columns in a state in which one column has been inserted into an existing database. Because direct column insertion consists of the insertion of columns directly into an active database, there is no need to consolidate two databases into one databases in reorganization, as entailed with column insertion with a child database. A method for consolidating these two databases into one is recited below.

Utilization of Overflow-Block Management Table

The foregoing recitation has described application of the methods taught in “Information storage and retrieval system” pertaining to links between primary blocks and overflow blocks and between overflow blocks and overflow blocks and links between alternate-key blocks and alternate-key overflow blocks and between alternate-key overflow blocks and alternate-key overflow blocks. Application to the overflow-block management table taught in “Data storage and retrieval system” is as follows.

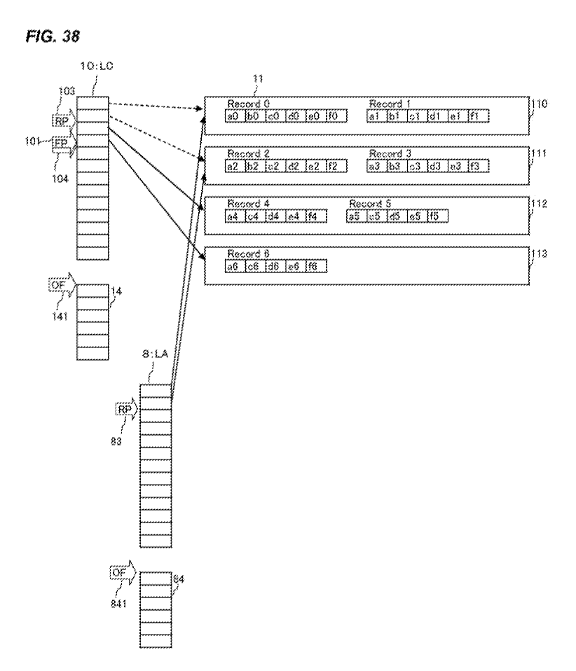

The recitation makes reference to FIG. 38. An overflow-block management table 14 is provided to a current location table 10. An overflow-block final pointer 141 is further provided to identify the final entry in the overflow-block management table. This much is required irrespective of column insertion. A new location table 8 is created in order to perform direct column insertion. A new overflow-block management table 84 and a new overflow-block final pointer 841 are further created for the new location table 8. Overflow blocks are omitted from FIG. 38 because none have been generated. Both overflow-block management tables are as yet unused. The methods described in the section on overflow-block management tables are employed to utilize these overflow-block management tables and to perform access using them.

Non-Retroactive Column Insertion with a Child Database

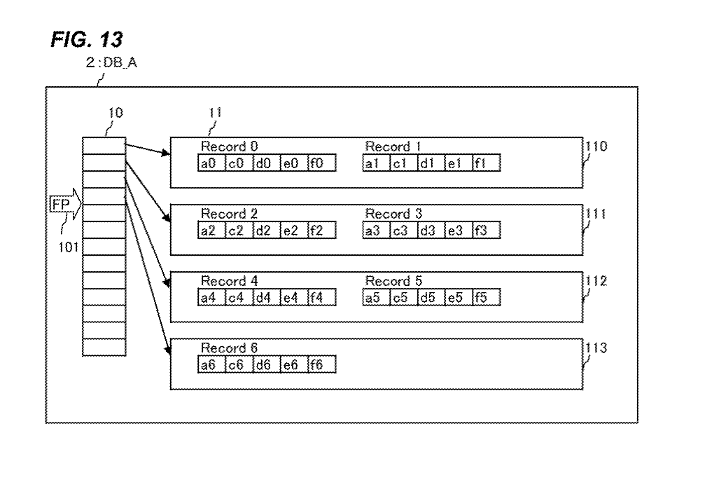

The recitation next discusses, with reference to FIGS. 13 through 16, non-retroactive column insertion with a child database. Non-retroactive column insertion with a child database is basically similar to retroactive column insertion with a child database and consists of inserting a newly inserted column from records created after modification of a database definition set without inserting the column into records created in the past. Records created after modification of the database definition set may also consist solely of records with the column inserted, and these may also be commingled with records created with previous versions of the database definition set. Since the insertion of records of multiple versions comprehends the insertion only of records of a single version, the recitation here addresses primarily the insertion of records of multiple versions.

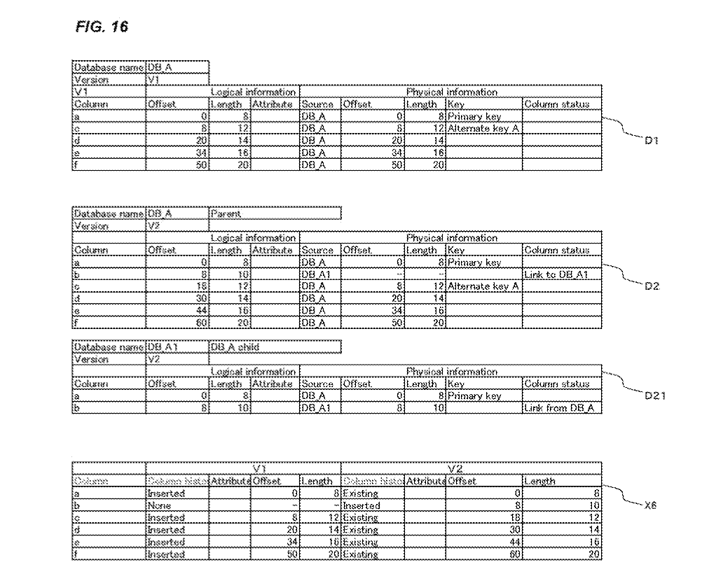

FIG. 13 is a database about to perform insertion of a column b by means of non-retroactive insertion with a child database. Seven records, record 0 through record 6, have here already been created. At this point a decision is take to insert column b, and the instruction issued to the database system. Upon receiving the instruction, the database system creates a definition set V2 (D2 and D21 in FIG. 16) for the database with column b inserted. FIG. 16 also depicts a logical structure conversion table X6. Methods for the creation of the database definition set V2 and the logical structure conversion table are recited below. At D21 in FIG. 16, a separate database DB_A1 is added to DB_A. DB_A is the parent database, and DB_A1 the child database.

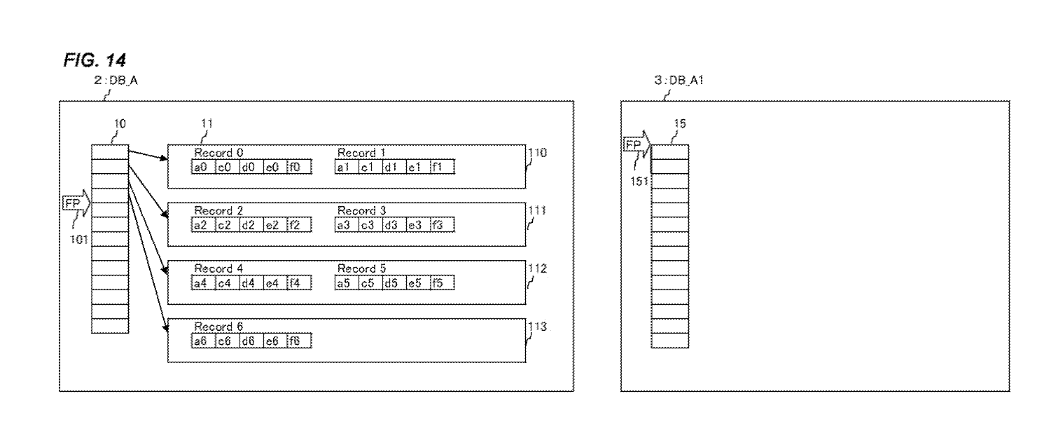

Next, a child location table (15 in FIG. 14) is created for DB_A1. A final pointer 151 is deployed and made to point to the beginning of the child location table 15. DB_A1 child blocks 16 may be acquired each time a record is stored, or the requisite number of blocks may be acquired beforehand. The foregoing consists of preparatory operations. Although column b has actual meaning in DB_A1, retrieval and updating cannot be performed with column b alone, and so its records consist of combinations with the DB_A primary key column a and are stored in the blocks 16. FIG. 14 illustrates this state. This state is maintained if no record is inserted. As access to this database may be performed by accessing DB_A alone, it presents no particular problem.

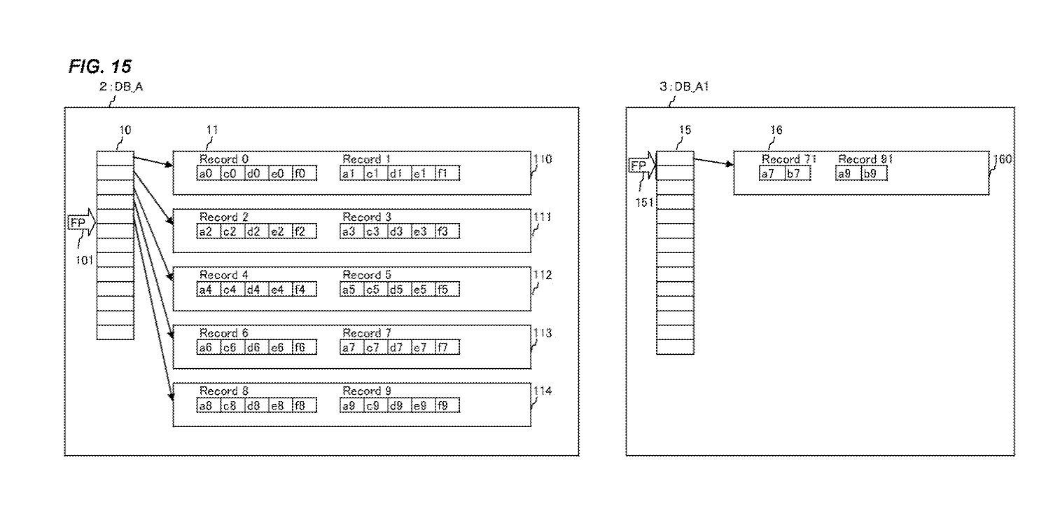

Next, the recitation addresses the insertion of records. The recitation here makes reference to FIGS. 46 through 49. The insertion of a record by an application program is performed as follows. First, a record 7 is inserted by an application program using database definite on set V2. Request-receipt processing is performed in the database system, as shown in FIG. 49. Next, the database definition set version of the application program is ascertained. It being V2 here, database definition set (35 in FIG. 49) V2 is used to convert logical structure and physical structure. Here records consisting of a single column and excluding column b are stored in DB_A. Child records made up of column a and column b, with column a as their primary key, will be stored in the child database (DB_A1). The DB_A record (record 7) will be stored in the final location by means of comparison with the final pointer. In this case, it is stored in block 3 (113). Next, the DB_A1 record (record 71) is stored in block 0 (160 in FIG. 15) of DB_A1.

Next, the recitation discusses the writing of a record 8 by an application program using database definition set V1, Request-receipt processing and allocation by means of the database definition set version are likewise to operations for record 7. Conversion of logical structure and physical structure is performed with the V1 database definition set. In this case, a record including column b is stored in DB_A only, and no operations are performed on DB_A1.

FIG. 15 depicts a state in which record 91 has been written by an application program using V2. The foregoing description has addressed the writing of records by application programs using multiple versions of a database definition set. The discussion here has been of two versions, but the system will run in a state with multiple versions existing, as set forth in the discussion of FIGS. 46 through 49.

When records are thus written by application programs using multiple versions of a database definition set, it becomes problematic to determine their record formats. In order to avoid such circumstances, record format may be definitively ascertained by, as set forth in the recitation of retroactive operations, storing version information for the database definition set with which that record was created in a specific location inside the record or outside the record. As shown in FIG. 17, for example, database definition set version information inside a record stores at a specific location in the record the version information of the database definition set in use at the time that record was created. The record length in FIG. 17 indicates the length of records that are records of variable length, but it may also be placed outside, by storing it together with record location in a specific place in a block not inside the record, as when employed with VSAM. The version of the database definition set with which the record was created may also be stored there. This is depicted in FIG. 18.

Database Access in Non-Retroactive Column Insertion with a Child Database

Next, the recitation addresses accessing records where non-retroactive column insertion with a child database is used. As records written from an application program using database definition set V1 and from an application program using V2 are commingled in FIG. 15, the recitation makes reference to FIGS. 15 and 16. FIGS. 46 through 49 are also informative. Let the request originator be an application program. Also let access be by primary key, and let the primary key value be a1. First, request-receipt processing is performed, and it is ascertained during that time whether the request originator is using database definition V1 or using V2. Next, a binary search is performed on the location table 10 of DB_A, and record 1 found in block 0. Next, it is ascertained from the database definition set version information in the record with which database definition set this record was created. In this case, it was created with V1. The database definition set for this version is used to convert from physical structure to logical structure.

If the request originator uses database definition set V1, the version of the creating database definition set and the version of the request originator are the same, and so the record read is passed to the request originator as is. If the request originator uses database definition set V2, V1 and V2 of the logical structure conversion table (X6 in FIG. 16) are referenced. In V2, record columns are made up of columns a, b, c, d, e and f. The source of column b is given as “DB_A1” in V2, and the column-status section states “Linked from DB_A.” This indicates that column b exists in DB_A1, and the actual record does not have a column b because it was created with database definition set V1. The record passed to the request originator is created with the V1 information of the logical structure conversion table X6 as the sender and the V2 logical location information as the receiver. The 8 bytes from an offset of byte 0 of the record read are placed in the 8 bytes from an offset of byte 0 in the record passed, the 12 bytes from an offset of byte 8 in the record read are placed in the 12 bytes from an offset of byte 18 in the record passed, the 14 bytes from an offset of byte 20 of the record read are placed in the 14 bytes from an offset of byte 30 in the record passed, and column e and column f then defined. Because no value is present in column b in the record read, column b should be assigned the default value or a null value, or defined as a column lacking data. Once the record is complete, it is passed to the request originator.

Next, the recitation addresses an instance of access by a request originator to a record created with database definition set V2. Where access is to record 7, a binary search is performed on the location table 10 and record 7 found in block 3 (113 in FIG. 15), as above. The version of the database definition set with which this record was created is ascertained, and in this case it is found to be V2. When database definition set V2 (D2 in FIG. 16) is therefore referenced, column b is found to be present in DB_A1 DB_A1 is therefore accessed and record 71 read. Database definition set V2 is then used to convert physical structure and logical structure. In this case, column b is present in the child database, but the record passed to the request originator concatenates columns a, b, c, d, e and f. Next, it is ascertained which version of the database definition set the request originator uses. First, the recitation addresses the use of V1. The logical structure conversion table X6 of FIG. 16 is used to convert logical structure from V2 to V1. The columns are defined with V2 information as the sender and V1 information as the receiver. Here, the record read from DB_A is already in the receiving format. It may be seen that in this case there is in fact no need to access DB_A1. In order to mitigate superfluous access, it is advantageous to determine from the ascertained version of the request originator whether the child database need be accessed.

Next, if the source of the request uses V2, DB_A and DB_A1 are accessed on the basis of the database definition set V2 information, and physical structure and logical structure converted. In this case, column b is defined to the second location in the record, and column c and subsequent columns shifted towards the end of the record. Because the version with which the record was created and the version of the request originator are the same, no logical structure conversion with the logical structure conversion table is required. While this recitation has described a read operation, record updating, deletion and insertion may be performed with the methods of FIGS. 47 through 49.

A target record may be retrieved in access by alternate key by performing a binary search on the alternate-key location table with the target alternate-key value, searching for the alternate-key entry having the target alternate-key value in the alternate-key blocks and alternate-key overflow blocks and performing a primary-key binary search on the location table with the primary key of that alternate-key entry. The target record is processed as set forth above. Multiple records may exist that have identical alternate-key values, in which case the foregoing operations are repeated.

Utilization of Overflow Block Management Table

Storage and access employing an overflow block management table being likewise to the methods set forth for retroactive insertion with a child database, a detailed description is here omitted.

Direct Non-Retroactive Column Insertion

Next, the recitation addresses direct non-retroactive column insertion. This approach resembles that of direct retroactive insertion, but a column inserted will not hold a value in records created prior to modification of the database definition set. In other words, records created in the past are retained in the format of the time of their creation, and newly created records commingle in formats with columns inserted and formats prior to column insertion. Records inserted after a new database definition set has been created may be only of the new format in this approach as well, but since this includes cases in which formats are commingled, the recitation here discusses commingled formats.

Records in a new format only are inserted in the following two circumstances. One is where records inserted from an application program using an old version are converted to the logical structure of the most recent version using a logical structure conversion table. In this case, because the column inserted does not have a value, the application program using the old version defines a null value to the inserted column, defines it as a column having no data or defines the default value to the column. The other is suspending the operation of application programs using old versions of database definition sets.

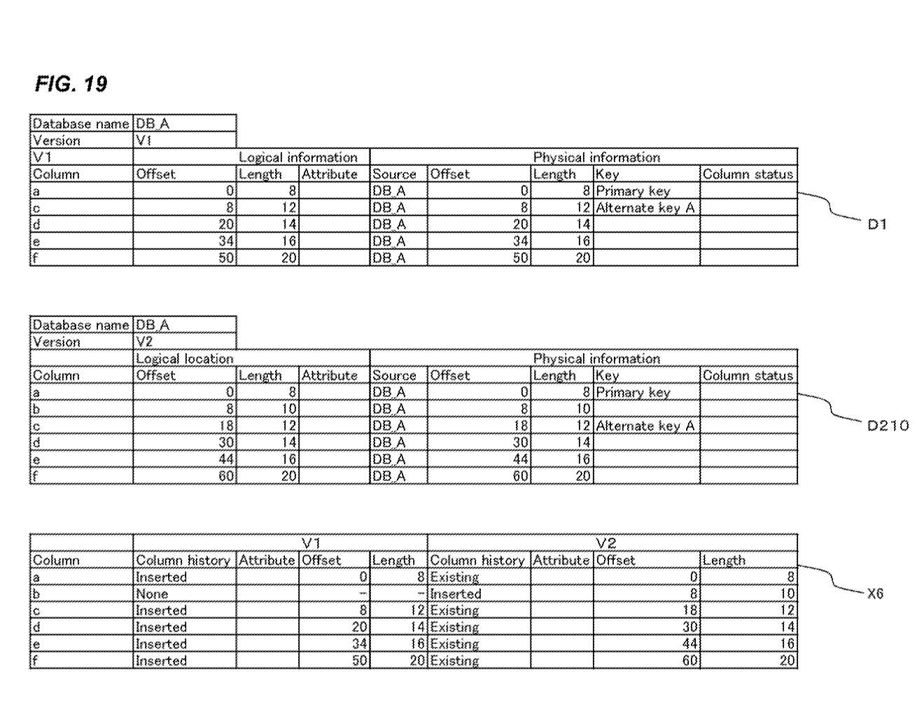

The recitation makes reference to FIGS. 13, 19 and 20. Also employed in recitation of non-retroactive insertion with a child database, FIG. 13 depicts a state immediately prior to insertion of a column. The version of the database definition set corresponding to this state is V1. Here seven records, record 0 through record 6, have already been created. It is decided at this point to insert a column b by means of retroactive operations, and an instruction is given to the database system. The database system creates the compliant database definition set V2 (D210 in FIG. 19) and logical structure conversion table (X6 in FIG. 19). Direct non-retroactive column insertion is thus completed. The reason is that no modification is performed on historical data.

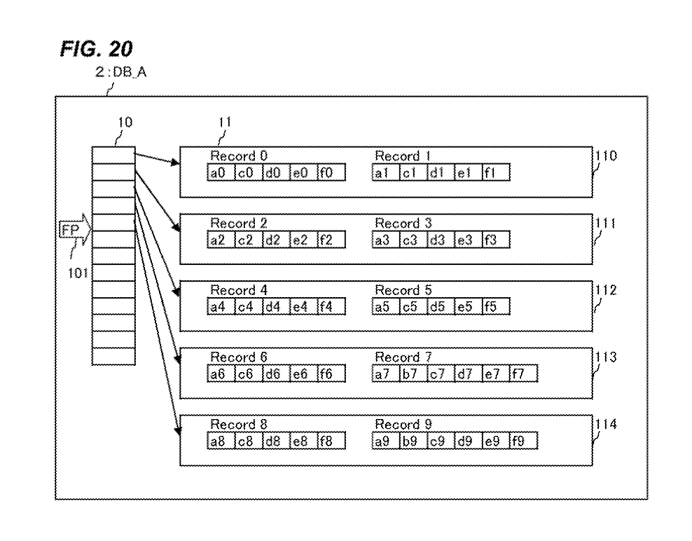

The methods by which records are inserted after the creation of database definition set V2 (D210 in FIG. 19) has completed are described with reference to FIGS. 19 and 20. FIG. 20 depicts a state, subsequent to the state of FIG. 13, in which the three records record 7, record 8 and record 9 have been inserted. The recitation first addresses record insertion by an application program (request originator) using database definition set V2 (D210 in FIG. 19). FIG. 49 is informative. An application program creates a record made up of columns a, b, c, d, e and f, and passes it to the database system. The database system performs request-receipt processing. The record is allocated to database definition set V2, and logical structure and physical structure converted. The record is then stored after, if necessary, retrieving the storage location of the record and moving records within the block. Alternate-key entries are then inserted.

Next, if the application program uses database definition set V1, the logical structure and physical structure of the record passed from the application program are likewise converted using database definition set V1 and the record stored.

Thus, where multiple record formats exist, the format of a record may be definitively ascertained by storing the version of the database definition set with which the record was created in that record or in the block, as recited for non-retroactive column insertion with a child database.

Access with Direct Non-Retroactive Column Insertion

The recitation next addresses the reading and updating of records in this state. The recitation first describes retrieval by a requesting source using database definition set V1. FIG. 46 is informative. First, request-receipt processing is performed. A binary search is then performed on the location table, and the target record found. The record is allocated to an individual version of the database definition set on the basis of the version of the database definition set with which it was created. Conversion of the physical structure and logical structure is performed with the individual database definition set. The logical structure conversion table is then used to convert the converted record to the version of the database definition set of the request originator.

If the record accessed had been created with database definition set V1 and the request originator uses database definition set V1, there need be no conversion with the logical structure conversion table. If the request originator uses V2, the logical structure conversion table is used to convert it from V1 to V2. Because column b does not exist in the V1 record, it should in this case be defined as a null value, defined as a column lacking data or defined as the default value.

Next, if the record accessed had been created with database definition set V2 and the request originator uses database definition set V2, there need be no conversion with the logical structure conversion table. If the request originator uses V1, the logical structure conversion table is used to convert from V2 to V1. If so, column b is deleted because column b is not present in V1 records. In fact, column c and subsequent columns are defined immediately after column a.

The recitation here has again described retrieval, but the methods depicted in FIGS. 47 through 49 may, as with other approaches, be employed to perform record updating, insertion and deletion. Access by alternate key consists of, likewise to recitation elsewhere, first effecting access by alternate key and performing retrieval by primary key with that alternate-key entry.

Utilization of Overflow Block Management Tables

Storage and access employing an overflow block management table being likewise to the methods set forth for direct retroactive insertion, a detailed description is here omitted.

Reorganization: Consolidating Two Databases into One After Column Insertion with a Child Database

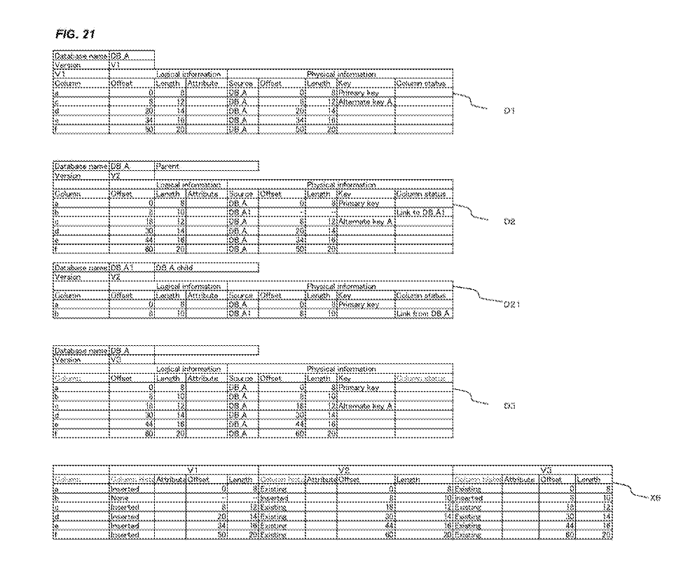

Next, a child database created with the method of retroactive column insertion with a child database or the method of non-retroactive column insertion with a child database may be consolidated with its parent database through application of the techniques of the “Database reorganization system”. The recitation describes the methods with the example of retroactive insertion. FIG. 7 depicts a database immediately prior to reorganization. This database was created by means of retroactive insertion with a child database. In addition to FIG. 7, the recitation makes reference to FIGS. 21, 23 and 24. Here the child database will be consolidated into the parent database, but the parent database may conversely be consolidated into the child database.

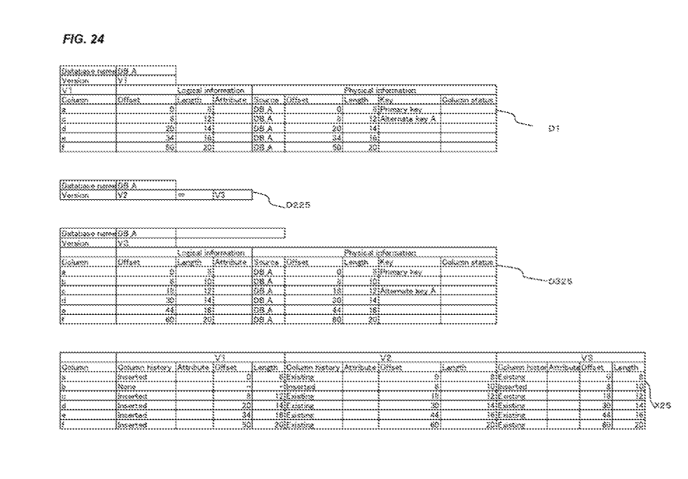

First, the database system is issued an instruction to initiate reorganization or to consolidate the two databases into one. This instruction may be automatically determined by a program built into the database reorganization system, or it may be activated by a system administrator. This instruction first of all executes preparatory operations to perform reorganization. Since reorganization in this case will result in consolidating two databases into one, a new database definition set must be created. FIG. 21 depicts the database definition set immediately prior to reorganization as V2 (D2 and D21) and the database definition set during reorganization, or after reorganization, as V3 (D3). Database definition set V2 is comprised of the two databases DB_A (2) and DB_A1 (3) and has represented these two as though they were a single database. In V3, on the other hand, DB_A will be the sole database and will include column b in its records. A database definition set will be further created after the completion of reorganization. This is shown in FIG. 24. FIG. 24 also depicts a logical structure conversion table X25.

Reorganization is performed by the following methods. First, a new location table 9 is provided to a current location table 10 of DB_A (2). A new location table is not required for the current location table of DB_A1. A reorganization pointer (102) is provided to the current location table 10, and a reorganization pointer (92) to the new location table 9. A final pointer may serve as proxy for the reorganization pointer of the new location table. This much consists of preparatory operations. Here, the new location table 9 is provided to the current location table 10 of DB_A (2), but the approach may also be adopted of providing a new location table to the current location table 15 of DB_A1 (3) and not providing a new location table to the current location table 10 of DB_A. This would consolidate the parent database into the child database. The database to which the new location table is allocated absorbs the other database. Access to the database is performed using the location table of DB_A1.

Next, the first entry and the first block of the current location table 10 are placed under exclusion in DB_A. Record 0 is read, and next record 10 in DB_A1 (3) is read. Column b of record 10 is inserted in record 0, which is written to block 0 as a new record 0. At this time, the database definition set version information of record 0 is modified to V3. This applies likewise to records subsequent to this record. If necessary, record 1 is shifted rightwards in the drawing in order to store the new record 0.

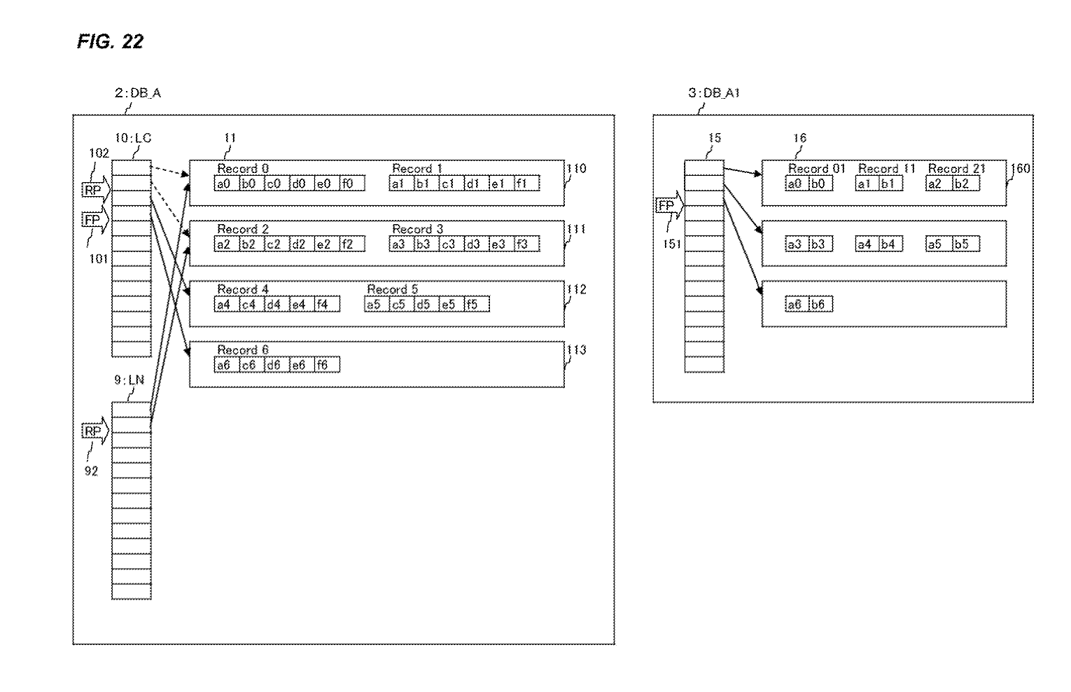

Next, record 1 and record 11 are read likewise to the foregoing, and a new record 1 created and written to block 0. Next, the address of block 0 is recorded in the new location table 9. As reorganization of block 0 is thus complete, exclusion is lifted on block 0. Next, exclusion is likewise placed on record 2, record 3 and block 1, column b of DB_A1 inserted into the records of DB_A, and the new records stored in block 1. The address of block 1 is recorded in the new location table. Exclusion is lifted on block 1. FIG. 22 depicts the state in which reorganization has completed through block 1.

This example is one of empty space in block 0 where a new record may be stored even with column b inserted; if the record could not be stored in block 0 due to the insertion of column b, a new block would be inserted, which would be a new block 1. This is a method recited in “Database reorganization system”. Where only one block is inserted, the storage rate of the inserted block may fall below the suitable initial storage rate, and so reorganization should, as is set forth in “Database reorganization system”, be performed on multiple blocks at once. In order to simplify, this discussion does not address multiple blocks subjected to reorganization and limits itself to addressing a single block. Reorganization is described in detail in “Database reorganization system”. This method is also set forth in discussion of direct retroactive column insertion. Because records grow in length with the consolidation of records, when records are sequentially rewritten from the beginning of the blocks of DB_A, the location of subsequent records must be shifted on each such occasion, and this overhead may also be minimized by means of performing updates in units of a block as set forth with respect to direct retroactive column insertion.

Reorganization pointer 102 of the current location table is pointing at the third entry in the current location table and the third entry in the new location table 9. No reorganization pointer is provided to DB_A1 because it is not directly subjected to reorganization due to its consolidation into DB_A.

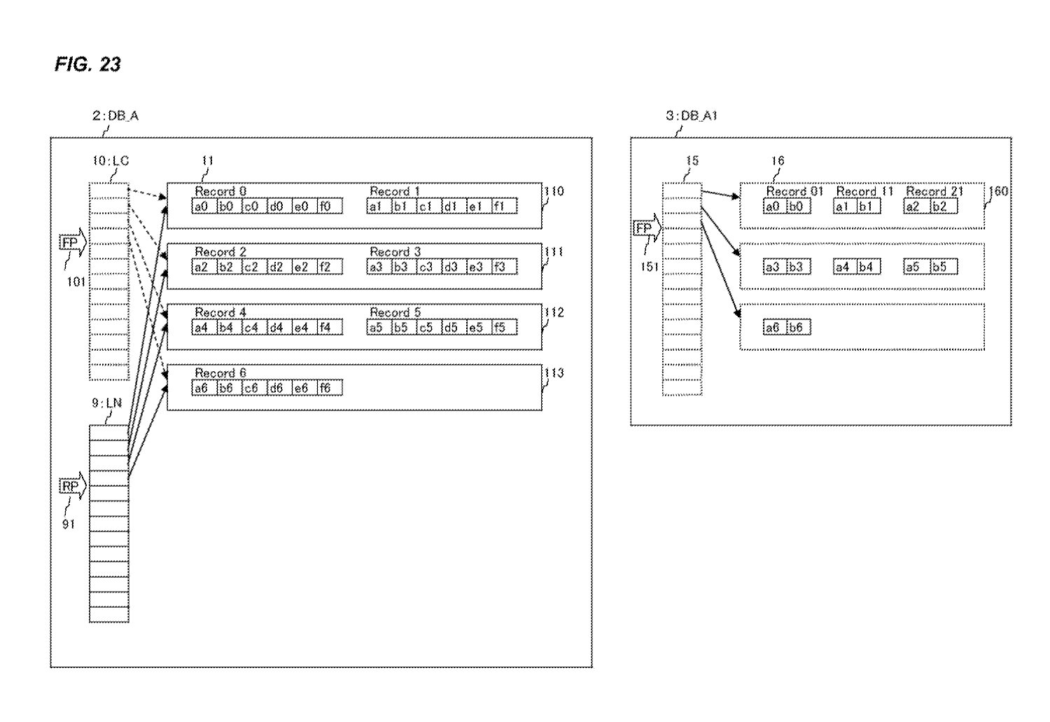

FIG. 23 depicts the state in which the foregoing reorganization has executed through the final record and reorganization has completed. The current location table 10 is here shown with dotted lines, but the current location table is in fact not needed and should be deleted. In fact, the new location table 9 becomes the current location table. FIG. 24 depicts database definition sets V1, (D1), V2 (D225) and V3 (D325) in a state in which reorganization has completed. DB_A1 is no longer needed due to its consolidation in reorganization. Database definition set V2 (D25) is in equivalence with V3; because V3 was modified to match the logical format of V2, it is depicted as the same as V3. Of course, a database definition set identical to that of database definition set V3 may also be created.

The foregoing recitation describes reorganization performed on one block at a time, but a realistic implementation would perform reorganization on multiple blocks at once. Overflow blocks would also be present, and these would also be subject to reorganization. In such cases, overflow blocks are made into primary blocks and their addresses recorded in the location table. The details of this approach employ methods set forth in “Database reorganization system”. The description of this embodiment is of an example of insertion of a column part-way into existing records, but the insertion of a column at the end of records and the simultaneous consolidation of two or more child databases may be performed in entirely like fashion.

Omitted in the foregoing recitation, alternate keys are handled as follows. The block address and block number stored in a record pointed to by an alternate-key entry may be modified in reorganization. Therefore, where block numbers and block addresses are maintained in alternate-key entries, alternate-key tables must be rewritten simultaneously and in parallel, as set forth in “Database reorganization system”. On the other hand, where block numbers and block addresses are not maintained in alternate-key entries, no modification of alternate-key entries occurs and no operations need be performed on alternate-key tables.

Database Access During Reorganization

Database access during reorganization may be performed likewise to during column insertion. Whether the current location 10 or the new location table 9 of DB_A is used depends on whether the primary key value of the target record is greater than or less than the primary key value of the location table entry pointed to by the reorganization pointer. This is a method set forth in “Database reorganization system”. If the primary key value of the target record is greater than the primary key value of the location table entry pointed to by the reorganization pointer, the current location table is used, and if it is less than that, the new location table 9 is used.

If the new location table 9 of DB_A is used, a binary search is performed on the location table entries between the first address in the new location table 9 and the location table entry pointed to by the reorganization pointer 92, and the blocks searched and the record found. Because reorganization has completed on records in blocks managed by the new location table, the records have been consolidated and column b has been inserted in them. In other words, the records have been created with database definition set V3. Therefore, the database definition set used is that of FIG. 24 for subsequent to completion of reorganization. Physical structure and logical structure are converted with the V3 database definition set. Next, it is ascertained which version of the database definition set the request originator uses, and logical structure is converted with the logical structure conversion table X25. If the database definition set versions of the record and the request originator are the same, conversion with the logical structure conversion table is not necessary.

Likewise to the foregoing, if the current location table 10 of DB_A is used, a binary search is performed on the location table entries between the location table entry pointed to by the reorganization pointer 102 and the location table entry pointed to by the final pointer 101, and the blocks searched and the record found. If the current location table 10 is used, the record has not yet been consolidated and has been created with database definition set V2. As it is V2, the child record is read from the child database as well. The database definition set used is that given in FIG. 21 for during reorganization (D2 and D21 in FIG. 21). The V2 database definition set is used to convert physical structure and logical structure. Next, it is ascertained which version of the database definition set the request originator uses, and the logical structure conversion table is used to convert logical structure. When the request originator uses V2, there is no need to convert logical structure.

Access from an alternate key may be performed by means of retrieval by primary key from the location table or the new location table after accessing the alternate-key table, and thus retrieving the target record. Although the foregoing recitation describes retrieval, updates of records may be performed by updating a record found by retrieval, likewise to other foregoing recitation, and deletions likewise performed by deleting a record found by retrieval. If the insertion of a record were performed by an application program using V1, a record lacking column b would be written by the application program, which should therefore either not be allowed to run or should create an actual database containing the column defined as the default value or as a null value, or defining the column as having no data. Updating, deletion and insertion of records are as recited with reference to FIGS. 47 through 49.

Access Subsequent to Completion of Reorganization

A state in which reorganization has completed is depicted in FIG. 23. Here, the current location table 10 is shown with dotted lines, which indicates that it is no longer needed, since reorganization has completed. Although the new location table 9 is actually functioning as the current location table, here it is discussed in terms of “new location table 9”. Database definition sets and a logical structure conversion table are also depicted in FIG. 24. This is as recited for access during reorganization. Access subsequent to the completion of reorganization is identical to access to the new location table recited for access during reorganization. Slight differences are that, since reorganization has completed, no decision is taken on whether to use the current location table with the reorganization pointer or to use the new location table, and that binary searches are performed on the location table entries between the beginning of the new location table and the location pointed to by the final pointer.

Access from an alternate key may be performed by means of retrieval by primary key from the location table or the new location table after accessing the alternate-key table, and thus retrieving the target record.

The foregoing recitation addresses the consolidation of two databases into one, and the consolidation of three or more databases may be achieved by means of the methods set forth above. Given two child databases, for example, the three databases may first be consolidated into two databases and then consolidated into one database or the three databases may simultaneously be consolidated into one database.

Additionally, depending on circumstances, DB_A and DB_A1 may be reorganized individually without consolidating them during reorganization. This being simply an application of “Database reorganization system,” detailed description is here omitted, and access during reorganization may be performed as taught in “Database reorganization system”.

Utilization of Overflow-Block Maintenance Table

Reorganization where an overflow block maintenance table is employed may be performed by applying the reorganization methods set forth in “Database reorganization system”, As record insertion and access during reorganization that is performed on pre-reorganization records may be performed by using the methods set forth for child databases, and that performed on post-reorganization records may be performed by using the methods set forth for direct column insertion, detailed description thereof is here omitted. Database access during reorganization may be achieved with either approach.

The foregoing recitation discusses reorganization with child databases. This application of reorganization enables the utilization of such child databases. The fields in a record are not generally referenced or updated at comparable frequencies, but each at different frequencies. In such cases, fields with a high frequency of referencing and updating are collected into a parent database and fields with a low frequency of referencing and updating collected into a child database. Whether a given frequency is high or low is a relative question and should be defined discretionally as some given value.

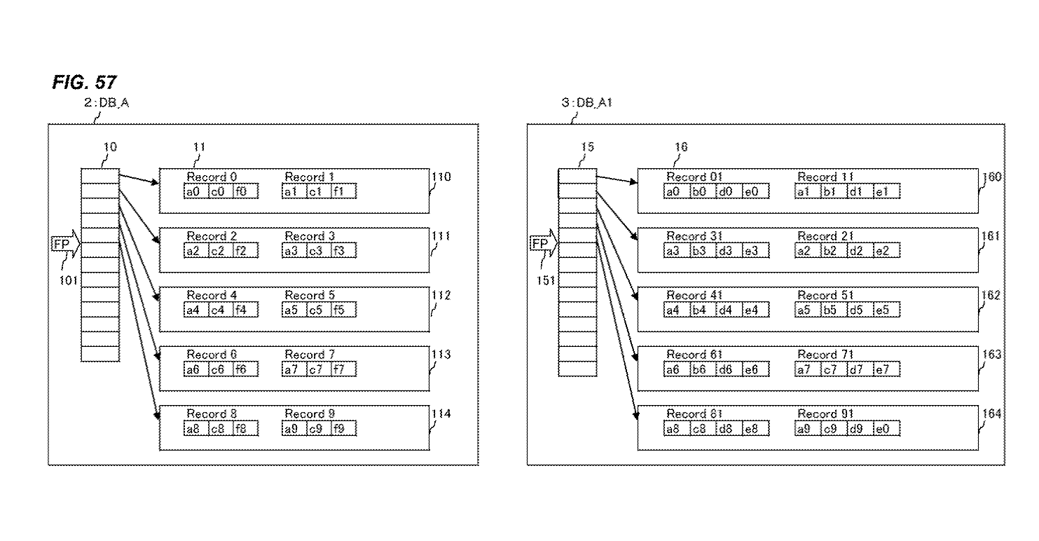

Thus, a parent database and a child database are created, and the parent database stored on a high-speed device and the child database on a low-speed device. However, the location table of the child database should be stored on a high-speed device. Generally speaking, high-speed devices are high-priced and low-speed devices low-priced. The ability thus to perform storage selectively makes it possible to construct a database employing low-cost devices without sacrificing a great deal of speed relative to storage of the whole in high-speed devices at high cost. FIG. 57 illustrates such a database. In this drawing, DB_A is the parent database and DB_A1 the child database.

Even where a child database is thus created, the frequency with which individual fields are referenced and updated may change with the addition of application systems or changes in the usage environment. When such occurs, the reorganization framework recited above may be used to swap fields between the databases. In FIG. 57, for example, fields (columns) with high frequencies of referencing and updating may consistently be maintained in the parent database by, if the frequency of referencing and updating field c decreases, deleting column c from DB_A and inserting column c into DB_A1. Likewise, if the referencing and updating of field (column) d in the child database increases, column d would be deleted from DB_A1 and column d inserted into DB_A. It goes without saying that such insertion and deletion of columns may be automated in the functionality of these databases.

Application to a generic package system is an example of the advantageous utilization of the child database in the database proper. Where a generic package system is used, portions that are simply problematic in terms of implementation are customized. When a database is inserted according to conventional methods in such cases, version upgrades to a package system prove to be difficult to apply in practice. This is because consistency is lost when a database field is inserted in a package system. However, the use of a generic package system for the parent database and the use of the customized portion for the child database in an environment in which the two are not consolidated allows the use of these databases such that the customized portion is unaffected even if the package system modifies the structure of the database.

Size of New Location Table

A new location table in “Database reorganization system” has a size capable of storing location table entries that are larger than the number of primary blocks after reorganization. However, this approach requires that, for purposes of reorganization, space always be available for a new location table of much the same size as the current location table.

This problem may be resolved by acquiring a location table that is physically disaggregated and employing an address conversion table or like means to treat it as a contiguous region. Application of this method permits a reduction in the size of the region required for a new location table in the following way. First, a new location table is created with a capacity of from one in several parts to one in several tens of parts of that required. As reorganization is performed, the anterior portions of the current location table become unneeded. When the new location table is full, therefore, reorganization is momentarily suspended, an anterior portion of the current location table released and reacquired as part of the new location table, and reorganization then restarted. By repeating this procedure several times to several tens of times, the region allocated to the new location table may be temporarily reduced.

The method set forth above of disaggregating a new location table in small regions and using regions emptied in the current location table in the new location table may be applied to “Database reorganization system” as well as to the direct insertion and the reorganization consolidating a child database into a parent database of the present invention.

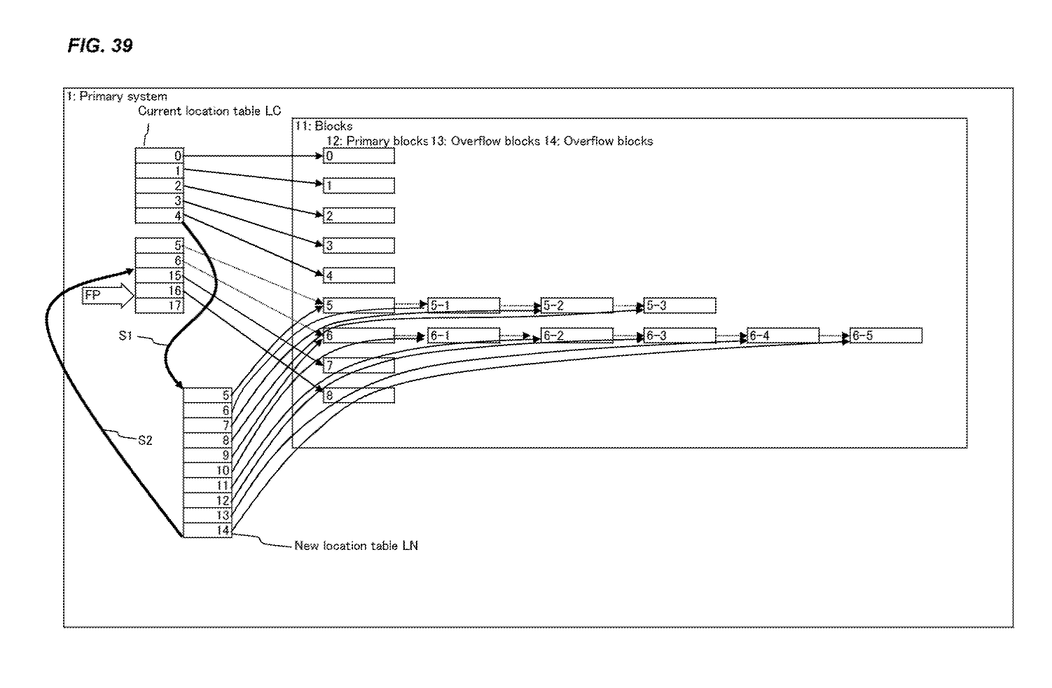

Application of the method set forth above of disaggregating a new location table in small regions and using in the new location table regions emptied in the current location table enables measures such as the following. The recitation makes reference to FIG. 39. FIG. 39 depicts a current location table LC and a new location table LN. In a database such as that of this drawing, overflow blocks may be generated with localized record insertion. In FIG. 39 overflow blocks are concentrated in primary blocks 5 and 6. In such a case, reorganization is performed only on the sections in which overflow blocks are concentrated, without performing reorganization on other sections. FIG. 39 depicts the point at which reorganization has completed, no reorganization performed on primary blocks 0, 1, 2, 3 and 4, reorganization performed on primary blocks 5 and 6, and no reorganization performed on primary blocks 7 and 8.

As reorganization is not performed on primary blocks 0 through 4, the current location table becomes the new location table as is. Next, reorganization (here, primarily the elimination of overflow blocks) is performed on primary block 5. The first entry in the new location table is 5, pointing to primary block 5. The second entry in the new location table is 6, pointing to overflow block 5-1. That they are managed by the new location table means that overflow blocks have become primary blocks. Reorganization is thus performed through overflow block 5-3, and reorganization is further performed from primary block 6 through overflow block 6-5. The new location table is used for 14 entries. Former entry 7 in the current location table is then appended as new entry 15 without performing reorganization on primary blocks 7 and 8. Former entry 8 in the current location table is likewise appended as new entry 16. Reorganization is thus completed. That S1 is physically connected to entry 4 in the current location table (i.e. the new location table) indicates that it is entry 5 in the new location table.

Although the term “new location table” is used in FIG. 39 for purposes of descriptive clarity, reorganization has in fact completed and so it is now part of the current location table. It is thus possible to perform reorganization on a part of a database at high speed.

Deletion of Columns

The recitation next addresses the deletion of columns. There are also three methods of deleting a column. The methods are backward retentive or backward non-retentive. Backward retention may be further divided into definitional deletion and the use of a child database. The only backward non-retentive method is direct deletion. Backward-retentive definitional deletion is a method of deleting a column only from a database definition without deleting the column from the actual database. An advantage of this approach is that the time required for deletion is instantaneous, but since the column is not actually deleted, it has the disadvantages that the database region remains large and that processing times are extended by the length of the record when reading a record and by deletion of the column for transfer to requesting sources. Columns deleted with this method may be actually deleted in reorganization.

Backward non-retentive column deletion resembles retroactive column insertion and consists of deleting a column from existing records retroactively. Access in this method is performed in the same fashion as recited for FIGS. 50 through 53. Only the most recent database definition set is maintained. Conversely, backward-retentive column deletion resembles non-retroactive column insertion. Existing records remain in the conditions in which they were created. Access in this method is performed in the same fashion as recited for FIGS. 46 through 49. Individual versions of the database definition set are maintained.

Use of a child database consists of creating a new child database for column deletion, storing in the parent database records with the column deleted from the original records, and creating child records from pairs of the column deleted and the primary key and storing these in the child database.

Direct column deletion consists of directly deleting records from the records stored in blocks and storing records lacking the deleted column as new records.

After a column has been deleted by means of definitional deletion from a database employing backward-retentive definitional deletion, the actual column may be deleted by applying the framework of reorganization. One method of deleting actual columns in reorganization is to write back as a new database only records from which the column is deleted, and another method is to create a new child database with records combining deleted columns and a primary key. Where the method of writing back as a new database only records from which a column is deleted is employed, less time will be required for reorganization, but programs may sometimes terminate abnormally because it is no longer possible to return the value of a deleted column in response to requests from a program using a database definition set from prior to deletion of the column. This applies likewise to direct column deletion. Therefore, discretion must be exercised in the use of these methods. Where the method of creating a new, separate database with a deleted column is employed, more time will be required for reorganization and a region for creation of the new database will be required. On the other hand, requests from a program using a database definition set from prior to deletion of a column may be processed without difficulty, and requests from a program using the new version of the database definition set will be quicker than prior to reorganization.

Backward-Retentive Definitional Column Deletion

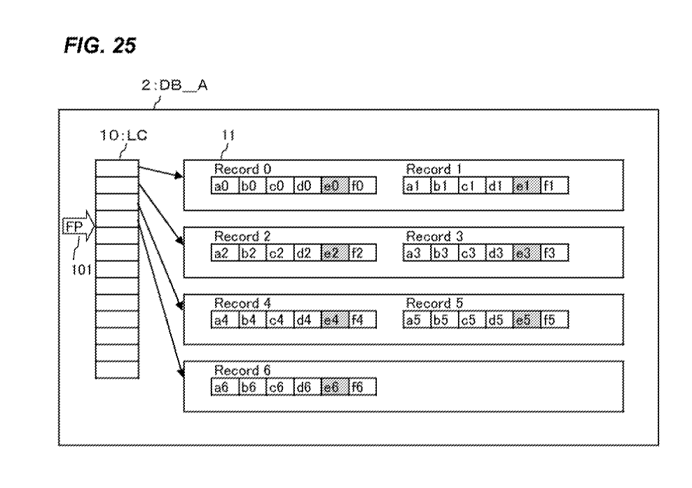

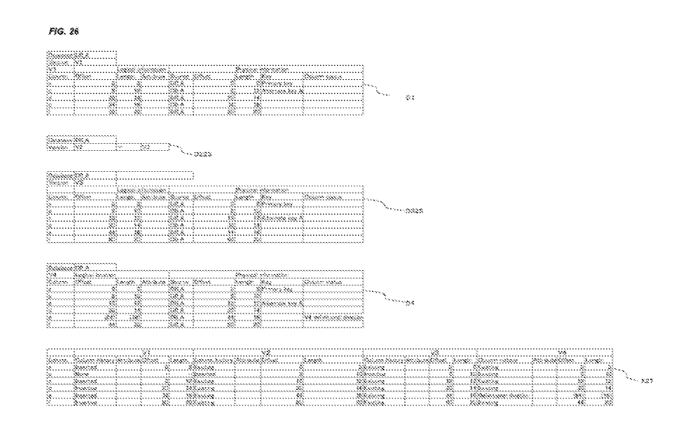

FIG. 25 illustrates deletion of a column e by means of backward-retentive definitional deletion. Column e is shown shaded in FIG. 25, the significance of which is specified in detail below. The database definition set and a logical structure conversion table X27 are depicted in FIG. 26. Let V3 be the database definition set immediately prior to the deletion of column e, and let V4 be the database definition set after the deletion of column e. Database definition sets V1, V2 and V3 are the same as those given in FIG. 24. FIGS. 46 through 49 are also informative.

First, an instruction is given to the database to delete column e by means of definitional deletion. The database system performs preparatory operations on this basis. In this case, a V4 database definition set (D4) and a logical structure conversion table X27 are created. Because there is no modification of the database definition sets V1 (D1), V2 (D225) and V3 (D235), they are used as is. In database definition set V4, column e is deleted from records made up of six columns from column a through column f. However, because the actual database will continue to maintain column e, the status given in the column-status column of column e in V4 is “Definitional deletion”. The offsets of the logical location of column e in database definition set V4 (X27) and of the V4 logical location of column e in the logical structure conversion table are 64, and their lengths are 16. The purpose of this expression is to permit the distinction to be made that although column e has not actually been deleted, it has been definitionally deleted, and further to enable column e values to be passed when records created with database definition set V4 are converted to the logical structures of other versions. Column e is not maintained in V4 records themselves. It is required as a virtual column for conversion to other versions. Preparatory operations are thus complete. The shading of column e in FIG. 25 indicates that it is subject to definitional deletion. Because no modification need be made to the actual database, the foregoing completes operations entailed in deletion.

Definitional Deletion and Database Access

Because column deletion by means of definitional deletion thus completes instantaneously, access during deletion does not present such problems as are encountered with column insertion. The recitation addresses access after column deletion. Which version of the database definition set a post-deletion request originator uses is identified. Request-receipt processing and index searching through to record detection are performed likewise to elsewhere. The version of the record read is ascertained. The database definition set 35 of that version is used to convert physical structure and logical structure. The logical structure conversion table is used to perform conversion of logical structure on the database definition set version of the request originator, and the record created is passed to the request originator. Likewise to other implementations, these methods may be used to update, insert and delete records. Access by alternate key is also performed likewise to other implementations.

The recitation here provides a more detailed description of logical structure conversion from database definition set V4 to other versions. When database definition set V4 is used to convert physical structure and logical structure, records are created in which column e does not exist because column e has been deleted in V4, and column e values will be lacking even if those records are converted to another version. One way of avoiding this circumstance is illustrated by database definition set V4 (D4) and logical structure conversion table X27 in FIG. 26. Column e in database definition set V4 is represented as having an offset of “(64)” and a length of “(16)”. The parentheses are not included in proper logical records, but are used to identify the column as one required for logic conversion. The same notation is employed for column e in V4 of the logical structure conversion table. Column e values are stored in 16 bytes from an offset of byte 64 in V4 logical records. In other words, this means that when V4 logical structure is converted to that of another version, the column e value will be defined and that value passed to the other version. This may be effected because a backward-retentive means of deletion is used.

Application to Implementations Employing an Overflow-Block Management Table

Because the physical structure of the database is not modified, storage and access where an overflow-block management table is employed may be performed in the same fashion as prior to definitional deletion.

Backward-Retentive Column Deletion with a Child Database

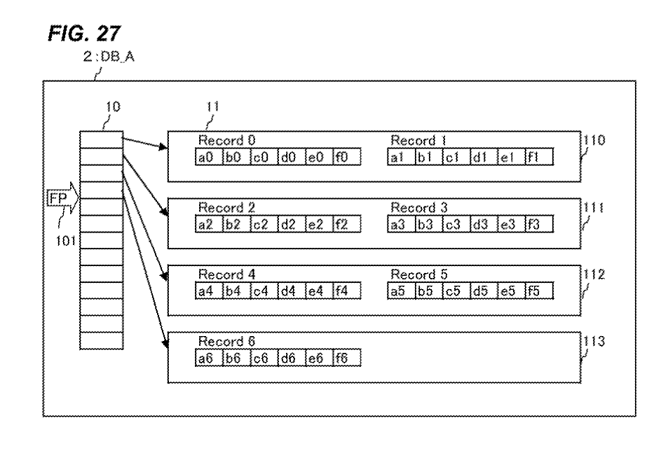

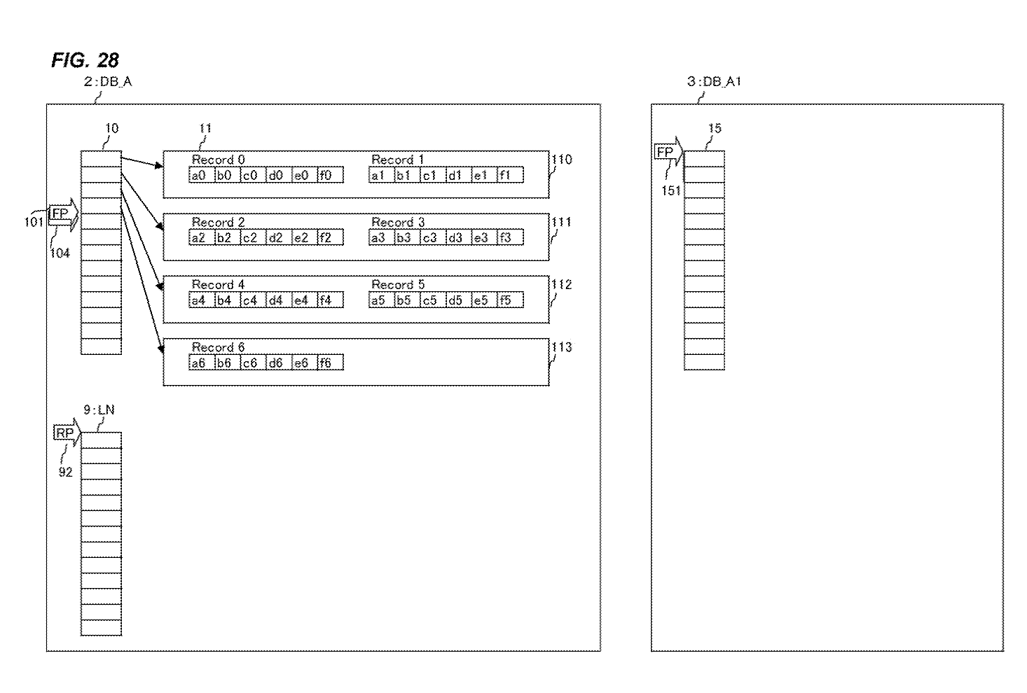

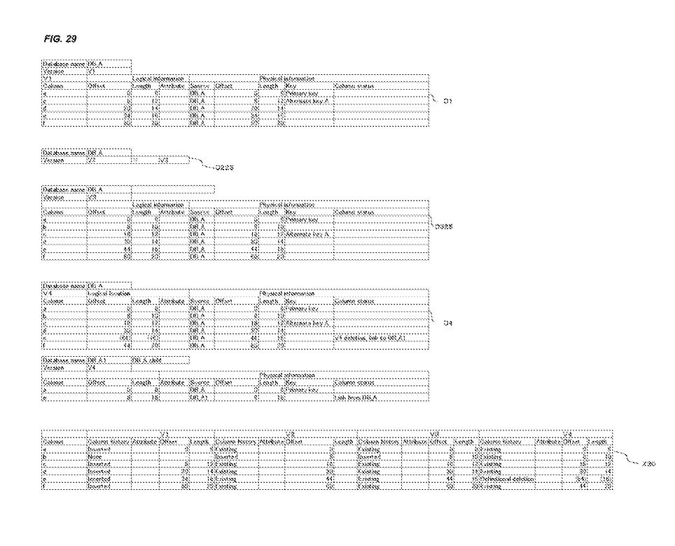

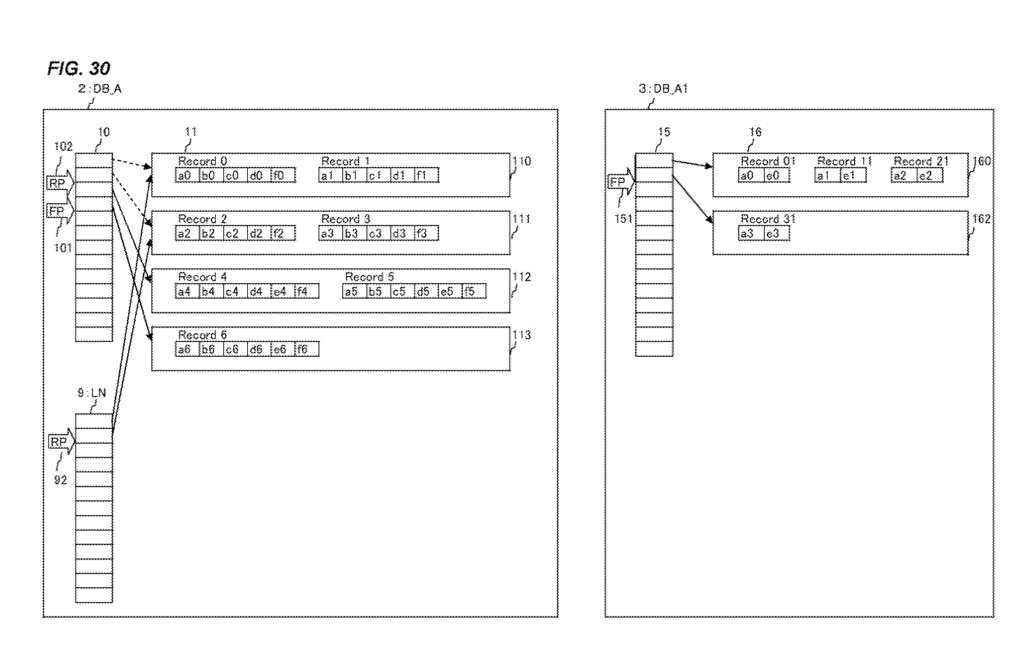

The recitation discusses backward-retentive column deletion with a child database with reference to FIGS. 27, 29, 30, 31 and 32. FIG. 27 illustrates a database about to undergo column deletion. Seven records, record 0 through record 6, are stored here. Each record is made up of columns a, b, c, d, e and f. Column e will be deleted from these records. An instruction is given to the database system to perform the column deletion by means of backward-retentive deletion with a child database. On the basis of this instruction, the database system performs preparatory operations. A new location table (9 in FIG. 28) and a new location table final pointer (101 in FIG. 28) are created. A child database DB_A1 (3 in FIG. 28), a child location table (15 in FIG. 28) and a child location table final pointer (151 in FIG. 28) are further created. A column operation pointer (102 in FIG. 30) is created for the current location table and its content set to the top address in the current location table. A column operation pointer (92 in FIG. 30) is also created for the new location table and its content set to the top address in the new location table. The column operation pointer of the new location table may also serve as proxy for a final pointer. A column operation completion pointer 104 is created that points to the same entry as the entry pointed to by the final pointer 101 of the current location table. Database definition set V4 (D430 and D4130 in FIG. 29) and a logical structure conversion table (X30 in FIG. 29) are further created. Database definition sets V1 (D1 in FIG. 29), V2 (D225 in FIG. 29) and V3 (D235 in FIG. 29) are the same as those in FIG. 24. In other words, the database of FIG. 27 is the same as the database of FIG. 23.

FIG. 30 depicts a point part-way through column deletion by means of backward-retentive deletion with a child database. The recitation describes procedures step by step from the beginning. First, entry 0 of the current location table (10 in FIG. 30), block 0 (110 in FIG. 29) and entry 0 of the new location table (9 in FIG. 30) of DB_A (2 in FIG. 30), and entry 0 of the child location table (15 in FIG. 30) and child block 0 (160 in FIG. 30), are placed under exclusion, and record 0 read. After column e is deleted from record 0, the record made up of columns a, b, c, d and f is written back to block 0 (110 in FIG. 30). Next, the primary key column a and column e are combined to form child record 0, which is stored in block 0 (160 in FIG. 30) of DB_A1 (3 in FIG. 30). The first entry in the child location table of DB_A1 is placed under exclusion, child block 0 (160 in FIG. 30) created and the record stored therein. Next, record 1 is read, and a record made up of columns a, b, c, d and f written back to block 0 (110 in FIG. 30). Next, the primary key column a and column e are combined to form child record 11, which is stored in block 0 (160 of FIG. 30) in DB_A1 (3 in FIG. 30).

As block 0 (110 in FIG. 30) of DB_A is now full, exclusion is lifted on entry 0 of the current location table 10 (10 in FIG. 30), block 0 and entry 0 of the new location table (9 in FIG. 30) of DB_A and on entry 0 of the child location table and child block 0. The column operation pointer of the current location table (10 in FIG. 30) is made to point to the beginning of current location table entry 1. The column operation pointer (91 in FIG. 30) of the new location table is made to point to the beginning of new location table entry 1. The final pointer (151 in FIG. 30) of the child location table is made to point to the beginning of child location table entry 1.

Likewise thereafter, after record 2 is read and column e deleted, a record made up of columns a, b, c, d and f is written back to block 1 (111 in FIG. 30). Next, the primary key column a and the deleted column e are combined to from record 21, which is stored in block 0 (160 in FIG. 30) of DB_A1 (3 in FIG. 30). Record 3 is processed likewise.

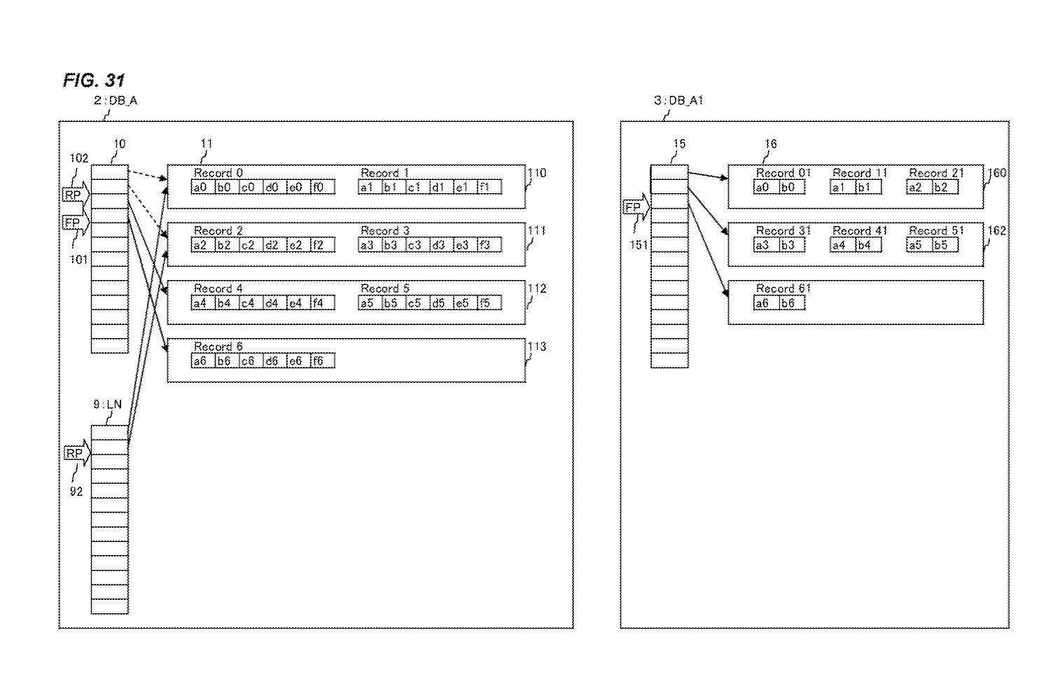

In order to simplify the recitation, the number of records stored in a block in DB_A remains unchanged in the foregoing example; where the number of records does in fact change, multiple blocks are placed under exclusion, column deletion operations are performed on the records in those blocks, and records stored in those blocks at their respective suitable initial storage rates. Any overflow blocks are made into primary blocks at this time, and if surplus blocks are left over from the imposition of suitable initial storage rates, these are defined as unused blocks. FIG. 31 depicts a state in which such column deletion has completed through record 6.

Database Access During Column Deletion

As operations performed in these circumstances are the opposite of column insertion with a child database, access may be executed without difficulty in the state illustrated in FIG. 30, which combines the retroactive column insertion with a child database of FIG. 5 and the direct retroactive column insertion of FIG. 9, even in circumstances of performing a column deletion. The schematics of FIGS. 46 through 49 are applicable. Conversion from V4 to other versions in logical structure conversion with the logical structure conversion table assigns special significance to the logical location and length of column e, as recited with respect to backward-retentive definitional deletion, and so enables logical structure conversion.

Application to Implementations Employing an Overflow-Block Management Table

Where this system is applied to a database implementation having an overflow-block management table, data storage and access are likewise to that for column insertion with a child database and so discussion is here omitted.

Backward Non-Retentive Direct Column Deletion

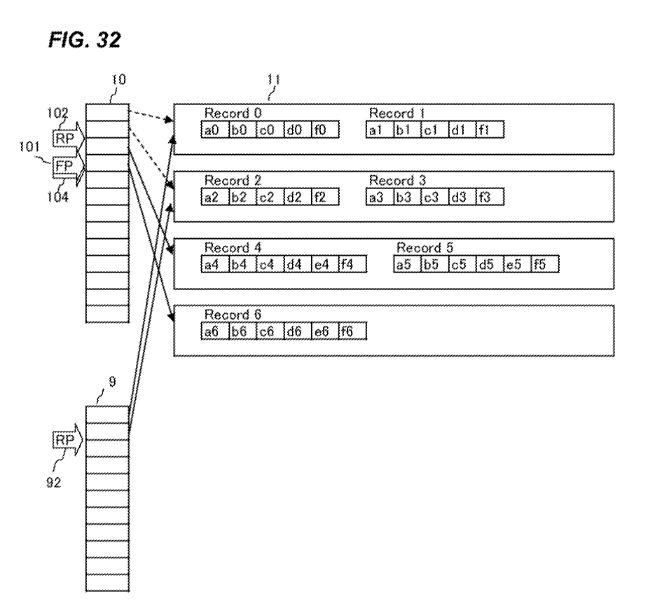

The recitation addresses backward non-retentive direct column deletion. This is a method of writing back to a block as new records only those existing records from which a column has been deleted. Many aspects of it are similar to direct column insertion. The recitation of this method makes reference to FIG. 32. First, a new location table 9 is provided to a current location table 10. Next, one column operation pointer each is provided to the current location table and the new location table. The column operation pointers initially point to the first entries in the individual location tables. A column operation completion pointer 104 is further provided that points to the same location as the location table entry pointed to by a final pointer 101 of the current location table. The value of the column operation completion pointer is not modified until completion of the column deletion.

Next, current location table entry 0, block 0 and new location table entry 0 are placed under exclusion. Next, record 0 is read, column e deleted and the record written back to block 0. Next, record 2 is processed in the same fashion. As block 0 has now reach its suitable initial storage rate, exclusion is lifted on the current location table entry 0, block 0 and new location table entry 0.

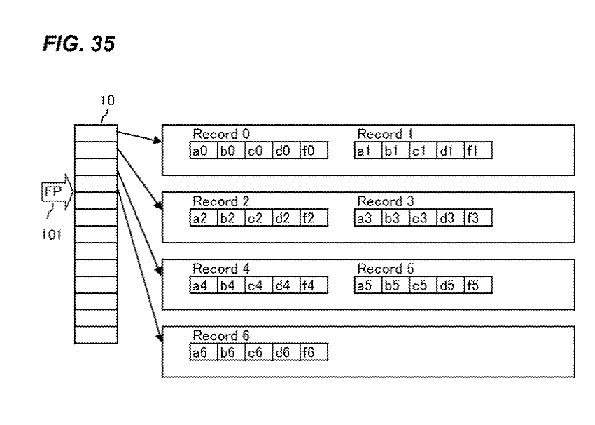

Because overflow blocks may in fact exist or the space occupied by records in blocks fall below their suitable initial storage rates, the foregoing column deletion should be performed on multiple blocks at once. The description is limited to a single block here in order to simplify the recitation, FIG. 35 depicts a state in which the deletion of column e has completed. At the point when column deletion was performed. the location table 10 had been provided as a new location table.

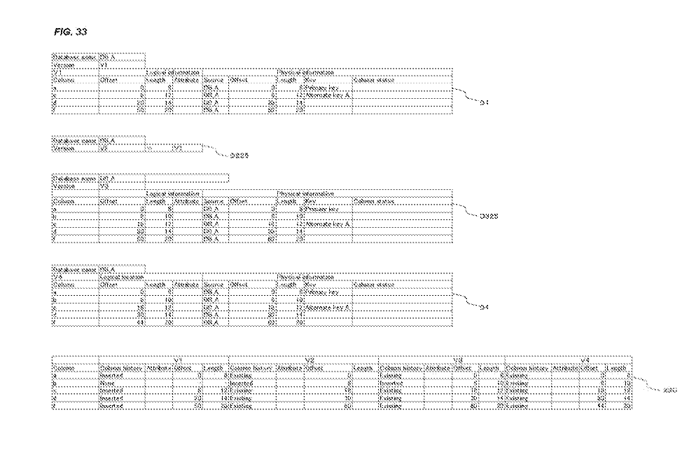

Backward non-retentive column deletion consists of deleting columns existing in records that have already been created, and only one generation of the record format is maintained. However, V1 is seen to be a format lacking column b. Simply maintaining only the most recent V4 database definition set will therefore generate inconsistencies. The following two methods are ways to avoid these inconsistencies. The first is to retain past versions of the database definition set. As this will generate inconsistencies with record formats retained as is in their past states, a new database definition set is recreated in a format excluding column e. Because record formats will differ before and after a column deletion where this method is employed, the database definition set for the old format and the database definition set for the new format are both maintained while performing a column deletion. FIG. 33 depicts such a database definition set and logical structure conversion table.

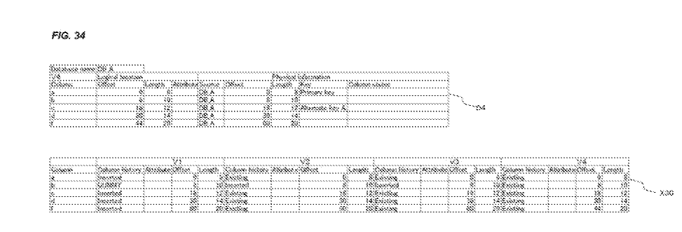

The second method is to assign a null value to column b in records created with V1 or to define those columns as lacking data, and to apply an identical record format. In this case, the only existing database definition format will be V4. FIG. 34 depicts such a database definition set and logical structure conversion table. Here, the term “Dummy” is placed in the column history of column b in V1 in the logical structure conversion table to indicate that it is not regular data.

Access to a database while column deletion is being performed is likewise to that during direct column insertion and allows retrieval, insertion, deletion and updating.

Application to Implementations Employing an Overflow-Block Management Table

Where this system is applied to a database implementation having an overflow-block management table, data storage and access are likewise to that for retroactive column insertion and so discussion is here omitted. It goes without saying that data insertion, updating and deletion may be performed at any time.

Reorganization After Definitional Deletion

Next, where column deletion is executed by means of definitional deletion, there are three methods for performing reorganization by handling column e in subsequent reorganization.

Reorganization After Definitional Deletion: Maintaining Definitionally Deleted Columns

The first method is to continue to maintain column e as is. The advantages of this approach are that it reduces the time required for reorganization and that it guarantees that programs that use column e will run. Its disadvantages, on the other hand, are that accessing records takes longer than if column e were deleted from the actual database and that the database requires a storage capacity superfluous by the size of column e.

Reorganization After Definitional Deletion: Inserting Definitionally Deleted Columns into a Child Database

The second method is to delete column e from the database, but create column e as a child database. The child database recited is the same as that recited for column insertion. The new database stores child records made up of column e and the primary key column a. The advantages of this approach are that it guarantees programs using column e will run and that access by programs using database definition set V4 will be faster. Its disadvantages, on the other hand, are that reorganization takes more time because it involves the creation of a new database and that a superfluous region is required for the region of the new database. This method is implemented by applying the methods recited for backward-retentive deletion with a child database.

Reorganization After Definitional Deletion: Actual Deletion of Definitionally Deleted Columns

The third method is to delete column e in the actual database. This method is entirely likewise to that of direct column deletion. This is the method that requires the least database region. The disadvantage, on the other hand, is that programs using column e cannot be guaranteed to run. This method is implemented by applying the methods recited for backward non-retentive direct column deletion.

Each of these methods thus has advantages and disadvantages, and the choice must be made with an appreciation of their significances. Database access during reorganization and after reorganization being performed in the same fashion as access when columns are inserted and when reorganization is performed after column insertion, a detailed description is here omitted, but access may be effected without any difficulty.

Application to Implementations Employing an Overflow-Block Management Table

None of the methodology recited above varies where this system is applied to a database employing an overflow-block management table, and so a detailed description is here omitted. It goes without saying that data may be inserted, modified and deleted while reorganization is underway.

Next, the recitation addresses the modification of columns. Modification of a column pertains to its attributes and length. These fall into three groups: modification of a column attribute and no modification of its length, no modification of a column attribute and modification of its length, and modification of both a column attribute and its length. The attribute of a column refers to the form of the data stored therein; examples of column attributes are numeric, text and date.

The recitation addresses retroactive column modification. A new location table is provided to the current location table, and the column modified is modified in existing records while performing reorganization. One column operation pointer each is provided to the current location table and the new location table, and procedures are likewise to column insertion. Like retroactive column insertion, retroactive column modification should maintain only the most recent version of the database definition set describing record format. In this case only the most recent version of the database definition set is retained. On the other hand, a logical structure conversion table is used to pass records to application programs using old database definition sets.

As no modification is performed on existing records in non-retroactive column modification, no operations need be performed on existing records. Newly created records are inserted not only as records using the most recent version of the database definition set, but also as records using existing old versions of the database definition set. Existing records are maintained in the formats of the time of their creation, and each version of the database definition set is retained. A logical structure conversion table is also used in this case.

Next, the recitation addresses the modification of column length. Modification of column length also permits a choice between retroactive and non-retroactive modification. Retroactive modification is a method in which the length of modified columns in existing records is modified to match the length in a new database definition set. In this case, modifications performed on existing records are likewise to the methods set forth for retroactive column insertion. In non-retroactive modification, no modification is performed on existing records, and the lengths of modified columns of records created using the most recent database definition set are modified.

In this case as well, records may be transferred by using a logical structure conversion table, even if record versions are different from application program versions, but because modification of column length may result in data overflow or truncation, application of this method requires confirmation that operational problems will not arise.

Application to Accelerator Systems

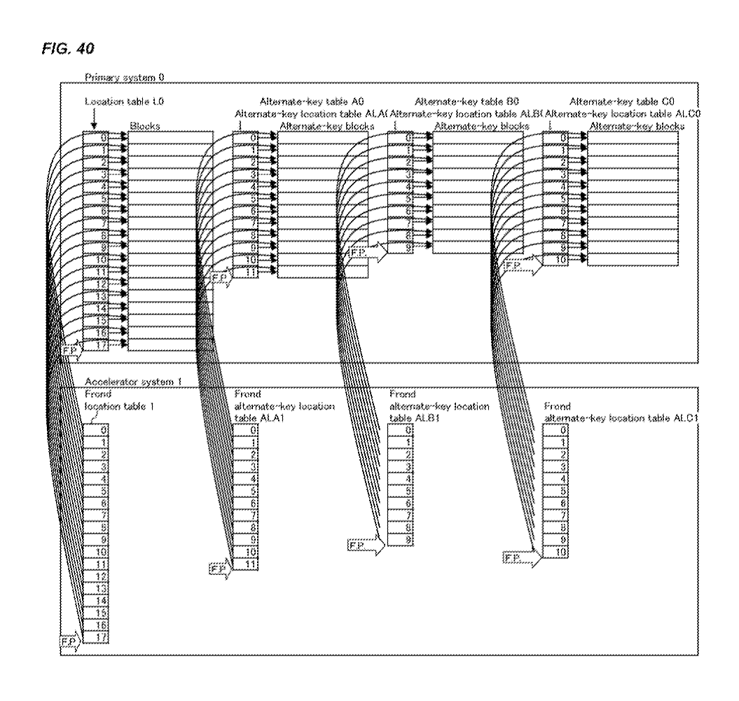

The recitation addresses accelerator systems, making reference to FIG. 40. The principles of accelerator systems are as follows. Binary searches are performed on location tables and alternate-key location tables to find target records. Performing a binary search on a location table entails searching repeatedly for two breakpoints, and the number of such iterations is generally greater than the number of iterations required for searching for a record within a block. Further, the probability is considerably low that multiple processes will simultaneously request records within the same block. Therefore, many record access requests may be executed if multiple copies of the location table and alternate-key location table are maintained and binary searches are performed in parallel on these individual copies.

FIG. 40 illustrates an instance of an accelerator system. The accelerator system maintains a location table (frond location table) and alternate-key location tables (frond alternate-key location tables), but does not maintain primary blocks, overflow blocks, alternate-key blocks or alternate-key overflow blocks. The frond location table of the accelerator system is functionally equivalent to the location table of the primary system. Likewise, the frond alternate-key location tables of the accelerator system are functionally equivalent to the alternate-key location tables of the primary system. The individual records of the front location table of the accelerator system point to the same blocks as the individual location table records of the primary system.

The accelerator system responds to a primary-key access request by performing a binary search on the frond location table, searching for the target block and requesting the primary system to retrieve the record in that block. If an alternate key, it performs a binary search on the frond alternate-key location table, finds the target block, finds the target alternate-key record from the alternate-key blocks maintained by the primary system and, on the basis of that alternate-key record, performs a binary search on the frond location table to find the target record. While this description is of retrieval, these methods may be applied to perform record updating, insertion and deletion. While the method for alternate keys specifies the performance of a binary search on the frond location table based on the alternate-key record, this will be unnecessary where block addresses and block numbers are maintained in alternate-key records. Throughput may thus be increased by performing record retrieval and updating in parallel on multiple accelerator systems.

The accelerator system of FIG. 40 maintains one location table and three alternate-key tables, the same number as the primary system. In “Accelerator” this is referred to as a symmetrical system. On the other hand, one may postulate, for example, an accelerator that maintains a location table and only two alternate-key location tables, or one may create an accelerator system that maintains only a location table or only alternate-key location tables. These are termed asymmetrical systems. Primary blocks and overflow blocks, and alternate-key blocks and alternate-key overflow blocks may be handled much the same in accelerator systems.

Application to Accelerator Systems

Next, the recitation addresses, with reference to FIG. 41, application to the synchronization of a primary system and an accelerator system in a system employing accelerator functionality. The primary system has a location table 10, an alternate-key location table ALA0, an alternate-key location table ALB0 and an alternate-key location table ALC0. It further has final pointers (101, 10A1, 10B1 and 10C1). Where the database implementation employs overflow-block management tables, it has an overflow-block management table 20, an alternate-key overflow-block management table 20A, an alternate-key overflow-block management table 20B and an alternate-key overflow-block management table 20C. Further, the overflow-block management table is provided an overflow-block management table pointer 201, the alternate-key overflow-block management table 20A an alternate-key overflow-block management table 20A1, and likewise alternate-key overflow-block management table pointers 20B1 and 20C1.

The accelerator system 3 has a frond location table 16, frond alternate-key location tables ALA1, ALB1 and ALC1, and final pointers (161, 16A1, 16B1 and 16C1). Where the database implementation employs overflow-block management tables, it is provided a frond overflow-block management table 21 and frond alternate-key overflow-block management tables 21A, 21B and 21C. Each frond alternate-key overflow-block management table 21A, 21B and 21C is provided a frond alternate-key overflow-block management table pointer 21A1, 21B1 and 21C1.

When a change occurs in the location table or an alternate-key location table on the primary system, it notifies the accelerator system of that change, and the accelerator system makes the change to the corresponding frond location table or frond alternate-key location table. When a change occurs to one of the location table 10, final pointer 101, an alternate-key location table or an alternate-key location table final pointer (10A1, 10B1 and 10C1), it notifies the accelerator system of the component changed. On the basis of that notification, the accelerator system modifies the corresponding component changed in the corresponding frond location table 16, frond alternate-key location table or frond alternate-key location table final pointer (21A1, 21B1 and 21C1).

Where the database employs overflow-block management tables, the primary system, in addition to the foregoing, notifies the accelerator system of any change made to the overflow-block management table 20, the overflow-block management table pointer 201, an alternate-key overflow-block management table (20A, 20B and 20C) or an alternate-key overflow-block management table pointer (20A1, 20B1 and 20C1), and the accelerator system modifies that component in the corresponding frond overflow-block management table 21, frond final pointer 161, frond overflow-block management table pointer 211, frond alternate-key overflow-block management table (21A, 21B and 21C) or frond alternate-key overflow-block management table pointer (21A1, 21B1 and 21C1).

Thus, the primary system notifies the accelerator system of the component changed and the accelerator system immediately applies that change to maintain the equivalence with the primary system of the frond location table 16, the frond overflow-block management table 21, the frond final pointer 161, the frond overflow-block management table pointer 211, the frond alternate-key location tables (21A, 21B and 21C), the frond alternate-key location table final pointers (21A1, 21B1 and 21C1), the frond alternate-key overflow-block management tables (21A, 21B and 21C) and the frond alternate-key overflow-block management table pointers (21A1, 21B1 and 21C1) of the accelerator system. When the accelerator system completes making the change to the corresponding location, it transmits modification-completion notification to the primary system. Until modification-completion notification has arrived from all accelerator systems, the primary system holds the affected component under exclusion.

The foregoing recitation addresses application to a basic instance of an accelerator system; where direct column insertion, direct column deletion and direct column modification are involved, the following additional conditions apply when those operations are performed. In addition to the foregoing conditions, a column operation pointer for the current location table, a column operation completion pointer, a new location table and a new column operation pointer are added to the primary system. Correspondingly, a column operation pointer for the frond current location table (frond column operation pointer), a frond column operation completion pointer, a frond new location table and a frond new column operation pointer are added to the accelerator system. Where the database employs overflow-block management tables, a new overflow-block management table and a new overflow-block management table pointer are added to the new location table. When a change is made to any of the foregoing fields on the primary system, it notifies the accelerator system of that change, and the accelerator system makes the change in the corresponding location.

Access from an accelerator system may be implemented by combining the methods taught for accelerator systems with the foregoing recitations of column insertion, deletion and modification, except that block access passes to the primary system.

The foregoing recitation assumes the accelerator system to be a symmetrical one; in application to asymmetrical systems, only those accelerator systems maintaining components in which a change occurs on the primary system are notified of those changes and perform updates.

The foregoing recitation has described the insertion, deletion and modification of columns in a database. This additional, deletion and modification of columns may be applied not only to common databases, but may also be applied to XML implementations of data management. XML consists of a collection of data enclosed by tags, and since tags may be created freely, it offers flexibility with respect to the insertion, deletion and modification of columns, but suffers from the drawback that there is no way to arrange and store such flexible data in an orderly manner.

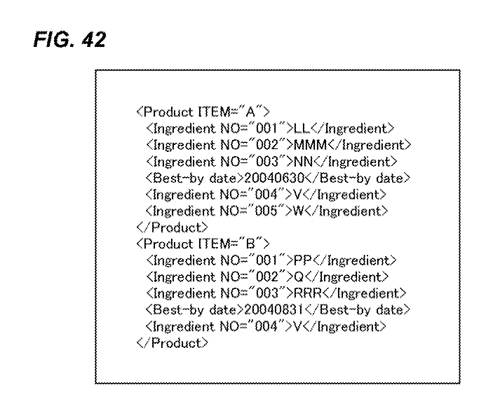

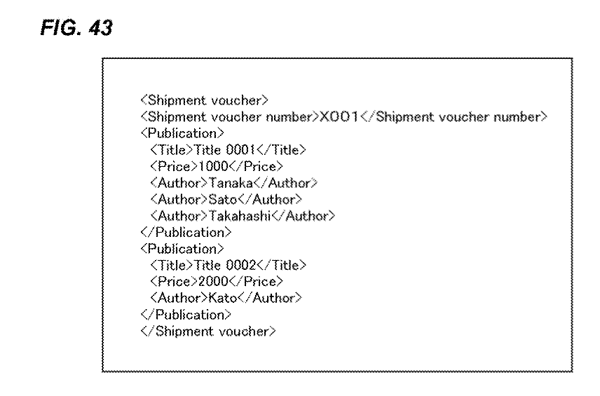

Particularly problematic are tags having identical attributes, like “ingredient” in the XML sample of FIG. 42, and the incidence of identical tags lacking attributes, like “author” in the XML sample of FIG. 43. In particular, handling multiple tags existing in the same column, as in the cases of “ingredient” in FIG. 42 and “author” in FIG. 43, becomes entangled with issues of the normalization of relational databases and has proven a hardship with conventional databases. The ingredients of FIG. 42 may be interpreted as separate fields depending on the number of NO's, and the operations involved in determining whether a particular ingredient is used have been a hardship in conventional implementations.

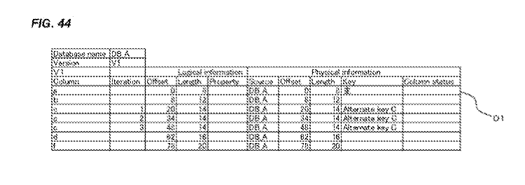

Implementation of a database system employing the methods recited in this specification would facilitate the storage of XML data. The database is constructed using the names of columns as XML tags. The database definition may be modified by inserting a column when a tag is added and deleting a column when a tag is removed. The recitation describes, with reference to FIG. 44, a method of resolving the problem of identical tags. Column c is used three times, in iterations 1, 2 and 3. This is the column corresponding to “author” in FIG. 43. Because they have the same tag, they are given a uniform column name, and the Iterations column is used to distinguish them. This example may apply where there are three authors, and where there are many authors, column insertion may be performed on column c.

Because column c1, column c2 and column c3 are separate columns, three alternate keys would be created where conventional alternate keys are in use, but here they are recorded as a single alternate key (alternate key C). The alternate keys set forth in “Information storage and retrieval system” are records stored in alternate-key tables as alternate-key entries combining an alternate-key value and a primary key value. Therefore, if their data content and attributes are the same, they may be used as identical keys, even if separate columns. Employing this method is highly advantageous when, for example, searching for which is a book by a specific author. FIG. 99 illustrates how alternate-key entries are created when the author tag of the XML of FIG. 43 is an alternate key C. These alternate-key entries are stored in the same alternate-key table (alternate key C).

Likewise, the ingredient tag of FIG. 42 may be implemented as a single key. Of course, they may be handled as individual columns attendant on the attributes of the ingredients. The product tag of FIG. 42 and the publication tag of FIG. 43 are efficaciously stored divided into records for each product and publication. Here, a suffix should be appended to the primary key and the same primary key used to indicate that the records are partitioned. Database records may be converted to XML by storing attribute information in the logical structure of columns in database definition sets.

XML may have a hierarchical structure in which data is nested as higher-order data and lower-order data; such structures may be supported by describing level numbers in the logical structure of columns in database definition sets, as with a COBOL data division.

Thus, XML may be stored in the databases taught in “Information storage and retrieval system” and “Database storage and retrieval system”. Where an accelerator system is implemented, the load on the primary system may be alleviated by performing conversion between XML formats and record formats on the accelerator system.

Database Definition Creation and Modification System

The recitation of database access when a column is inserted and during reorganization addressed the creation and modification of database definition sets. Such manual creation and modification of database definition sets is inadvisable due to the trouble involved and the high probability of error. It is plainly advisable that they should be automatically created and modified by the database system itself. The recitation below describes a method of automatically creating and modifying database definition sets. There is no way for V1 in FIG. 4 to be created other than manually. Automatic creation and modification applies to the creation of V2 and later versions and, when creating a new version of a database definition set, to the modification of earlier versions of the database definition set. The recitation first addresses the example of column insertion in FIG. 6. In V2 here, column f is inserted into V1. Additionally, this column insertion is performed with a child database. These decisions, to insert a column and the means by which to insert the column, should be taken by a system administrator. When the decisions to insert a column and the means by which to insert the column are taken by a system administrator and the database system is notified, the database system creates the V2 database definition set and, if necessary, modifies V1 as follows. In FIG. 6 there is no modification of V1.

In V2, column f is inserted into the records stored in DB_A. The system administrator has given notice that the column insertion is to be performed with a child database. On this basis, it may be determined that it is necessary to create a new database. The column f inserted not being a primary key field, it may further be determined that the database may not be comprised solely of column f. It may thus be determined that the new database DB_A1 shall be comprised of records combining column f and column a of DB_A. It may further be determined that the pre-existing DB_A itself shall undergo no modification whatsoever. The V2 database definition set may be created in this manner.

Next, the recitation addresses the creation of a database definition set when the V2 databases above are reorganized and consolidated into a single database. This is treated in FIGS. 39, 41, 42 and 43. Reorganization may be initiated automatically by defining conditions for it beforehand, or it may be initiated at the instruction of a system administrator.

Before reorganization starts, it is necessary to create the requisite database definition set. The logic involved is as follows. Because the two V2 databases will be consolidated into one through reorganization, it may readily be determined that the database definition set must be modified. This will be V3. In V3, the two databases will be a single database, but not different from V2 in terms of logic. V2 will persist as is in logical structure. Where column b had been physically external, it will now be included in new records. The child database is no longer needed, and physical records are also consolidated.

The foregoing permits the logical creation of the individual versions of the database definition set. The new version is created from the immediately precedent version of the database definition set and application of the information imparted by the system administrator to create the new version, i.e. modification information (difference information). After the new version has been created, a method of revising earlier versions is to reflect the differences between the new version and earlier versions in individual earlier database definition sets. Additionally, as recited above, retrieval, updating, insertion and deletion with earlier database definition sets may be performed on a database created with the most recent version by deploying column-status sections, maintaining version-specific histories and information on compositional modifications, and revising and retaining earlier database definition sets.

Creation of a logical structure conversion table entails first determining the columns that will be subjected to conversion. The recitation describes an example in which the latest logical structure conversion table covers database definition sets through V4 and a new database definition set V5 is created. Although only one generation of the logical structure conversion table need be retained, for the convenience of the recitation, the logical structure conversion table covering database definition sets through V4 shall be termed V4 and the logical structure conversion table covering database definition sets through V5 shall be termed V5. In this case, where the V5 logical structure conversion table involves a column inserted into the V4 logical structure conversion table, the column inserted is added to the columns of the logical structure conversion table. Where a column is deleted by means of a non-retroactive operation, it is removed from the columns of the logical structure conversion table. The logical structure portion of database definition set V5 is then added to the right side (in the drawing) of the V5 logical structure conversion table.

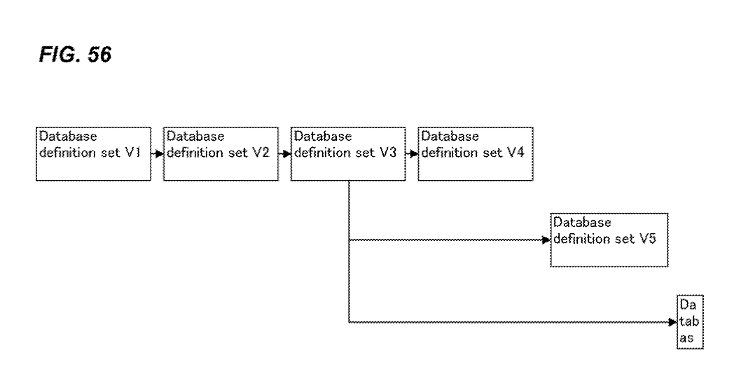

The foregoing recitation describes the creation of a new database definition set from the most recent version of a database definition set, but a new database definition set may also be created from any version of a database definition set. FIG. 56 depicts a state in which V5 and V6 have been created from V3. In such an environment as electronic data interchange (EDI), for example, that operates on the basis of a stipulation of basic fields, this is efficacious when specific information must be added with respect to a specific transaction partner. Modifying all records and programs to support that specific information would require a waste of the storage region and the trouble of modifying the application programs. However, if the column insertion were performed by means of a non-retroactive operation, for example, the storage region may be minimized and the modification of application programs also minimized by matching database definition versions to transaction partners, such that the V3 format is the basic transaction partner format, V4 is for specific transaction partner X, V5 is for specific transaction partner Y and V6 is for specific transaction partner Z.

The foregoing recitation describes methods in which a system administrator specifies the component modified. However, instances may be envisioned it is problematic for a system administrator to ascertain whether a document of a format such as XML is a new version or not, or to specify a new version. In such cases, a tag-inspection step may be inserted into the steps performed in receipt of a request-processing request when writing to a database to determine whether it conforms with an existing database definition set or whether a new database definition set is required, Where tags have a defined order pertaining to where a column is inserted, that order is complied with.

The foregoing recitation sets forth the ability to insert and delete columns dynamically. Application enables the following usages. A robot, for example, performs learning under given conditions, stores the results as data and performs that operation smoothly from then on, and in this framework may frequently be subject to additional given conditions or additional learning results and fields. In such instance, their programs themselves may automatically perform column insertions and deletions, automatically create new databases and update the content of databases.

Individual database definition sets should be provided columns to store such information as the number of times it is used, date created, date last edited and date last used, and these fields should be maintained by the database system. They should further maintain such information as the names of the programs that use the database definition set and their usage timestamp. Such functionality enables determination of whether an old version of the database definition set is being used and the deletion of versions of a database definition set not used for some given period of time and of the data maintained by that database definition set. (Effect of the invention)

Operations entailed in the insertion, deletion and modification of columns in a database may be performed while the database continues to run. Application programs may also continue to run when columns are inserted, deleted or modified.

What is claimed is:

1. A database system, comprising:
records having data fields that include a primary-key field;
primary blocks and overflow blocks that store data records in the order of their primary keys;
location table records that store the addresses of the primary blocks;
a location table that stores the location table records in the order of their primary keys;
a final pointer that indicates the end of the region of the location table in use;
child primary blocks and child overflow blocks that store child records made up of an inserted column and a primary key;
child location table records that store the addresses of the child primary blocks;
a child location table that stores the child location table records in the order of their primary keys; and
a final pointer that indicates the end of the region of the child location table in use.

2. The database system of claim 1, additionally comprising:
a structure conversion component that converts a record defined with some given version of a database definition set to a record defined with a different version of the database definition set;
multiple versions of the database definition set paired to the records of one given table; and
a data storage component storing multiple versions of records defined with those database definition sets.

3. The database system of claim 2, additionally comprising:
means for sorting records defined by a database definition set according to that database definition set.

4. The database system of claim 1, additionally comprising:
a structure conversion component that converts a record defined with some given version of a database definition set to a record defined with a different version of the database definition set;
a single version of the database definition set paired to the records of one given table; and
a data storage component storing a single version of records defined with that database definition set.

5. The database system of claim 1, additionally comprising:
a current overflow-block management table;
a current overflow-block management table pointer;
a new overflow-block management table; and
a new overflow-block management table pointer.

6. The database system of claim 1, additionally comprising:
a frond location table;
a final pointer indicating the end of the region of the frond location table in use;
a frond column operation pointer; and
a frond column operation completion pointer.

7. A database system comprising:
records having data fields that include a primary-key field:
primary blocks and overflow blocks that store data records in the order of their primary keys;
location table records that store the addresses of the primary blocks;
a location table that stores the location table records in the order of their primary keys;
a final pointer that indicates the end of the region of the location table in use;
new location table records that store the addresses of primary blocks storing records into which a column has been inserted;
a new location table that stores the new location table records in the order of their primary keys; and
a final pointer that indicates the end of the region of the new location table in use.

8. The database system of claim 7, additionally comprising:
a column operation pointer assigned to the current location table;
a column operation pointer assigned to the new location table; and
a column operation completion pointer.

9. The database system of claim 7, additionally comprising:
a structure conversion component that converts a record defined with some given version of a database definition set to a record defined with a different version of the database definition set;
multiple versions of the database definition set paired to the records of one given table; and
a data storage component storing multiple versions of records defined with those database definition sets.

10. The database system of claim 9, additionally comprising:
means for sorting records defined by a database definition set according to that database definition set.

11. The database system of claim 7, additionally comprising:
a current overflow-block management table;
a current overflow-block management table pointer;
a new overflow-block management table; and
a new overflow-block management table pointer.

12. The database system of claim 7, additionally comprising:
a frond location table;
a final pointer indicating the end of the region of the frond location table in use;
a frond column operation pointer; and
a frond column operation completion pointer.

13. A database system comprising:
records having data fields that included a primary-key field;
primary blocks and overflow blocks that store data records in the order of their primary keys;
location table records that store the addresses of the primary blocks;
a location table that stores the location table records in the order of their primary keys;
a final pointer that indicates the end of the region of the location table in use;
alternate-key records made up of an alternate-key value and a primary-key value;
alternate-key blocks and alternate-key overflow blocks that store the alternate-key records in the order of their alternate-key values;
alternate-key location table records that store the addresses of the alternate-key blocks;
an alternate-key location table that stores the alternate-key location table records in the order of their alternate-key values;
a final pointer that indicates the end of the region of the alternate-key location table in use;
a frond alternate-key location table;
a frond alternate-key final pointer that indicates the end of the region of the frond alternate-key location table in use;
a frond column operation pointer; and
a frond column operation completion pointer.

14-19. (canceled)
